(19) United States
(12) Patent Application Publication
(10) Pub. No.: US 2022/0243521 A1
(43) Pub. Date: Aug. 4, 2022

(54) A POWER CLOSURE MEMBER ACTUATION SYSTEM

(71) Applicant: MAGNA CLOSURES INC., NEWMARKET (CA)

(72) Inventors: Ryan HERMAN, Newmarket (CA); Hesam AKBARIAN, Newmarket (CA)

(21) Appl. No.: 17/617,648

(22) PCT Filed: Jun. 22, 2020
(86) PCT No.: PCT/CA2020/050870

§ 371 Date: Dec. 9, 2021

Related U.S. Application Data
(62) Division of application No. 15/493,285, filed on Apr. 21, 2017, now Pat. No. 10,443,292.
(60) Provisional application No. 62/864,070, filed on Jun. 20, 2019.
(60) Provisional application No. 62/875,736, filed on Jul. 18, 2019.
(60) Provisional application No. 62/885,390, filed on Aug. 12, 2019.
(60) Provisional application No. 62/885,397, filed on Aug. 12, 2019.
(60) Provisional application No. 62/928,416, filed on Oct. 31, 2019.
(60) Provisional application No. 62/327,317, filed on Apr. 25, 2016.
(60) Provisional application No. 62/460,152, filed on Feb. 17, 2017.

(51) Int. Cl. E05F 15/73; E05F 15/622; E05F 15/43; B60J 5/10; B60R 1/06; B60R 1/12

(52) U.S. Cl. CPC E05F 15/73; E05F 15/622; E05F 15/43; B60J 5/101; B60R 1/06; B60R 1/12; E05Y 2900/546; E05Y 2400/36; E05F 2015/434; E05Y 2400/32; E05F 2015/763; B60R 2001/1223; E05Y 2900/531; E05F 2015/433

(57) ABSTRACT

A power closure member actuation system for moving a vehicle closure member between an open position and a closed position includes an actuator and a user movement sensor configured to sense a motion input from a user on the closure member to move the closure member. A user interface is configured to detect a user interface input to modify at least one stored motion control parameter associated with the movement of the closure member. A controller is configured to modify the at least one stored motion control parameter in response to detecting the user interface input. The controller detects the motion input and in response generates a force command using the at least one stored motion control parameter. The controller then commands movement of the closure member receiving the force command to vary an actuator output force acting on the closure member to move the closure member.

### CROSS-REFERENCE TO RELATED APPLICATIONS

This PCT International Patent application claims the benefit of U.S. Provisional Application No. 62/864,070 filed Jun. 20, 2019 and U.S. Provisional Application No. 62/875,736 filed Jul. 18, 2019 and U.S. Provisional Application No. 62/885,390 filed Aug. 12, 2019 and U.S. Provisional Application No. 62/885,397 filed Aug. 12, 2019 and U.S. Provisional Application No. 62/928,416 filed Oct. 31, 2019 and U.S. Continuation-in-part application Ser. No. 16/567,156 filed Sep. 11, 2019, which claims the benefit of U.S. Utility application Ser. No. 15/493,285, filed Apr. 21, 2017, which claims the benefit of U.S. Provisional Application No. 62/327,317 filed Apr. 25, 2016 and U.S. Provisional Application No. 62/460,152 filed Feb. 17, 2017. The entire disclosure of the above applications being considered part of the disclosure of this application and hereby incorporated by reference.

### FIELD

The present disclosure relates generally to closure member systems for motor vehicles and, more particularly, to a power closure member actuation system for moving a closure member, such as a vehicle door, relative to a vehicle body between an open position and a closed position.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

As a further advancement, power closure member actuation systems have been developed. For passenger doors, like those described above, the power closure member system can function to automatically swing the passenger door about its pivot axis between the open and closed positions, to assist the user as he or she moves the passenger door, and/or to pop out or present the passenger door to the user. Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Schuering et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

While such power closure member actuation systems function satisfactorily for their intended purpose, one recognized drawback relates to operation of known power closure member actuation systems in a wide range of various circumstances. For example, users may wish to change or customize how the power closure member actuation system operates in different circumstances. Users may also desire to change the “feel” of the door or other closure member movement in instances where the power closure system is providing assistance in the movement of the door or other closure member.

In addition, operation of the power closure member actuation system may result in a change to familiar sounds such as a clunk when the closure member is closed. Users may be skeptical of operation of the power closure member actuation system lacking such feedback to the user. Furthermore, power closure member actuation systems may be subject to abuse by users slamming the closure member using excessive speed or force.

Closure members moved by such power closure member actuation systems commonly also include seals between the closure member and the vehicle body (e.g., around a perimeter of the closure member) to help isolate an interior of the vehicle from an environment. As the closure members are operated, the seals provide some load based on their resilience that can affect movement of the closure member. For example, the power closure member actuation system may need to work against the seal when closing the closure member; however, the seal load can help move the closure member when opening. So, movement of a swing door out of a primary position and out of a secondary position (i.e., door opening) may only require the load of the seal to move. Nevertheless, as the seals age, the load or resilience provided can fluctuate from a new or “green” seal to the end of the vehicle life, as well as in different temperatures, for example. Consequently, variability of seal load can adversely affect consistent performance of the power closure member actuation system.

Similarly, wear and aging of other components is possible in power closure member actuation systems. For example, increases in friction due to lack of lubrication (e.g., hinges or power-operated device gear train) or changes in the operation of the electric motor of the power-operated device (e.g., motor brushes wearing) can also undesirably affect performance of the power closure member actuation system.

While settings for the power closure member actuation systems may be preprogrammed by the system manufacturer, the speed at which the closure member is moved while assisting the user and/or automatically moving the closure member in between closed and open positions may not be ideal in some environmental conditions and for all users. More specifically, when the outside temperature is cold and/or if there is precipitation, an interior of the vehicle is exposed to these elements during movement of the closure member. One solution could be to universally increase the force applied to the closure member and/or speed of movement; nevertheless, such an adjustment may not be appropriate for all environmental conditions and/or may not be desirable to every user.

In view of the above, there remains a need to develop alternative power closure member actuation systems which address and overcome limitations and drawbacks associated with known power closure member actuation systems as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure member actuation system for moving a closure member of a vehicle between open and closed positions relative to a vehicle body. The power closure member actuation system includes an actuator coupled to the closure member and the vehicle body configured to move the closure member relative to the vehicle body. The power closure member actuation system also includes a user movement sensor that is configured to sense a motion input from a user on the closure member to move the closure member. In addition, the power closure member actuation system includes a user interface that is configured to detect a user interface input to modify at least one stored motion control parameter associated with the movement of the closure member. Additionally, the power closure member actuation system includes a controller in communication with the user movement sensor, the user interface, and the actuator. The controller is configured to modify the at least one stored motion control parameter in response to detecting the user interface input. The controller is also configured to detect the motion input and in response generate a force command using the at least one stored motion control parameter. The controller then commands movement of the closure member by the actuator receiving the force command to vary an actuator output force acting on the closure member to move the closure member.

It is a further aspect for the present disclosure to provide a user modifiable system for controlling movement of a powered closure member of a vehicle based on a user preference. The user modifiable system includes a user interface configured to detect a user interface input to modify at least one stored motion control parameter associated with the movement of the closure member. The user modifiable system also includes a controller in communication the user interface. The controller is configured to present the at least one stored motion control parameter on the user interface. The controller is also configured to modify the at least one stored motion control parameter in response to detecting the user interface input. In addition, the controller is configured to generate one of a motion command and a force command using the at least one stored motion control parameter to control an actuator output force acting on the closure member to move the closure member.

It is yet another aspect of the disclosure to provide a method of controlling the movement of a closure member based on a user preference. The method includes the step of presenting at least one stored motion control parameter associated with controlling the movement of the closure member using a user interface. The method continues with the step of modifying the at least one stored motion control parameter in response to detecting the user interacting using the user interface. The method also includes the step of generating one of a force command and a motion command using the at least one stored motion control parameter to control an actuator acting on the closure member to move the closure member.

It is a further aspect of the disclosure to provide a closure member of a motor vehicle moveable between open and closed positions relative to a vehicle body. The closure member includes an actuator coupled to the closure member and the vehicle body and configured to move the closure member relative to the vehicle body. The closure member also includes a user movement sensor configured to sense a motion input from a user on the closure member to move the closure member. Furthermore, the closure member includes a controller in communication with the user movement sensor and the actuator. The controller is configured to generate a force command using at least one stored motion control parameter being user modifiable. The controller is also configured to command movement of the closure member by the actuator receiving the force command to vary the actuator output force acting on the closure member to move the closure member.

It is another aspect of the disclosure to provide an electronic control system for a power closure member actuation system for moving a closure member of a motor vehicle between open and closed positions relative to a vehicle body. The electronic control system includes a user interface configured to detect a user interface input. The electronic control system includes a power signal generator that is configured to generate a pulse width modulation control signal to actuate an actuator of the power closure member actuation system to move the closure member. In addition, the electronic control system includes a memory device having at least one memory location for storing at least one stored motion control parameter associated with controlling the movement of the closure member. The electronic control system also includes a controller in communication with the user interface, the power signal generator, and the memory device. The controller is configured to receive the user interface input to modify the at least one stored motion control parameter using the user interface. The controller is also configured to modify the at least one stored motion control parameter stored in the memory device. The controller is additionally configured to generate one of a force command and a motion command for supply to the power signal generator using the at least one stored motion control parameter.

It is an aspect of the present disclosure to provide a power closure member actuation system for moving a closure member of a vehicle between open and closed positions relative to a vehicle body. The power closure member actuation system includes an actuator coupled to the closure member and the vehicle body configured to move the closure member relative to the vehicle body. The system also includes a closure member feedback sensor for determining at least one of a position and a speed of the closure member. The system additionally includes a controller in communication with the closure member feedback sensor and the actuator. The controller is configured to monitor the at least one of the position and the speed of the closure member using the closure member feedback sensor. The controller is also configured to generate a command to reduce the speed of the closure member as the closure member moves towards one of the open position and the closed position based on the at least one of the position and the speed of the closure member. In addition, the controller is configured to control movement of the closure member by the actuator receiving the command to vary an actuator output force acting on the closure member to move the closure member.

According to an aspect, the controller is further configured to control movement of the closure member by the actuator at a constant velocity for a portion of movement of the closure member subsequent to reducing the speed of the closure member to return the motor to below the maximum speed operating rating of the actuator.

According to an aspect, the controller is further configured to control movement of the closure member by the actuator at a decreasing velocity for a subsequent portion of movement of the closure member subsequent to the control movement of the closure member by the actuator at a constant velocity to allow the closure member to approach the one of the open position and the closed position at a velocity below the constant velocity.

According to an aspect, the controller is further configured to control the actuator to reduce the speed of the closure member during the approach without exceeding a maximum predetermined rate of deceleration of the closure member.

According to an aspect, the closure member feedback sensor is an accelerometer.

According to an aspect, the accelerometer is positioned on the closure member opposite a pair of hinges coupling the closure member to the vehicle body.

According to an aspect, the accelerometer is provided as part of a latch.

It is another aspect of the disclosure to provide method of controlling the movement of a closure member of a vehicle between open and closed positions relative to a vehicle body based on at least one of a position and a speed of the closure member using a power closure member actuation system. The method includes the step of moving the closure member relative to the vehicle body using an actuator of the power closure member actuation system coupled to the closure member and the vehicle body. The next step of the method is determining at least one of a position and a speed of the closure member using a closure member feedback sensor of the power closure member actuation system. The method proceeds by monitoring the at least one of the position and the speed of the closure member using a controller of the power closure member actuation system coupled to the closure member feedback sensor and the actuator. The method continues with the step of generating a command to reduce the speed of the closure member as the closure member moves towards one of the open position and the closed position based on the at least one of the position and the speed of the closure member using the controller. The method also includes the step of controlling movement of the closure member by the actuator receiving the command to vary an actuator output force acting on the closure member to move the closure member.

Also disclosed is a method of controlling the movement of a closure member of a vehicle between open and closed positions relative to a vehicle body based on at least one of a position and a speed of the closure member using a power closure member actuation system. The method includes the step of moving the closure member relative to the vehicle body using an actuator of the power closure member actuation system coupled to the closure member and the vehicle body. Next, monitoring the at least one of the position and the speed of the closure member using a controller of the power closure member actuation system coupled to a closure member feedback sensor and the actuator. The method proceeds by determining whether the speed of the closure member is greater than a predetermined maximum speed threshold above which may cause damage to the actuator. The method also includes the step of controlling movement of the closure member by the actuator to resist the movement of the closure member towards one of the open position and the closed position in response to determining the speed of the closure member is greater than a predetermined maximum speed threshold.

According to an aspect, the method also includes the step of not using a mechanical brake or coupling to resist the movement of the door towards one of the open position and the closed position.

According to an aspect, the method also includes the step of controlling movement of the closure member by the actuator without exceeding an operating rating of the actuator which can damage the actuator based on the position and the speed of the closure member.

It is an aspect of the present disclosure to provide a power closure member actuation system for moving a closure member of a vehicle between open and closed positions relative to a vehicle body. The system includes an actuator coupled to the closure member and the vehicle body configured to move the closure member relative to the vehicle body. The system also includes an environmental sensor configured to sense at least one environmental condition of the vehicle. In addition, the system includes a controller in communication with the environmental sensor and the actuator. The controller is configured to receive one of a motion input and an automatic mode initiation input to control movement of the closure member in a powered assist mode in response to receiving the motion input and in an automatic mode in response to receiving the automatic mode initiation input. The controller is also configured to generate one of a motion command in the automatic mode and a force command in the powered assist mode as a function of the at least one environmental condition. The controller commands movement of the closure member by the actuator receiving the one of the motion command and the force command to vary an actuator output force acting on the closure member to move the closure member.

It is another aspect of the disclosure to provide a method of controlling the movement of a closure member based on an environmental condition of the vehicle. The method includes the step of receiving one of a motion input and an automatic mode initiation input to control movement of the closure member in a powered assist mode in response to receiving the motion input and in an automatic mode in response to receiving the automatic mode initiation input. The method continues with the step of detecting the environmental condition of the vehicle using an environmental sensor. The next step of the method is generating one of a motion command in the automatic mode and a force command in the powered assist mode as a function of the environmental condition. The method also includes the step of commanding movement of the closure member by the actuator receiving the one of the motion command and the force command to vary an actuator output force acting on the closure member to move the closure member.

It is an aspect of the present disclosure to provide a power closure member actuation system for moving a closure member of a vehicle between open and closed positions relative to a vehicle body. The system includes an actuator coupled to the closure member and the vehicle body that is configured to move the closure member relative to the vehicle body. The system also includes at least one closure member feedback sensor configured to sense at least one of an actual speed of the closure member and an actual position of the closure member. The system includes a controller in communication with the at least one closure member feedback sensor and the actuator. The controller is configured to receive one of a motion input and an automatic mode initiation input to control movement of the closure member to the open position. The controller controls movement of the closure member by commanding the actuator using the one of the motion input and the automatic mode initiation input. The controller monitors at least one of the actual speed and the actual position of the closure member using the at least one closure member feedback sensor and calculates at least one of a position differential between an expected position of the closure member and the actual position of the closure member and a speed differential between an expected speed of the closure member and the actual speed of the closure member. The controller adjusts the commanding of the actuator to compensate for the at least one of the position differential and the speed differential to move the closure member to at least one of the expected position and the expected speed.

It is another aspect of the disclosure to provide a method of controlling the movement of a closure member of a vehicle. The method includes the steps of receiving one of a motion input and an automatic mode initiation input to control movement of the closure member to the open position. The method continues with the step of controlling movement of the closure member by commanding the actuator using the one of the motion input and the automatic mode initiation input. The next step of the method is monitoring at least one of an actual speed and an actual position of the closure member using at least one closure member feedback sensor configured to sense at least one of the actual speed and the actual position of the closure member. The method proceeds with the step of calculating at least one of a position differential between an expected position of the closure member and the actual position of the closure member and a speed differential between an expected speed of the closure member and the actual speed of the closure member. The method also includes the step of adjusting the commanding the actuator to compensate for the at least one of the position differential and the speed differential to move the closure member to at least one of the expected position and the expected speed.

It is yet another aspect of the disclosure to provide a power closure member actuation system for moving a closure member of a vehicle between open and closed positions relative to a vehicle body. The power closure member actuation system includes a latch mechanism including a ratchet having a ratchet latch feature and a ratchet engagement feature, a ratchet biasing member, a pawl, and a pawl biasing member. The ratchet is moveable between a striker release position corresponding to a closure member release position whereat the ratchet is positioned to release a striker and two distinct striker capture positions whereat the ratchet is positioned to retain the striker. The two distinct striker capture positions including a secondary striker capture position corresponding to a secondary closure member position and a primary striker capture position corresponding to a primary closure member position. The ratchet biasing member is configured to bias the ratchet toward its striker release position. The pawl is moveable between a ratchet holding position whereat the pawl engages the ratchet latch feature and holds the ratchet in its primary striker capture position and a ratchet releasing position whereat the pawl is disengaged from the ratchet latch feature. The pawl is located in its ratchet releasing position when the ratchet is located in its striker release and secondary striker capture positions. The pawl biasing member is configured to bias the pawl toward its ratchet holding position, and a power release actuator is operable to move the pawl from the ratchet holding position to the ratchet releasing position. The system includes a door seal provided between the closure member and the vehicle body. The door seal is in a compressed state when the closure member is in the closed position to exert a seal force on the closure member to move the closure member towards the closure member release position. An actuator is coupled to the closure member and the vehicle body configured to move the closure member relative to the vehicle body. The system also includes at least one closure member feedback sensor is configured to sense a position of the closure member. Additionally, the system includes a controller in communication with the at least one closure member feedback sensor, the actuator, and the power release actuator. The controller is configured to receive a command to control movement of the closure member to the open position. The controller is also configured to command the power release actuator to move the pawl to the ratchet releasing position. The controller monitors the position of the closure member using the at least one closure member feedback sensor and calculates a seal load differential between the seal force exerted on the closure member and a nominal seal force. The controller generates a command using the seal load differential to control an actuator output force acting on the closure member from the actuator to supplement the seal load force. The controller additionally, controls movement of the closure member by commanding the actuator using the command to vary the actuator output force acting on the closure member and move the closure member to the closure member release position, wherein when the closure member is in the closure member release position, the ratchet has been moved to the striker release position.

It is an aspect of the present disclosure to provide a power closure member actuation system for moving a closure member of a vehicle. The system includes an actuator coupled to the closure member and a vehicle body and configured to move the closure member relative to the vehicle body. A controller is in communication with the actuator and is configured to receive one of a motion input associated with a powered assist mode and an automatic mode initiation input associated with an automatic mode. The controller sends the actuator one of a motion command based on a plurality of automatic closure member motion parameters in the automatic mode and a force command based on a plurality of powered closure member motion parameters in the powered assist mode to vary an actuator output force acting on the closure member to move the closure member. The controller is also configured to monitor and analyze historical operation of the power closure member actuation system using an artificial intelligence learning algorithm. The controller then adjusts the plurality of automatic closure member motion parameters and the plurality of powered closure member motion parameters accordingly.

It is another aspect of the disclosure to provide a method of controlling the movement of a closure member of a vehicle using a power closure member actuation system. The method includes the step of receiving one of a motion input associated with a powered assist mode and an automatic mode initiation input associated with an automatic mode. The next step of the method is sending an actuator one of a motion command based on a plurality of automatic closure member motion parameters in the automatic mode and a force command based on a plurality of powered closure member motion parameters in the powered assist mode to vary an actuator output force acting on the closure member to move the closure member. The method proceeds by monitoring and analyzing historical operation of the power closure member actuation system using an artificial intelligence learning algorithm and adjusting the plurality of automatic closure member motion parameters and the plurality of powered closure member motion parameters accordingly.

In accordance with another aspect of the disclosure, there is provided a non-contact obstacle detection system for a motor vehicle including a controller, at least one non-contact obstacle sensor coupled to the controller for detecting obstacles near a closure member of the motor vehicle, a motion sensing system coupled to the controller for detecting a motion of the closure member, and a power actuator coupled to the closure member and the controller for moving the closure member, wherein the controller is configured to detect movement of the closure member using the motion sensing system, detect no obstacle using the at least one non-contact obstacle sensor, and alter movement of the closure member using the power actuator in response to no obstacle being detected while movement of the closure member is detected. In a related aspect, the controller is further configured to cease movement of the closure member using at least one of the actuator and a braking mechanism in response to no obstacle being detected while movement of the closure member is detected.

In accordance with another aspect of the disclosure, there is provided a method of operating a non-contact obstacle detection system for a motor vehicle including the steps of determining whether a closure member is in an open position, determining whether no obstacle is detected using at least one non-contact obstacle sensor, determining whether the closure member is moving, and altering motion of the closure member in response to the closure member moving and no obstacle being detected. In a related aspect, the step of altering motion of the closure member in response to the closure member moving and no obstacle being detected is further defined as ceasing motion of the closure member using at least one of a power actuator coupled to the closure member and the controller for moving the closure member and a braking mechanism in response to the closure member moving and no obstacle being detected.

In accordance with another aspect of the disclosure, there is provided a non-contact obstacle detection system for a motor vehicle including a controller, at least one motion sensor coupled to the controller for detecting a change in motion or inclination of the motor vehicle, and at least one of a power actuator and a braking mechanism coupled to the closure member and the controller for altering a motion of the closure member, such that the controller is configured to detect a change in motion or orientation of the motor vehicle using the motion sensor, and alter movement of the closure member using the at least one power actuator and braking mechanism in response to detecting a change in motion or orientation of the motor vehicle while movement of the closure member is detected. In a related aspect, the controller is configured to alter movement of the closure member by applying a resistive force against the movement of the closure member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and the vehicle body according to aspects of the disclosure;

FIG. 2 is a perspective inner side view of a closure member shown in FIG. 1, with various components removed for clarity purposes only, in relation to a portion of the vehicle body and which is equipped with the power closure member actuation system according to aspects of the disclosure;

FIG. 3 illustrates a block diagram of the power closure member actuation system according to aspects of the disclosure;

FIG. 4 illustrates another block diagram of the power closure member actuation system for moving the closure member in an automatic mode according to aspects of the disclosure;

FIGS. 5 and 5A illustrate the power closure member actuation system shown as part of vehicle system architectures according to aspects of the disclosure;

FIG. 6 illustrates another block diagram of the power closure member actuation system for moving the closure member in a powered assist mode according to aspects of the disclosure;

FIG. 7 illustrates the power closure member actuation system shown as part of the vehicle system architecture corresponding to operation in the powered assist mode according to aspects of the disclosure;

FIG. 8 shows a user interface of the power closure member actuation system according to aspects of the disclosure;

FIG. 9 illustrates a plurality of user motion control parameters that are modifiable by a user and a plurality of manufacturer motion control parameters that are modifiable by a manufacturer according to aspects of the disclosure;

FIG. 10 illustrates that the user interface includes a touch screen of a control console disposed in the motor vehicle that is operable in the automatic mode according to aspects of the disclosure;

FIG. 11 shows a plurality of stored motion control parameters associated with the automatic mode mapped to corresponding memory locations in a memory device of the power closure member actuation system according to aspects of the disclosure;

FIG. 12 shows an additional block diagram of the power closure member actuation system in the automatic mode according to aspects of the disclosure;

FIG. 13 illustrates example changes to a duty cycle register corresponding to a change in a pulse width modulation duty cycle in the automatic mode according to aspects of the disclosure;

FIG. 14 shows stored motion control parameters stored in the memory device and translated changes in a motion profile in the automatic mode according to aspects of the disclosure;

FIG. 15 shows additional stored motion control parameters stored in the memory device including a door check sensitivity and a movement profile according to aspects of the disclosure;

FIGS. 16A and 16B show adjustments to a motion profile related to the velocity of the closure member for each of the plurality of closure member angles according to aspects of the disclosure;

FIG. 17 illustrates that the user interface includes the touch screen of the control console disposed in the motor vehicle that is operable in the powered assist mode according to aspects of the disclosure;

FIG. 18 shows a plurality of stored motion control parameters associated with the powered assist mode mapped to corresponding memory locations in the memory device of the power closure member actuation system according to aspects of the disclosure;

FIG. 19 shows an additional block diagram of the power closure member actuation system in the powered assist mode and generating a force command using pre-compensation according to aspects of the disclosure;

FIG. 20 shows an additional block diagram of the power closure member actuation system in the powered assist mode and generating the force command using post-compensation according to aspects of the disclosure;

FIG. 21 shows adjustments to force profiles related to a force of the closure member for each of a plurality of closure member angles with boundary conditions according to aspects of the disclosure;

FIGS. 22-27 illustrate steps of a method of controlling the movement of the closure member based on a user preference according to aspects of the disclosure;

FIGS. 28A and 28B show example profile modifications based on the user interface input according to aspects of the disclosure;

FIG. 29 illustrates example motion of the closure member outside of a plurality of pre-stored calibration limits according to aspects of the disclosure;

FIG. 30 illustrates a range of movement of the closure member between an open position and a closed position according to aspects of the disclosure;

FIGS. 31 and 32 illustrate a range of movement of the closure member between an open position and a closed position illustrating spikes in velocity caused by a slam event according to aspects of the disclosure;

FIG. 33 illustrates changes to a speed of the closure member moving toward the open position depending on an angle of the closure member in an anti-slam mode according to aspects of the disclosure;

FIG. 34 illustrates changes to a speed of the closure member moving toward the closed position depending on the angle of the closure member in the anti-slam mode according to aspects of the disclosure;

FIG. 35 illustrates a hysteresis implemented in the power closure member actuation system by dynamically updating the comparison limits used for important switching points according to aspects of the disclosure;

FIGS. 36A and 36B illustrate operation of the controller in both the powered assist mode and the anti-slam mode according to aspects of the disclosure;

FIG. 37 illustrates a relationship between the speed of the closure member and the mode in which the controller operates according to aspects of the disclosure;

FIG. 37A illustrates an illustrative method of transitioning between automatic mode and power assist mode according to aspects of the disclosure;

FIGS. 38 and 39 illustrate steps of a method of controlling the movement of the closure member based on at least one of a position and the speed of the closure member using the power closure member actuation system according to aspects of the disclosure.

FIG. 40 shows adjustments to a motion profile related to the motion of the closure member for each of the plurality of closure member angles according to aspects of the disclosure;

FIG. 41 shows adjustments to force profiles related to a force of the closure member for each of a plurality of closure member angles with boundary conditions according to aspects of the disclosure;

FIG. 42 illustrates steps of a method of controlling the movement of the closure member based on at least one environmental condition of the vehicle 10 is also provided according to aspects of the disclosure;

FIG. 43 is a client-server network diagram, in accordance with an illustrative embodiment

FIG. 44 is a partial perspective view of the motor vehicle with the closure member equipped with a latch assembly, according to aspects of the disclosure;

FIG. 45 is an isometric view of the latch assembly generally illustrating the components of a latch mechanism, a latch release mechanism, a power release actuator, a latch cinch mechanism, a power cinch actuator, and a cinch disengage mechanism with the latch assembly operating in an Unlatched mode, according to aspects of the disclosure;

FIG. 46 shows various positions of the closure member, according to aspects of the disclosure;

FIGS. 47A-47D illustrate latch status switch states of the latch assembly, according to aspects of the disclosure;

FIG. 48 illustrates an example closure member motion profile showing how a speed of the closure member could be affected by an aging seal load, according to aspects of the disclosure;

FIGS. 49 and 50 illustrate steps of a method of controlling the movement of the closure member of the vehicle is also provided, according to aspects of the disclosure;

FIGS. 51 and 52 illustrate steps of a method of controlling the movement of the closure member of the vehicle using the power closure member actuation system is also provided according to aspects of the disclosure;

FIG. 53 is a block diagram of components of a system for executing an learning algorithm using a neural network and/or for training the neural network, in accordance with some embodiments of the present invention;

FIG. 54 illustrates a series of nodes forming a neural network model in accordance with an illustrative embodiment;

FIGS. 55A and 55B illustrate a method of operation of the power closure member actuation system for moving a door from a fully latched position when operating in the automatic mode, in accordance with an illustrative embodiment;

FIGS. 56A and 56B illustrate a method of operation of the power closure member actuation system for closing the door from an open position, in accordance with an illustrative embodiment;

FIG. 57 illustrates a method of operation of the power closure member actuation system for moving the door when the controller is operating in the power assist mode from a stopped door position, in accordance with an illustrative embodiment;

FIG. 58 illustrates a method of operation of the power closure member actuation system for controlling the movement of the door during an unplanned stop when the door is operating in automatic mode, in accordance with an illustrative embodiment;

FIG. 58A illustrates a door motion chart of speed versus door angle illustrating the door motion during automatic mode operation before an interruption, the door motion during power assist operation following an interruption in automatic mode operation, followed by a resumption of the automatic mode operation having a motion profile not exceeding the door motion before interruption, in accordance with an illustrative embodiment;

FIG. 59 illustrates a method of operation of the power closure member actuation system for controlling the movement of the door from a small angle position greater than secondary position in automatic mode, in accordance with an illustrative embodiment;

FIG. 60 illustrates a method of operation of the power closure member actuation system of checking the door when controlling the door in automatic mode or power assist mode, in accordance with an illustrative embodiment;

FIG. 60A illustrates a door check force profile as a function of door angle, in accordance with an illustrative embodiment;

FIG. 61 illustrates a method of operation of the power closure member actuation system while a wind force acts on the door of the vehicle, in accordance with an illustrative embodiment;

FIGS. 61A and 61B are graphs illustrating sensed current changes as a result of a user manually controlling the door, in accordance with an illustrative embodiment;

FIG. 62A illustrates a method of operation of the power closure member actuation system to detect no obstacles while movement of the closure member is detected, in accordance with an illustrative embodiment;

FIGS. 62B and 62C illustrate methods of operation of the power closure member actuation system to detect a manual control of the closure panel when the user is detected using the non-contact obstacle detection system, in accordance with illustrative embodiments;

FIG. 63 illustrates a method of operation of the power closure member actuation system to detect a movement of the vehicle while movement of the closure member is detected, in accordance with an illustrative embodiment;

FIG. 64 illustrates a method of operation of the power closure member actuation system to detect no obstacles and movement of the vehicle while movement of the closure member is detected, in accordance with an illustrative embodiment;

FIG. 65 illustrates a method of operation of the power closure member actuation system for moving a door from a closed door position when the door is in a frozen state, in accordance with an illustrative embodiment;

FIG. 66 illustrates a method of operation of the power closure member actuation system for moving a door from a closed door position when the door is in a mechanically blocked state, in accordance with an illustrative embodiment;

FIG. 67 illustrates a method executed by the controller of the of the power closure member actuation system for calculating an actuator force to move the door, in accordance with an illustrative embodiment;

FIG. 68 illustrates a system block diagram of the power closure member actuation system configured for executing the method of FIG. 67, in accordance with an illustrative embodiment;

FIG. 69 is a superposition algorithm executed by the controller of the of the power closure member actuation system, in accordance with an illustrative embodiment;

FIG. 70 is a partial perspective view of the of actuator of the power closure member actuation system illustrating the torque moments about the door hinge axis corresponding to the superposition algorithm of FIG. 69, in accordance with an illustrative embodiment; and

FIG. 71 is a block diagram of the superposition algorithm executed by the controller of the of the power closure member actuation system illustrating the inclusion of torque moments of auxiliary door systems, in accordance with an illustrative embodiment.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system or user modifiable system constructed in accordance with the teachings of the present disclosure will now be disclosed. The example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

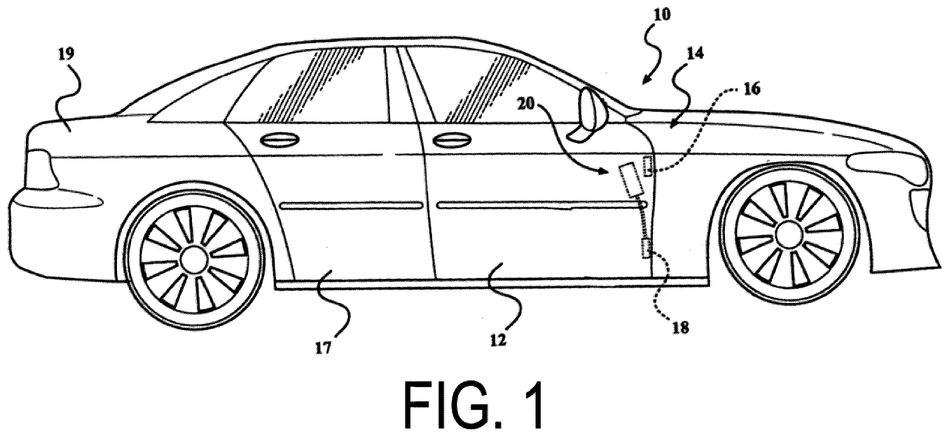

Referring initially to FIG. 1, an example motor vehicle 10 is shown to include a first passenger door 12, or also referred to as an exemplary closure member 12, pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

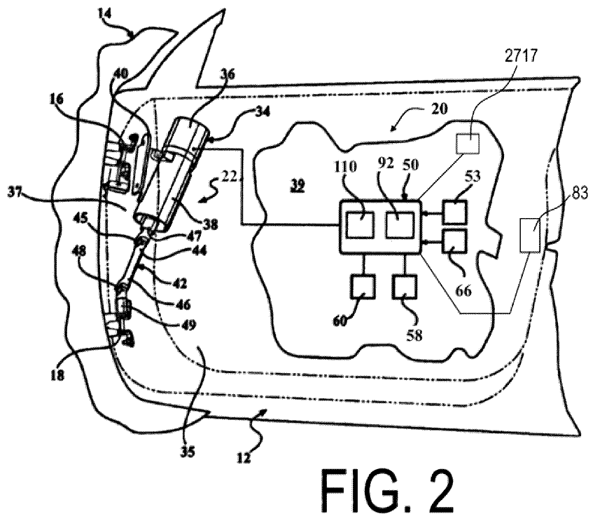

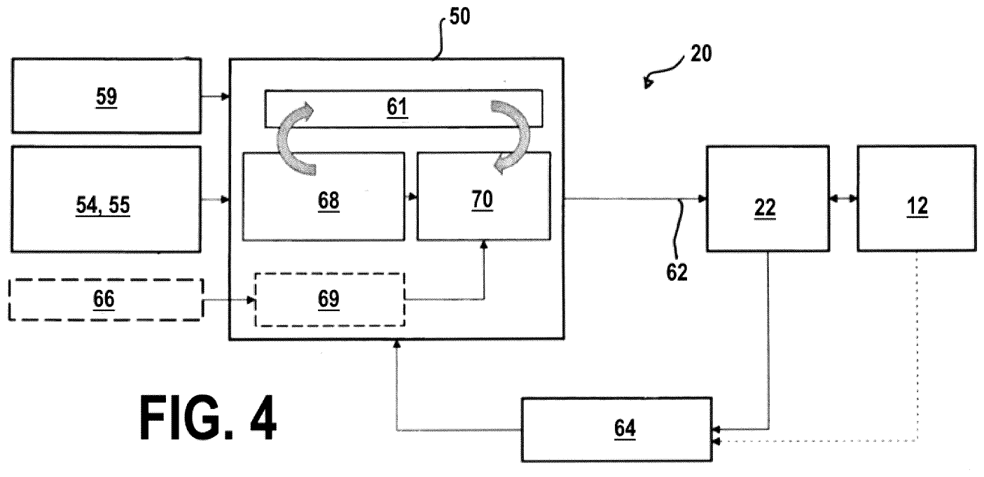

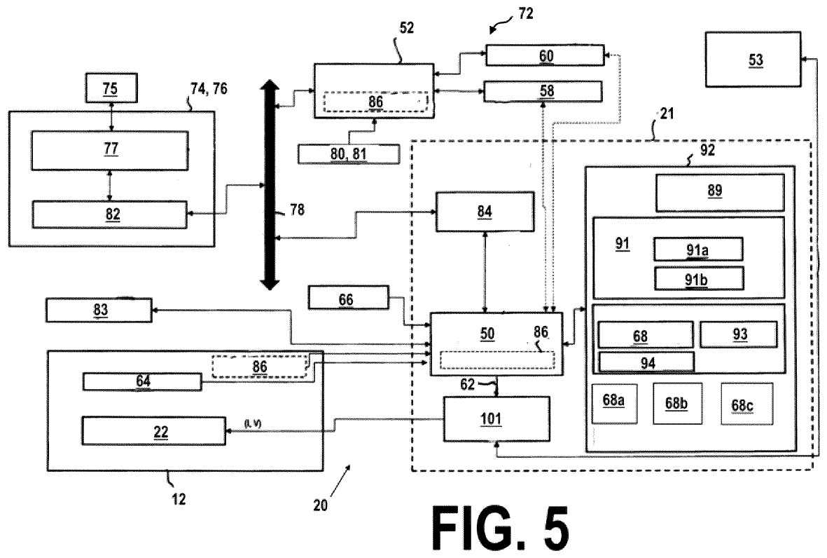

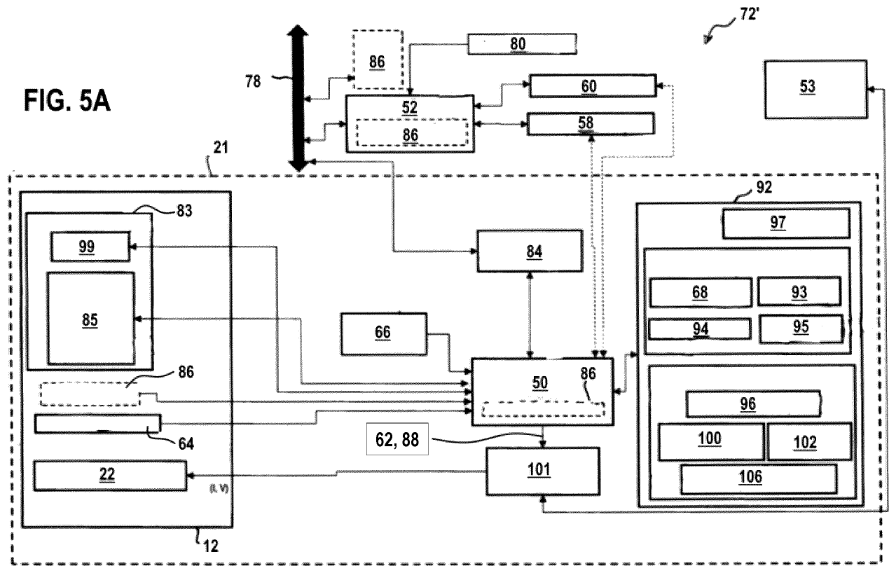

Power closure member actuation system 20 is generally shown in FIG. 2 and, as mentioned, is operable for controllably pivoting vehicle door 12 relative to vehicle body 14 between an open position and a closed position. As shown in FIGS. 4 and 5, lower hinge 18 of power closure member actuation system 20 includes a door hinge strap 28 connected to vehicle door 12 and a body hinge strap 30 connected to vehicle body 14. Door hinge strap 28 and body hinge strap 30 of lower door hinge 18 are interconnected along a generally vertically-aligned pivot axis A via a hinge pin 32 to establish the pivotable interconnection between door hinge strap 28 and body hinge strap 30. However, any other mechanism or device can be used to establish the pivotable interconnection between door hinge strap 28 and body hinge strap 30 without departing from the scope of the subject disclosure.

As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to the door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis A. The mounting of motor and geartrain assembly 34 adjacent to upper door hinge 16 of vehicle door 12 minimizes the effect that power closure member actuation system 20 may have on a mass moment of inertia (i.e., pivot axis A) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e. power-off engagement) and could be selectively energized (i.e. power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user 75 between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-driveable” gearing. In one possible configuration, the power-operated actuator mechanism 22 is provided without a clutch mechanism, and so a direct permanent coupling between the motor and output of the power-operated actuator mechanism 22 (e.g. a coupling to the vehicle body 14 for example.) In such a configuration, the geartrain assembly 34 may possibly be a backdriveable geartrain.

Second end 46 of drive shaft 42 is coupled to body hinge strap 30 of lower door hinge 18 for directly transferring the rotational force from motor and geartrain assembly 34 to door 12 via body hinge strap 30. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to body hinge strap 30 of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating body hinge strap 30 about its pivot axis to which drive shaft 42 is attached and relative to door hinge strap 28. As a result, power closure member actuation system 20 is able to effectuate movement of vehicle door 12 between its open and closed positions by “directly” transferring a rotational force directly to body hinge strap 30 of lower door hinge 18. With motor and geartrain assembly 34 connected to vehicle door 12 adjacent to upper door hinge 16, second end 46 of drive shaft 42 is attached to body hinge strap 30 of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to door hinge strap 28.

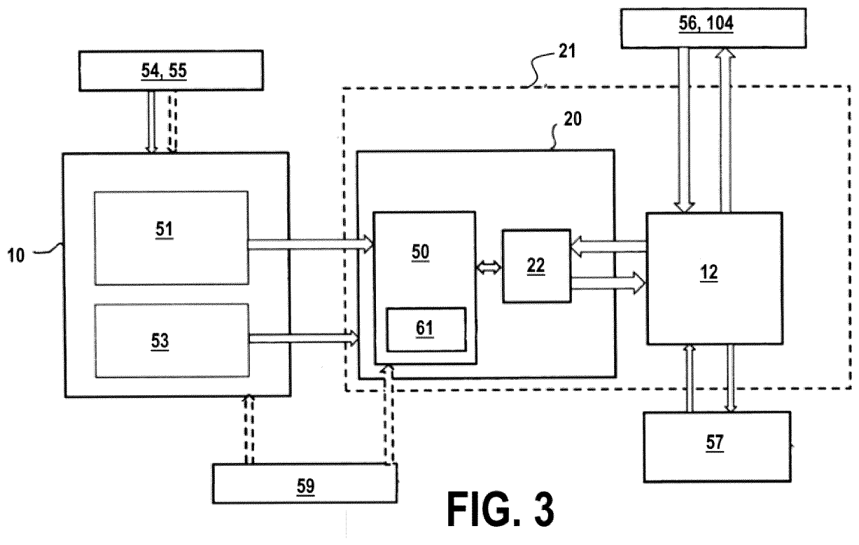

FIG. 3 illustrates a block diagram of the power closure member actuation system 20 of a power door system 21 for moving the closure member (e.g., vehicle door 12) of the vehicle 10 between open and closed positions relative to the vehicle body 14. As discussed above, the power closure member actuation system 20 includes the actuator 22 that is coupled to the closure member (e.g., vehicle door 12) and the vehicle body 14. The actuator 22 is configured to move the closure member 12 relative to the vehicle body 14. The power closure member actuation system 20 also includes a controller 50 that is coupled to the actuator 22 and in communication with other vehicle systems (e.g., a body control module 52) and also receives vehicle power from the vehicle 10 (e.g., from a vehicle battery 53).

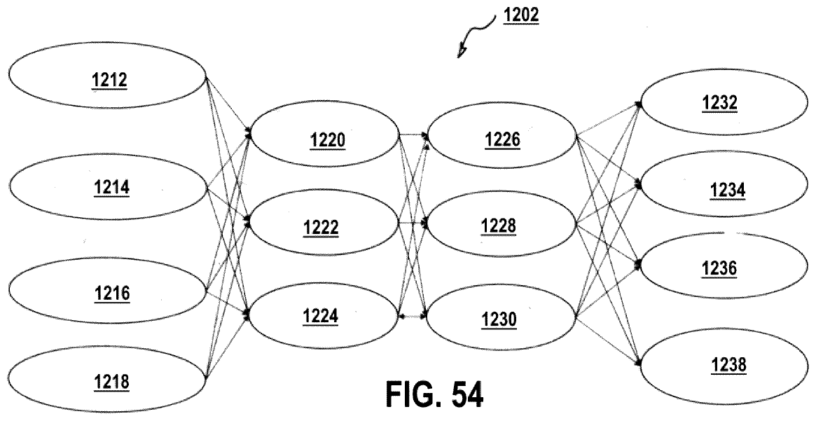

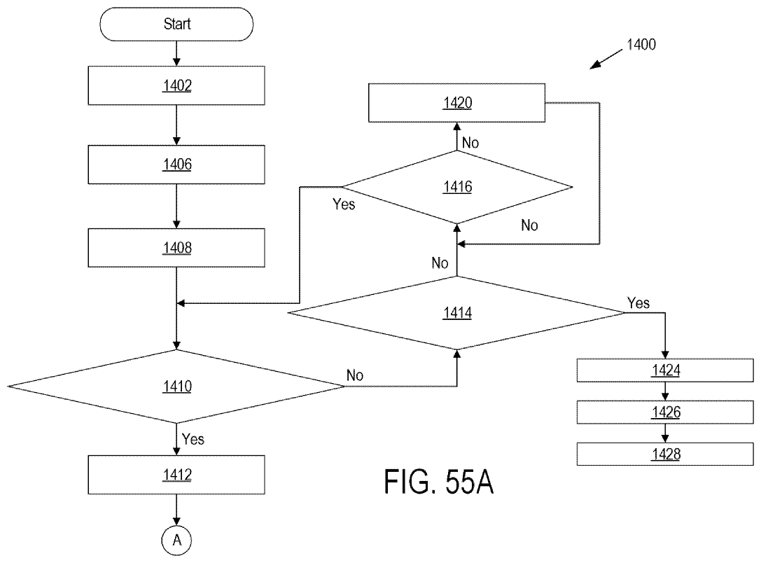

The controller 50 is operable in at least one of an automatic mode (in response to an automatic mode initiation input 54) and a powered assist mode (in response to a motion input 56). In the automatic mode, the controller 50 commands movement of the closure member through a predetermined motion profile (e.g., to open the closure member). The powered assist mode is different than the automatic mode in that the motion input 56 from the user 75 may be continuous to move the closure member, as opposed to a singular input by the user 75 in automatic mode. Commands 51 from the vehicle systems may, for example, include instructions the controller 50 to open the closure member, close the closure member, or stop motion of the closure member. Such control inputs, such as inputs 54, 56 may also include other types of inputs 55, such as an input from a body control module, which may receive a wireless command to control the door opening based on a signal such as a wireless signal received from the key fob 60, or other wireless device such as a cellular smart phone, or from a sensor assembly provided on the vehicle, such as a radar or optical sensor assembly detecting an approach of a user, such as a gesture or gait e.g. walk of the user 75 upon approach of the user 75 to the vehicle. Also shown are other components that may have an impact on the operation of the power closure member actuation system 20, such as door seals 57 of the vehicle door 12, for example. In addition, environmental conditions 59 (rain, cold, heat, etc.) may be monitored by the vehicle 10 (e.g., by the body control module 52) and/or the controller 50. The controller 50 also includes an artificial intelligence learning algorithm 61 (e.g., series of nodes forming a neural network model shown in FIG. 54), discussed in more detail below.

Referring now to FIG. 4, the controller 50 is configured to receive the automatic mode initiation input 54 and enter the automatic mode to output a motion command 62 in response to receiving the automatic mode initiation input 54 or input motion command 62. The automatic mode initiation input 54 can be a manual input on the closure member itself or an indirect input to the vehicle (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10, for example. It should also be appreciated that other automatic mode initiation inputs 54 are contemplated, such as, but not limited to a proximity of the user 75 detected by a proximity sensor.

In addition, the power closure member actuation system 20 includes at least one closure member feedback sensor 64 for determining at least one of a position and a speed and an attitude of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50. Feedback sensor 64 in communication with controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuitry) for detecting movement of a target on the closure member (e.g. on the hinge) or actuator 22 (e.g. on a motor shaft) as examples, and/or may also be software based (e.g. using code and logic for executing a ripple counting algorithm) executed by the controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the controller 50. The controller 50 is configured to determine whether an obstacle is detected using the at least one non-contact obstacle detection sensor 66 (e.g., using a non-contact obstacle detection algorithm 69) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar based sensor 66 or to characterize the object as a user or human as compared to an non-human object for example based on determining the reflectivity of the object using a radar based sensor 66 and system. The non-contact obstacle detection system may also be configured determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

In the automatic mode, the controller 50 can include one or more closure member motion profiles 68 that are utilized by the controller 50 when generating the motion command 62 (e.g., using a motion command generator 70 of the controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and finally stops at an open position) and is continually optimized per user feedback (e.g., automatic mode initiation input 54).

In FIG. 5, the power closure member actuation system 20 is shown as part of a vehicle system architecture 72 corresponding to operation in the automatic mode. The power closure member actuation system 20 includes a user interface 74, 76 that is configured to detect a user interface input from a user 75 via an interface 77 (e.g., touchscreen) to modify at least one stored motion control parameter associated with the movement of the closure member. Thus, the controller 50 of the power closure member actuation system 20 or user modifiable system is configured to present the at least one stored motion control parameter on the user interface 74, 76.

The body control module 52 is in communication with the controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the controller 50 or otherwise communicated to the controller 50. The body control module 52 may also be in communication with an environmental sensor (e.g., temperature sensor 80). The controller 50 is also configured to modify the at least one stored motion control parameter in response to detecting the user interface input. A screen communications interface control unit 82 associated with the user interface 74, 76 can, for example, communicate with a closure communications interface control unit 84 associated with the controller 50 via the vehicle bus 78. In other words, the closure communication interface control unit 84 is coupled to the vehicle bus 78 and to the controller 50 to facilitate communication between the controller 50 and the vehicle bus 78. Thus, the user interface input can be communicated from the user interface 74, 76 to the controller 50.

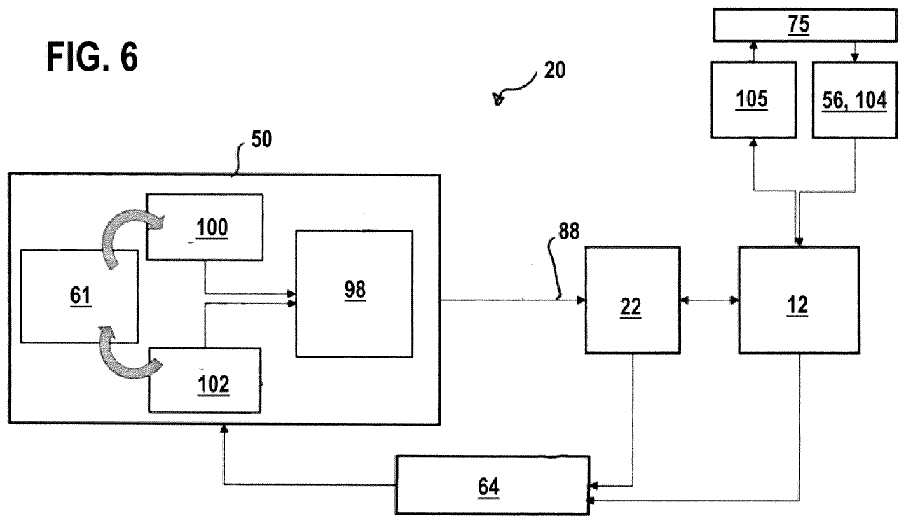

A vehicle inclination sensor 86 (such as an accelerometer) is also coupled to the controller 50 for detecting an inclination of the vehicle 10. The vehicle inclination sensor 86 outputs an inclination signal corresponding to the inclination of the vehicle 10 and the controller 50 is further configured to receive the inclination signal and adjust the one of a force command 88 (FIG. 6) and the motion command 62 accordingly. While the vehicle inclination sensor 86 may be separate from the controller 50, it should be understood that the vehicle inclination sensor 86 may also be integrated in the controller 50 or in another control module, such as, but not limited to the body control module 52.

The controller 50 is further configured to perform at least one of an initial boundary condition check prior to the generation of the command signal (e.g., the force command 88 or the motion command 62) and an in-process boundary check during the generation of the command signal. Such boundary checks prevent movement of the closure member and operation of the actuator 22 outside a plurality of predetermined operating limits or boundary conditions 91 and will be discussed in more detail below.

The controller 50 can also be coupled to a vehicle latch 83. In addition, the controller 50 is coupled to a memory device 92 having at least one memory location for storing at least one stored motion control parameter associated with controlling the movement of the closure member (e.g., door 12). The memory device 92 can also store one or more closure member motion profiles 68 (e.g., movement profile A 68a, movement profile B 68b, movement profile C 68c) and boundary conditions 91 (e.g., the plurality of predetermined operating limits such as minimum limits 91a, and maximum limits 91b). The memory device 92 also stores original equipment manufacturer (OEM) modifiable door motion parameters 89 (e.g., door check profiles and pop-out profiles).

The controller 50 is configured to generate the motion command 62 using the at least one stored motion control parameter to control an actuator output force acting on the closure member to move the closure member. A pulse width modulation unit 101 is coupled to the controller 50 and is configured to receive a pulse width control signal and output an actuator command signal corresponding to the pulse width control signal.

Similar to FIG. 5, FIG. 5A shows the power closure member actuation system 20 as part of another vehicle system architecture 72′ operable in the automatic mode and the powered assist mode. The body control module 52 may also be in communication with at least one environmental sensor 80, 81 for sensing at least one environmental condition 59. Specifically, the at least one environmental sensor 80, 81 can be at least one of a temperature sensor 80 or a rain sensor 81. While the temperature sensor 80 and rain sensor 81 may be connected to the body control module 52, they may alternatively be integrated in the body control module 52 and/or integrated in another unit such as, but not limited to the controller 50. In addition, other environmental sensors 80, 81 are contemplated.

The controller is also coupled with the latch 83 that includes a cinch motor 99 (for cinching the closure member 12 into the closed position). The latch 83 also includes a plurality of primary and secondary ratchet position sensors or switches 85 that provide feedback to the controller 50 regarding whether the latch 83 is in a latch primary position or a latch secondary position, for example.

Again, the vehicle inclination sensor 86 (such as an accelerometer or inclinometer) is also coupled to the controller 50 for detecting the inclination of the vehicle 10. The vehicle inclination sensor 86 outputs an inclination signal corresponding to the inclination of the vehicle 10 and the controller 50 is further configured to receive the inclination signal and adjust the one of the force command 88 (FIG. 6) and the motion command 62 accordingly. Accordingly may be for example adjusting the motion command 62 such that door 12 moves at the same speed and motion profile as compared to the door 12 being moved by a motion command as if on a level terrain. As a result, the actuator 22 may move the door 12 such that the motion profile (e.g. speed versus door position) when on an incline is the same as or is tracking to the motion profile as if the vehicle was not on an incline. In other words the user detects no visual difference in the door motion appearance of speed versus position as when the vehicle 10 is on an incline or not. Or for example accordingly may be adjusting the force command 88 such that door 12 is moved applying the similar resistance force detected by a user as compared to the door being moved by a force command as if on level terrain. As a result, the actuator 22 may move the door such that the force required to move the door 12 by a user when on an incline is the same as the force required by a user to move the door as if the vehicle was not on an incline. In other words, the user experiences the same reactionary resistive force of the door acting against the input force of the user when the vehicle 10 is on an incline or not.

A pulse width modulation unit 101 is also coupled to the controller 50 and is configured to receive a pulse width control signal and output an actuator command signal corresponding to the pulse width control signal. The controller 50 includes a processor or other computing unit 110 in communication with the memory device 92. So, the controller 50 is coupled to the memory device 92 for storing a plurality of automatic closure member motion parameters 68, 93, 94, 95 for the automatic mode and a plurality of powered closure member motion parameters 96, 100, 102, 106 for the powered assist mode and used by the controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93 (e.g., see FIG. 46), a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

Consequently, the controller 50 is configured to receive one of the motion input 56 associated with the powered assist mode and the automatic mode initiation input 54 associated with the automatic mode. The controller 50 is then configured to send the actuator 22 one of a motion command 62 based on the plurality of automatic closure member motion parameters 68, 93, 94, 95 in the automatic mode and the force command 88 based on the plurality of powered closure member motion parameters 96, 100, 102, 106 in the powered assist mode to vary the actuator output force acting on the closure member 12 to move the closure member 12. The controller 50 additionally monitors and analyzes historical operation of the power closure member actuation system 20 using the artificial intelligence learning algorithm 61 and adjusts the plurality of automatic closure member motion parameters 68, 93, 94, 95 and the plurality of powered closure member motion parameters 96, 100, 102, 106 accordingly.

As discussed above, the power closure member actuation system 20 can include an environmental sensor 80, 81 in communication with the controller 50 and configured to sense at least one environmental condition of the vehicle 10. Thus, the historical operation monitored and analyzed by the controller 50 using the artificial intelligence learning algorithm 61 can include the at least one environmental condition of the vehicle 10. So, the controller is further configured to adjust the plurality of automatic closure member motion parameters 68, 93, 94, 95 and the plurality of powered closure member motion parameters 96, 100, 102, 106 based on the at least one environmental condition of the vehicle 10.

As best shown in FIG. 6, the controller 50 is also configured to receive the motion input 56 and enter the powered assist mode to output the force command 88 (e.g., using a force command generator 98 of the controller 50 as a function of a force command algorithm 100, door model 102, boundary conditions 91, a plurality of closure member component profiles 106 as discussed in more detail below) as modified by the artificial intelligence learning algorithm 61. The controller 50 is also configured to generate the force command 88 to control an actuator output force acting on the closure member to move the closure member. So, the controller 50 varies an actuator output force acting on the closure member to move the closure member in response to receiving the motion input 56. In the powered assist mode, the force command 88 has a specified force profile (e.g., that may be altered to change the user experience with the closure member, such as by making it lighter or heavier, or based on changes in the environmental condition and modified by the artificial intelligence learning algorithm 61, such as by increasing or decreasing the force assist provided to the user 75). The force command 88 is continually optimized per current user feedback, for example. A user movement sensor 104 is coupled to the controller 50 and is configured to sense the motion input 56 from the user 75 on the closure member to move the closure member. Door motion feedback 105 is also provided from the closure member (e.g., door 12) back to the user 75. Again, the power closure member actuation system 20 further includes at least one closure member feedback sensor 64 for determining at least one of a position and speed of the closure member. The at least one closure member feedback sensor 64 detects the position and/or speed of the closure member, as described above for the automatic mode, and can provide corresponding position/motion information or signals to the controller 50 concerning how the user 75 is interacting with the closure member. For example, the at least one closure member feedback sensor 64 determine how fast the user 75 is moving the closure member (e.g., door 12). The attitude or inclination sensor 86 may also determine the angle or inclination of the closure member and the power closure member actuation system 20 may compensate for such an angle to assist the user 75 and negate any effects on the closure member motion that the change in angle causes (e.g., for example changes regarding how gravity may influence the closure member differently based on the angle of the closure member relative to a ground plane).

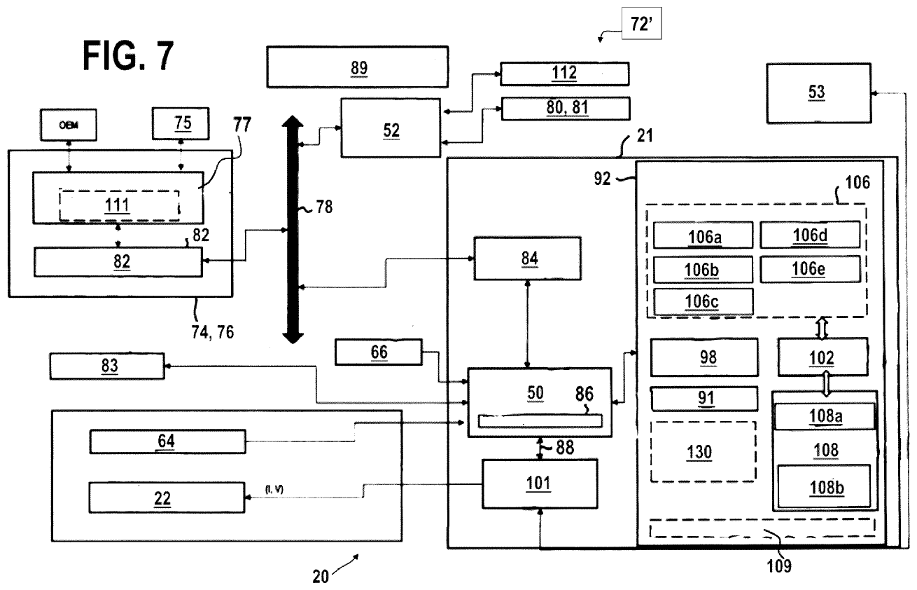

Like the vehicle system architecture shown in FIG. 5, a vehicle system architecture 72″ corresponding with operation of the power closure member actuation system 20 of FIG. 6 in the powered assist mode is shown in FIG. 7. Again, the power closure member actuation system 20 includes the user interface 74, 76 that is configured to detect a user interface input to modify at least one stored motion control parameter associated with the movement of the closure member. The controller 50 of the power closure member actuation system 20 or user modifiable system is configured to present the at least one stored motion control parameter on the user interface 74, 76 (e.g., displayed parameters and functions 111). The controller 50 is also configured to modify the at least one stored motion control parameter stored in the memory device 92 in response to detecting the user interface input. So, the memory device 92 stores the at least one stored motion control parameter and other closure member parameters 106 used by the system 20 for assisting the user 75 with moving the closure member, such as weight 106a, and dimensions of the closure member 106b, closure member inertia 106c, closure member friction 106d, other closure member attributes 106e any mathematical models of the closure member (e.g., closure member model 102), any models of physical components 108 (e.g., door seal model 108a, actuator time/wear/temperature based model 108b) influencing the closure member motion that may vary over time due to wear, for example, and door functions 109 (e.g., anti-pinch, door check).

Consequently, the controller 50 is configured to generate the force command 88 based on the at least one stored motion control parameter and the at least one environmental condition 59 to control the actuator output force acting on the closure member to move the closure member. Again, the closure communications interface control unit 84 is coupled to a vehicle bus 78 and to the controller 50 to facilitate communication between the controller 50 and the vehicle bus 78. The pulse width modulation unit 101 is coupled to the controller 50 and is configured to receive the pulse width control signal and output the actuator command signal corresponding to the pulse width control signal. As in FIG. 5, the closure communications interface control unit 84 is coupled to the vehicle bus 78 and to the controller 50 to facilitate communication between the controller 50 and the vehicle bus 78.

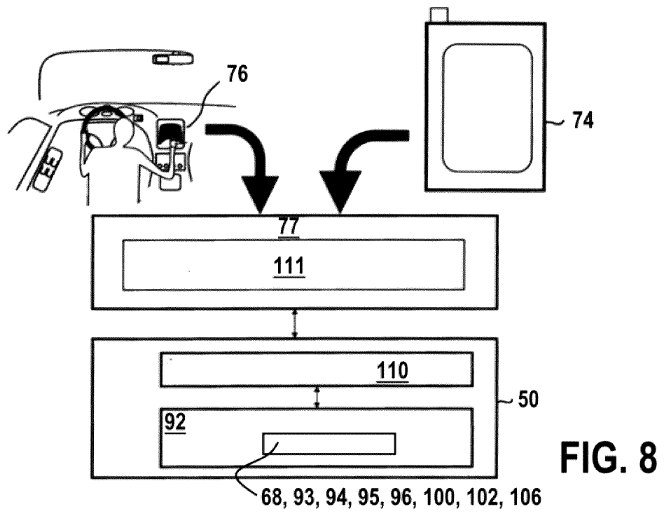

As best shown in FIG. 8, the user interface 74, 76 of the power closure member actuation system 20 can comprise a mobile device 74 configured to communicate wirelessly with the controller 50. As an alternative, or in addition to the mobile device, the user interface 74, 76 can comprise a control console 76 disposed in the vehicle 10. In either case, the user interface 74, 76 displays the at least one stored motion control parameter and communicates the user interface input to the controller 50. The controller 50 includes a processor or other computing unit 110 in communication with the memory device 92, which stores the at least one stored motion control parameter.

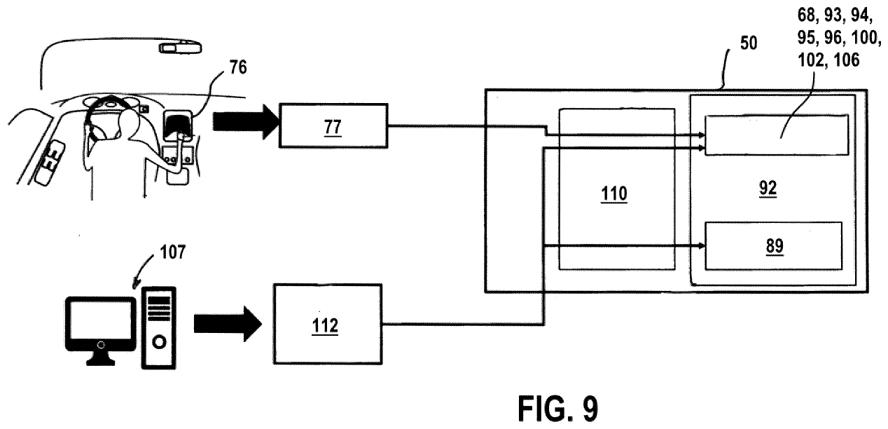

As best shown in FIG. 9, the at least one stored motion control parameter of the power closure member actuation system 20 can, for example, be modified by the user 75 using the user interface 74, 76. Thus, the at least one stored motion control parameter can include a plurality of user motion control parameters that are modifiable by the user 75 using the user interface 74, 76. However, manufacturers 107 utilizing the power closure member actuation system 20 in a vehicle 10 may prefer to restrict modification of certain parameters to ensure desirable operation of the power closure member actuation system 20. Consequently, the at least one stored motion control parameter can also include a plurality of manufacturer motion control parameters being modifiable by the manufacturer 107 (e.g., modified using an OEM interface 112 and stored in the memory device 92 as shown in FIG. 5 or elsewhere as shown in FIG. 7). Such manufacturer motion control parameters 89, such as pop-out profiles (motion profile for presenting the closure member to the user 75) are not modifiable by the user 75. For example the latch pop-out can be tuned to ensure the latch 83 will transition to an open state correctly (e.g., too slow a pawl may reengage, too fast and a pawl of the latch 83 may not disengage a ratchet of the latch 83).

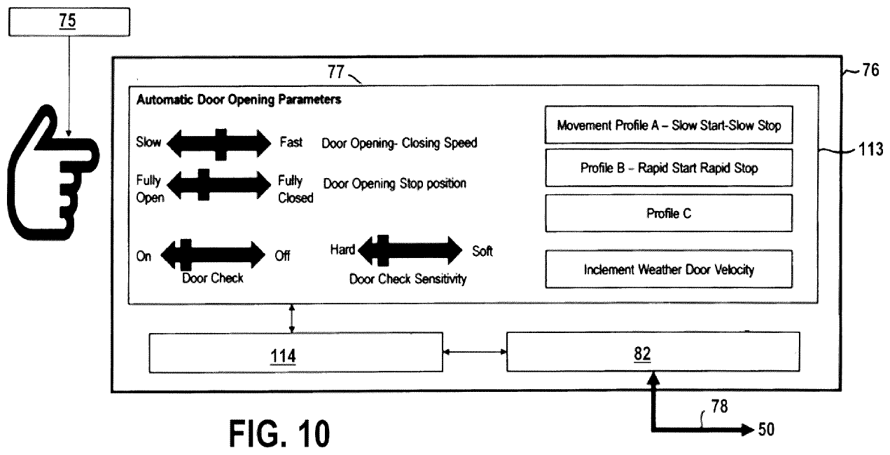

Discussing the automatic mode in more detail, FIG. 10 illustrates that the user interface 74, 76 includes a touch screen 113 of the control console 76 disposed in the vehicle 10 configured to display the at least one stored motion control parameter and receive the user interface input. As shown and as previously discussed, the screen communications interface control unit 82 is in communication with the closure communications interface control unit 84. A touch screen controller 114 is coupled to the touch screen 113 and the screen communications interface control unit 82 and is configured to communicate the user interface input to the controller 50 using the screen communications interface control unit 82. FIG. 10 also shows the at least one stored motion control parameter that may be adjusted or modified by the user 75 for the automatic mode. The at least one stored motion control parameter may include one of a closure member opening and closing speed and a closure member opening stop position and a door check sensitivity; however, it should be appreciated that additional or other parameters may be used for the at least one stored motion control parameter.

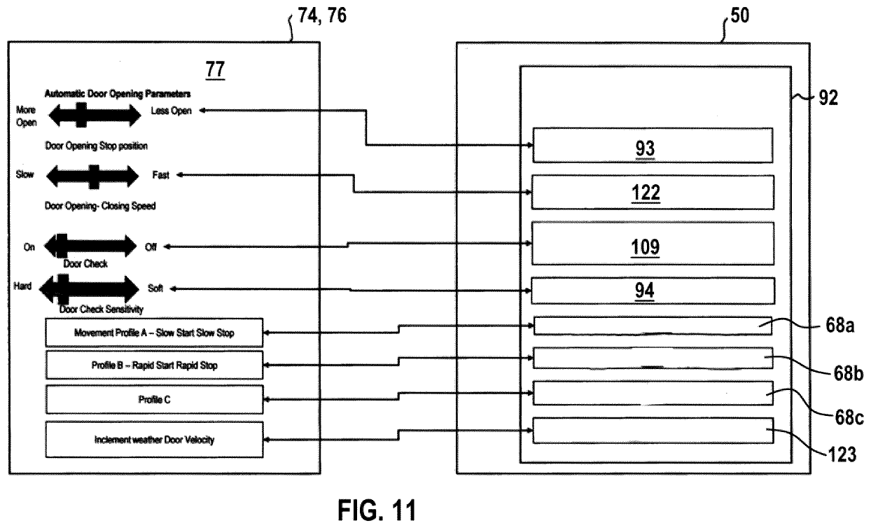

FIG. 11 shows that the at least one stored motion control parameters include a plurality of stored motion control parameters associated with the automatic mode that may be mapped to corresponding memory locations in the memory device 92. One of the memory locations is for a velocity during detected inclement weather 123. The user interface 74, 76 will display the current value stored in the memory device 92, and also the limits to which the user 75 is allowed to modify these values based on system calibration limits, for example. Thus, the user 75 is not able to exceed the operating parameter value which could damage the closure member (e.g., door 12) during operation. For instance, the user 75 will not be able to set an opening closing speed which would cause the closure member to slam the hard stop open position which may cause damage to the hinges.

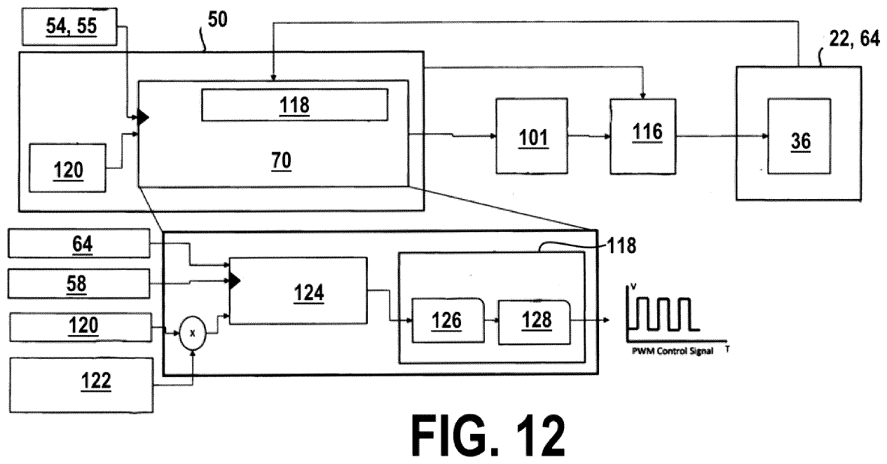

Referring now to FIG. 12, after receiving the automatic mode initiation input 54 the controller 50 enters the automatic mode. As discussed above with reference to FIGS. 5 and 7, the pulse width modulation unit 101 is coupled to the controller 50 and configured to receive the pulse width control signal and output an actuator command signal corresponding to the pulse width control signal. An H bridge 116 is coupled to the pulse width modulation unit and is configured to apply a control voltage to the actuator 22 based on the actuator command signal. A power signal generator 118 is coupled to the controller 50 (or may be part of the controller 50 itself) and is configured to generate a pulse width modulation control signal to actuate an actuator 22 of the power closure member actuation system 20 to move the closure member (e.g., using the motion command generator 70 of the controller 50 that is triggered by the automatic mode initiation input 54, door switch 58, or commands 55 from the vehicle 10 and receiving position feedback from the actuator 22, 64). Thus, the controller 50 is configured to receive the user interface input to modify the at least one stored motion control parameter using the user interface 74, 76. The controller 50 is also configured to modify the at least one stored motion control parameter stored in the memory device 92 and generate one of a force command 88 and a motion command 62 for supply to the power signal generator 118 using the at least one stored motion control parameter. In addition, the user interface 74, 76, power signal generator 118, memory device 92 and controller 50 may, for example, comprise an electronic control system for the power closure member actuation system 20.

Again, the controller 50 is further configured to receive the at least one of the position and speed of the closure member from the at least one closure member feedback sensor 64 in the automatic mode. The controller 50 calculates the motion command 62 based on the at least one of the position and speed of the closure member and a function of a target motion velocity 120 and a motion velocity adjustment factor 122 in response to receiving the automatic mode initiation input 54 using a motion command calculator 124 of the controller 50 in the automatic mode. The controller 50 generates a pulse width modulation control signal based on the motion command 62 using a duty cycle register 126 and a comparator 128 of the pulse width modulation control signal generator 118 of the controller 50 in the automatic mode. The controller 50 is also in communication with the closure member switch 58 that is configured to output the closure member trigger signal (e.g., through the body control module 52). So, the automatic mode initiation input 54 can be the closure member trigger signal from the closure member switch 58.

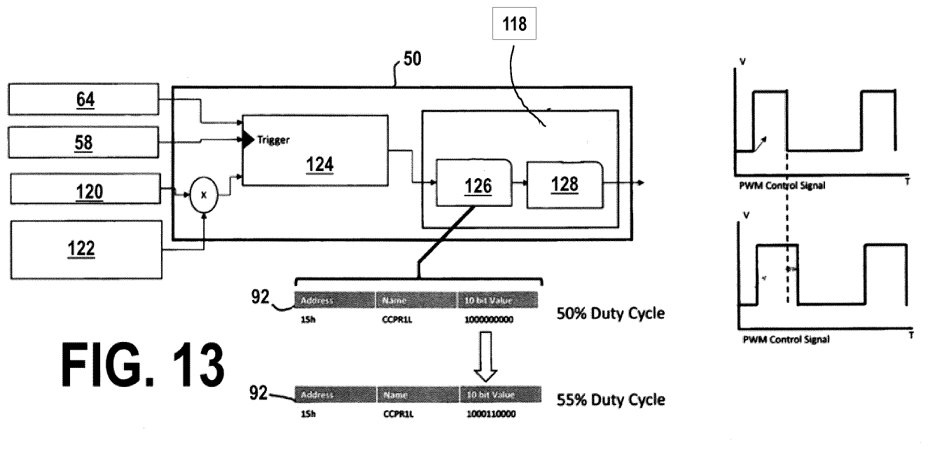

FIG. 13 illustrates example changes to the duty cycle register corresponding to a change in the pulse width modulation duty cycle from 50% to 55%. Such a change may be prompted by the calculation of the motion command 62 by the motion command calculator of the controller 50. Consequently, the pulse width modulation duty cycle of the pulse width modulation control signal increases as shown.

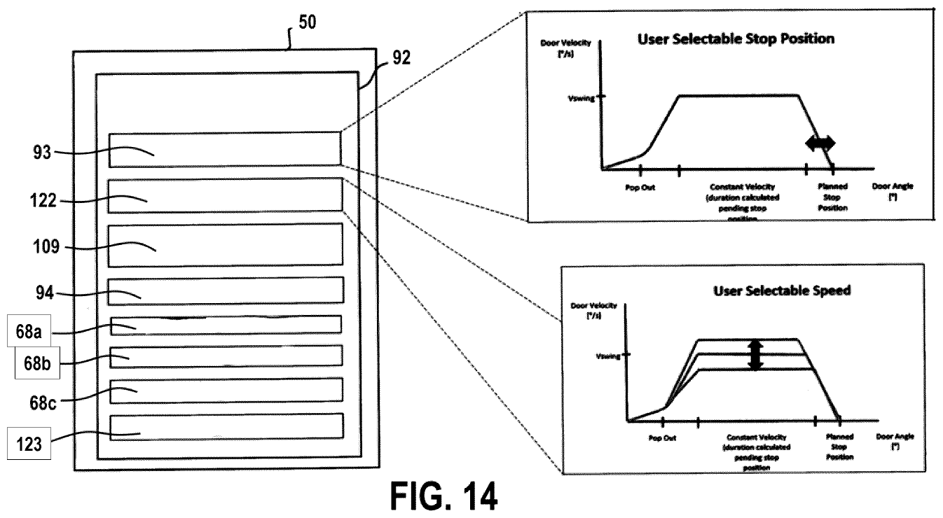

FIG. 14 shows stored motion control parameters stored in the memory device 92. Each of the stored motion control parameters can be translated into a change in the motion profile related to a velocity of the closure member for each of a plurality of closure member angles, for example. As shown, a pop out position (e.g., for presenting the closure member to the user 75) is reached by ramping the velocity of the closure member to a first predetermined velocity. Next, the velocity of the closure member is then ramped to a second predetermined velocity Vswing, which remains constant for a calculated duration based on a planned stop position. The velocity of the closure member is ramped down from the second predetermined velocity until the closure member reaches the planned stop position. Such a second predetermined or motion velocity can be adjusted by the user 75 as shown.

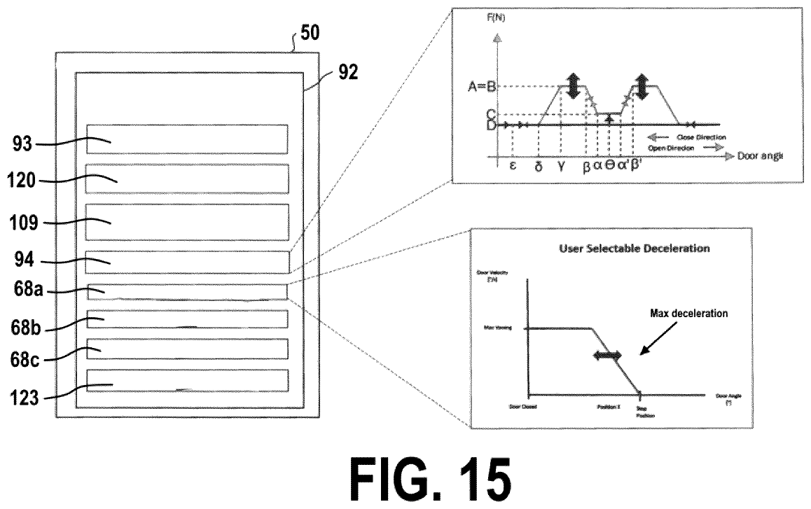

FIG. 15 shows additional stored motion control parameters stored in the memory device 92 including a door check sensitivity and a movement profile. The movement or motion profile can be adjusted by for a user selectable deceleration (e.g., as the velocity of the closure member is ramped down from the second predetermined velocity until the closure member reaches the planned stop position). The user 75 can for example change a maximum deceleration rate. The door check sensitivity can allow the user 75 to change velocities of the closure member (A, B, C, D) and angles or positions of the closure member (ε, δ, γ, β, α, θ, α′, β′) for both opening and closing directions, for example.

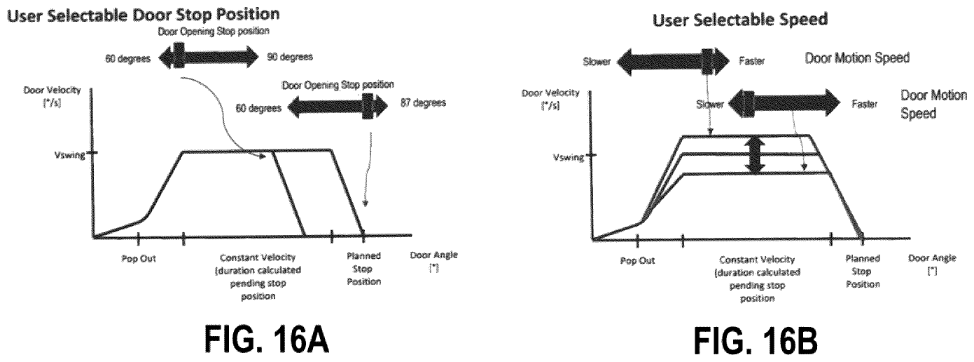

FIGS. 16A and 16B show adjustments to the motion profile related to the velocity of the closure member for each of the plurality of closure member angles. The velocity and positions are affected as shown, in response to changes or adjustments by the user 75 to stored motion control parameters including a closure member opening stop position (FIG. 16A) and second predetermined velocity Vswing being adjusted (FIG. 16B).

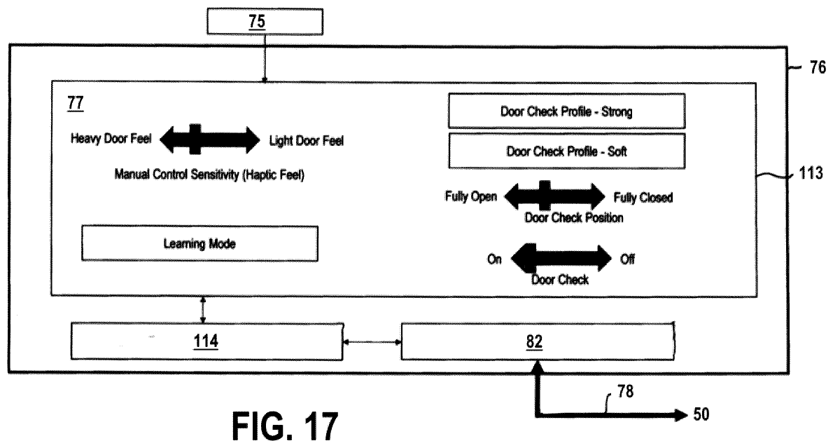

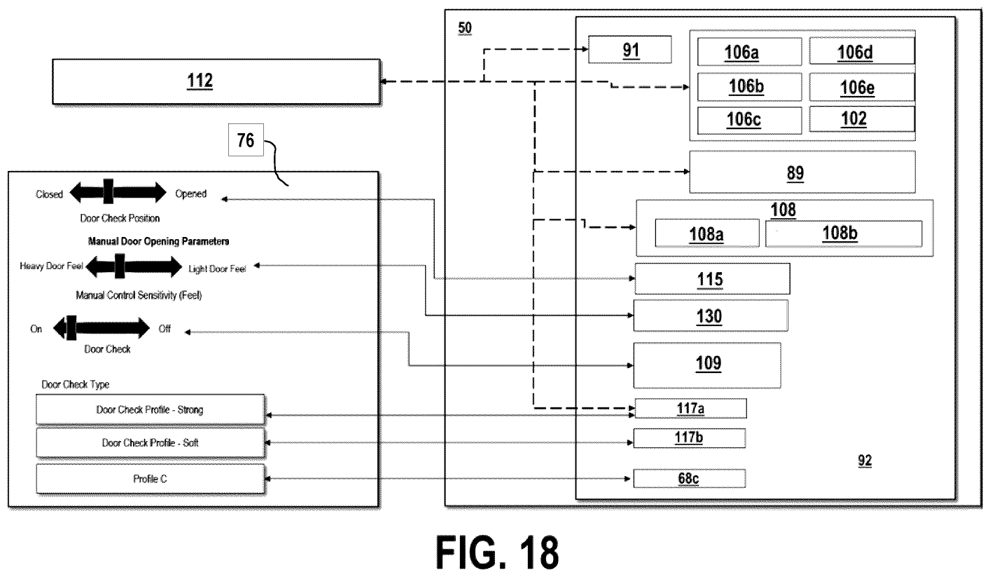

As discussed above, the controller 50 is configured to receive the motion input 56 and in response enter the powered assist mode. As in FIG. 10 above, the user interface 74, 76 shown in FIG. 17 includes the touch screen of the control console disposed in the vehicle 10. In addition to displaying the at least one stored motion control parameter for the automatic mode, the touch screen is configured to display the at least one stored motion control parameter and receive the user interface input for the powered assist mode. For example, a “feel” of the closure member as the user 75 moves it (i.e., the motion input 56) may be adjusted through the user interface 74, 76 in addition to closure member check profiles and positions. Again, the screen communications interface control unit 82 is in communication with the closure communications interface control unit 84. The touch screen controller 114 is coupled to the touch screen and the screen communications interface control unit 82 and is configured to communicate the user interface input to the controller 50 using the screen communications interface control unit 82. Thus, the at least one stored motion control parameter can be adjusted or modified by the user 75 for the powered assist mode. FIG. 18 shows that the plurality of stored motion control parameters associated with the powered assist mode may be mapped to corresponding memory locations in the memory device 92. Such memory locations can, for example, include door check positions 115, a strong door check profile 117a, and a soft door check profile 117b. Again, the user interface 74, 76 will display the current value stored in the memory device 92, and also the limits to which the user 75 is allowed to modify these values based on the system calibration limits, for example. Therefore, the user 75 is not able to exceed the operating parameter value which could damage the closure member during operation. For example, the user 75 will not be able move the closure member over a given speed if the closure member is on an extreme grade.

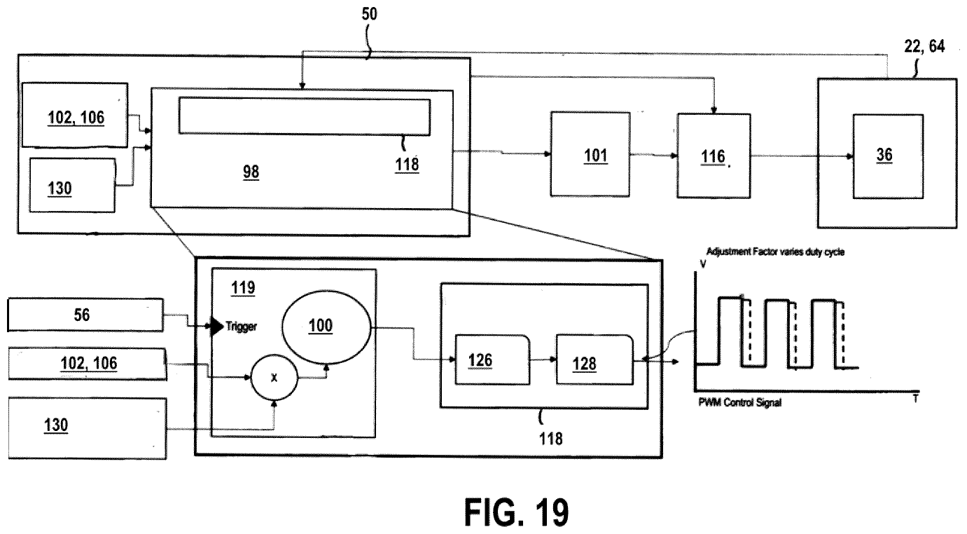

As best shown in FIG. 19, the controller 50 is also configured to receive the at least one of the position and speed of the closure member from the at least one closure member feedback sensor 64 in the powered assist mode. Therefore, the controller 50 is configured to determine the force command 88 based on the motion input 56 and the at least one of the position and speed of the closure member using the force command algorithm 100 in a force command calculator module 119 of the force command generator 98 and the closure member model 102 of the controller 50 in the powered assist mode. Specifically, the motion input 56 can trigger a force command calculator output by the force command calculator module 119. For instance, the force command calculator output can equal Function(X(Multiplier)×Door parameter), such as 1.1×weight of door. Thus, the controller 50 is configured to generate a pulse width modulation control signal based on the force command 88 to vary the actuator output force acting on the closure member to assist movement of the closure member using the pulse width modulation control signal generator 118 of the controller 50 in the powered assist mode.

More specifically, as shown in FIG. 19, the controller 50 calculates the force command 88 using pre-compensation and is further configured to calculate the force command 88 based on the motion input 56 and a function of a force sensitivity factor 130 and the closure member model 102 in response to receiving the motion input 56 in the powered assist mode. The controller 50 is also configured to generate a pulse width modulation control signal based on the force command 88 using the duty cycle register 126 and the comparator 128 of the pulse width modulation control signal generator 118 of the controller 50 in the powered assist mode. So, based on the user change in sensitivity, for example, the system 20 will apply the force sensitivity factor to the force command calculations, which will result in a change in the input value to the duty cycle calculation by the pulse width modulation control signal generator. In this case the modification to the sensitivity is done as part of the force command calculations (pre-processing). For instance, the weight of the closure member is increased by a multiplier factor, and the force command 88 will be increased to move the closure member with more force simulating a lighter physical closure member (e.g., door 12).

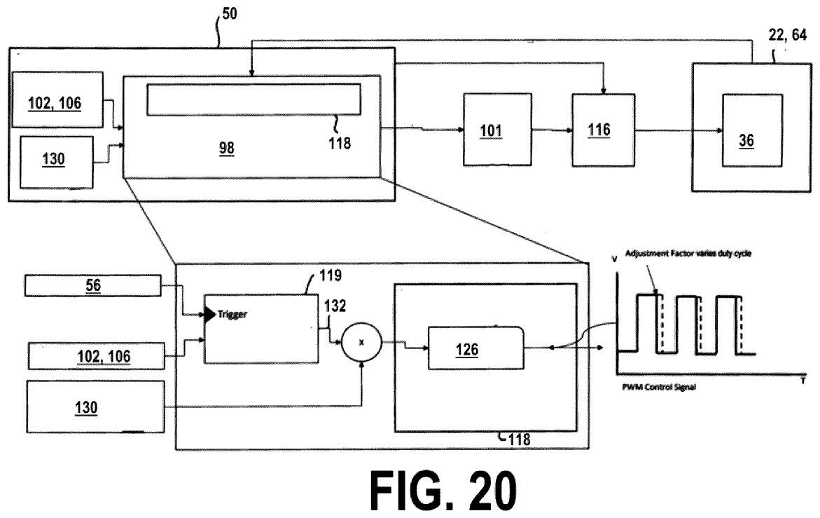

As best shown in FIG. 20, the controller 50 can alternatively calculate the force command 88 using post-compensation. For post-compensation, the controller 50 calculates the force command 88 as a function of an initial force command 132 calculated from the motion input 56 and the closure member model 102 and the force sensitivity factor 130 in response to receiving the motion input 56 in the powered assist mode. The controller 50 is also configured to generate a pulse width modulation control signal based on the force command 88 using the duty cycle register 126 of the pulse width modulation control signal generator 118 of the controller 50 in the powered assist mode. Again, the force command algorithm 98 and closure member model 102 are stored in the memory device 92 coupled to the controller 50. The closure member model 102 utilizes the plurality of model parameters 106 including at least one of a closure member weight attribute and a closure member friction attribute and a closure member inertia attribute and a closure member length attribute. So, for example, based on the user change in sensitivity, the system 20 will apply the force sensitivity factor 130 to the result of force command calculations 132 which will result in a change in the input value to the duty cycle calculation by the pulse width modulation control signal generator. The modification to the sensitivity is done by adjusting the force command 88 (post-processing).

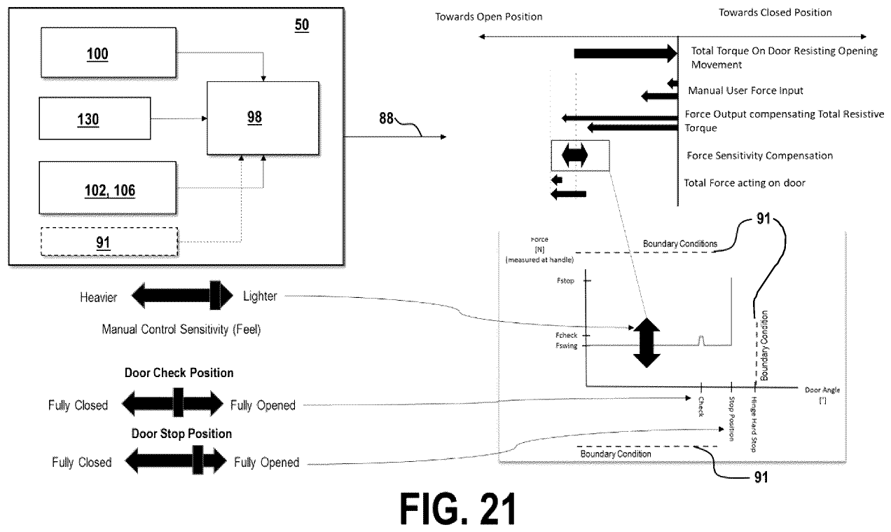

FIG. 21 shows adjustments to force profiles related to the force experienced by the closure member (e.g., measured at a handle of the closure member) for each of the plurality of closure member angles. As mentioned earlier, the controller 50 is configured to perform at least one of the initial boundary condition check prior to the generation of the command signal and the in-process boundary check during the generation of the command signal. As shown, example boundary conditions 91 (e.g., the plurality of predetermined operating limits) for the powered assist mode are shown relative to a predetermined assist force Fswing provided by the actuator 22 throughout the range of motion of the closure member until the stop position. The predetermined assist force can be adjusted as shown, but such adjustments are checked by the controller 50 to ensure that they do not exceed the boundary conditions 91. Thus, the controller 50 utilizes the boundary conditions 91 in addition to the closure member model 102, force sensitivity compensation factor 130 and force command algorithm 98 when generating the force command 88 in the powered assist mode.

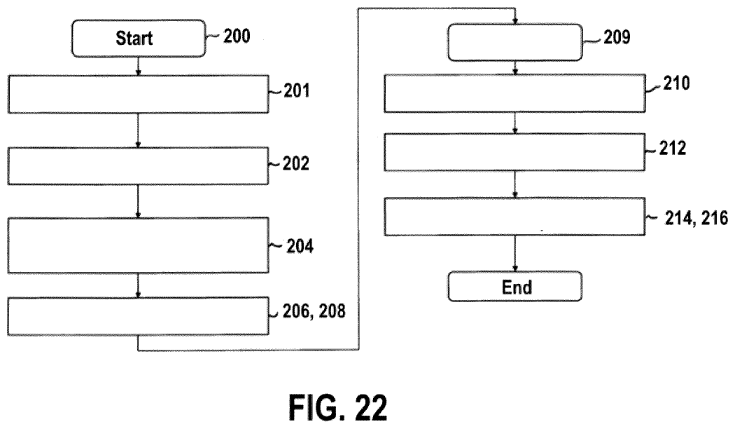

As best shown in FIGS. 22-27, a method of controlling the movement of a closure member based on a user preference is also provided. Referring initially to FIG. 22, the method includes the steps of 200 starting a user preference mode and 201 reading the at least one stored motion control parameter from a memory device 92. The method proceeds by 202 presenting at least one stored motion control parameter associated with controlling the movement of the closure member using a user interface 74, 76. The method also includes the step of 204 receiving a user interface input on the user interface 74, 76 corresponding to a modification of the at least one stored motion control parameter. The method continues with the step of 206 modifying the at least one stored motion control parameter in response to detecting the user 75 interacting using the user interface 74, 76. The next step of the method is 208 writing a modification of the at least one stored motion control parameter to the memory device 92 based on the user interface input. The method then includes the steps of 209 starting a door command generator function and 210 detecting a motion input 56 to move the closure member and in response entering a powered assist mode. The method continues with the step of 212 reading the at least one stored motion control parameter that has modified from the memory device 92 in the powered assist mode. The method also includes the step of 214 generating one of a force command 88 and a motion command 62 using the at least one stored motion control parameter (e.g., generating the force command 88 based on the motion input 56 and using the at least one stored motion control parameter in the powered assist mode) to control an actuator 22 acting on the closure member to move the closure member. The method can also include the step of 216 commanding movement of the closure member by the actuator 22 receiving the force command 88 to vary an actuator output force acting on the closure member to move the closure member in the powered assist mode.

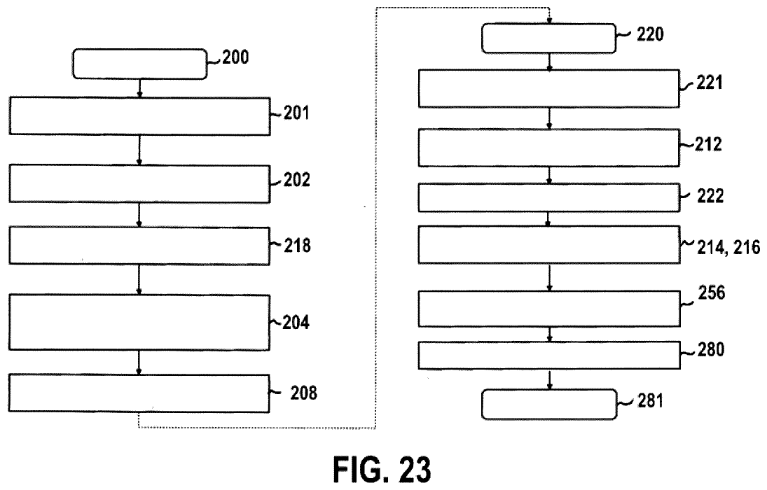

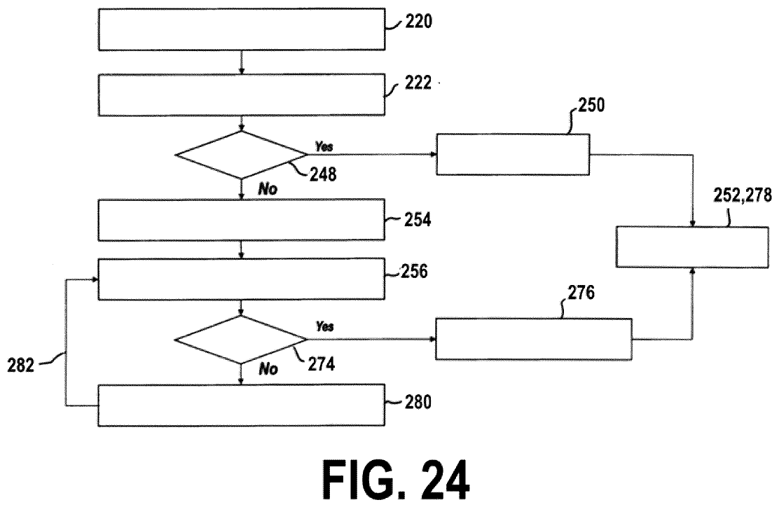

Referring to FIGS. 23 and 24, the method of controlling the movement of a closure member based on the user preference includes the steps of 200 starting a user preference mode and 201 reading the at least one stored motion control parameter from a memory device 92. The method continues with the step of 202 presenting at least one stored motion control parameter associated with controlling the movement of the closure member using a user interface 74, 76. Next, 218 displaying a plurality of predetermined operating limits of the at least one stored motion control parameter on the user interface 74, 76 based on a plurality of pre-stored calibration limits. The method continues with the step of 204 receiving a user interface input on the user interface 74, 76 corresponding to a modification of the at least one stored motion control parameter within plurality of pre-stored calibration limits (e.g., boundary conditions 91). The next step of the method is 208 writing a modification of the at least one stored motion control parameter to the memory device 92 based on the user interface input. The method then includes the steps of 220 starting a door actuation mode and 221 detecting one of a motion input 56 to move the closure member and an automatic mode initiation input 54 and entering a powered assist mode in response to detecting the motion input 56 and entering an automatic mode in response to receiving the automatic mode initiation input 54. The method proceeds by 212 reading the at least one stored motion control parameter that has been modified from the memory device 92.

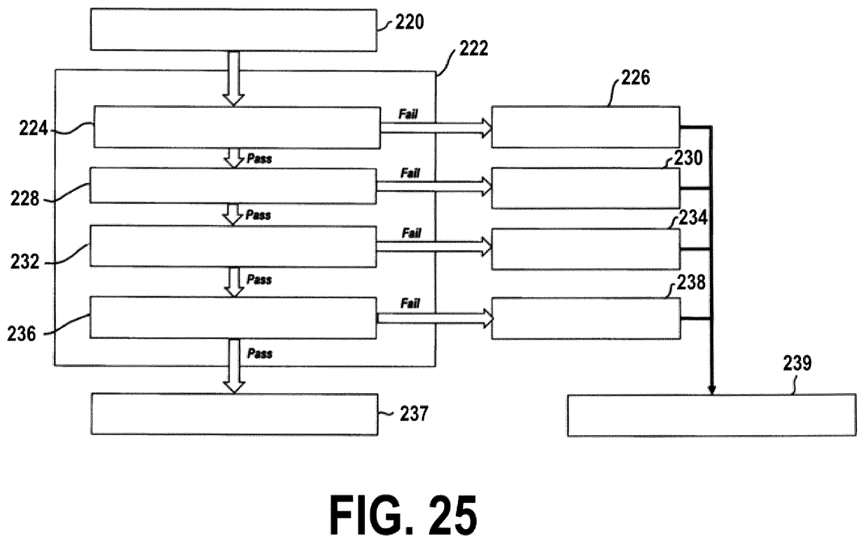

As discussed above, the controller 50 is configured to perform at least one of an initial boundary condition check prior to the generation of the command signal and an in-process boundary check during the generation of the command signal. Thus, the next step of the method is 222 performing an initial boundary check. More specifically, as best shown in FIG. 25, the step of 222 performing the initial boundary check can include the step of 224 determining whether a battery voltage is within the plurality of pre-stored calibration limits. Next, 226 registering a battery voltage error in response to the battery voltage not being within the plurality of pre-stored calibration limits. The initial boundary check 222 can continue with the step of 228 determining whether an attitude of the vehicle 10 is within the plurality of pre-stored calibration limits in response to the battery voltage being within the plurality of pre-stored calibration limits. The initial boundary check 222 can also include the step of 230 registering a vehicle attitude error in response to the attitude of the vehicle 10 not being within the plurality of pre-stored calibration limits. Next, the initial boundary check 222 includes 232 determining whether an environmental temperature is within the plurality of pre-stored calibration limits in response to the attitude of the vehicle 10 being within the plurality of pre-stored calibration limits. The method continues with the step of 234 registering an environmental temperature error in response to the environmental temperature not being within the plurality of pre-stored calibration limits. Next, 236 determining whether obstacle detection is within the plurality of pre-stored calibration limits in response to the environmental temperature being within the plurality of pre-stored calibration limits and 237 defining the one of the force command 88 and the motion command 62 to move the closure member. The initial boundary check 222 additionally includes the steps of 238 registering an obstacle detection error in response to the obstacle detection not being within the plurality of pre-stored calibration limits and 239 preventing generation of the one of the force command 88 and the motion command 62.

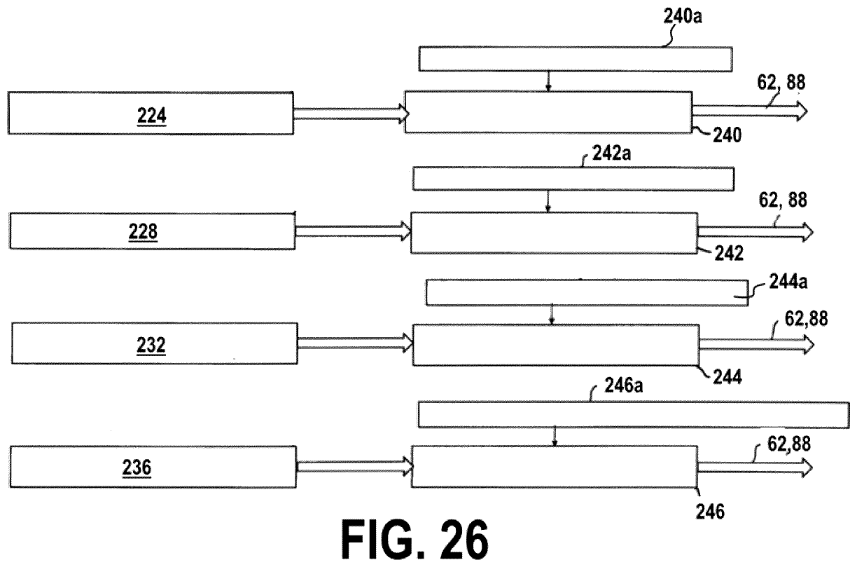

As best shown in FIG. 26, the method can also include the step of 240 adjusting the one of the force command 88 and the motion command 62 based on the battery voltage and one of a default force command 88 and a default motion command for a predetermined battery voltage (e.g., a normal battery voltage, indicated as numeral 240a). The method may also include the step of 242 adjusting the one of the force command 88 and the motion command 62 based on the attitude of the vehicle 10 and one of a default force command 88 and a default motion command 62 for a predetermined attitude of the vehicle 10 (e.g., the vehicle 10 on a flat surface, indicated as numeral 242a). Next, 244 adjusting the one of the force command 88 and the motion command 62 based on the environmental temperature and one of a default force command and a default motion command 62 for a predetermined environmental temperature (e.g., the temperature being 15 degrees Celsius, indicated as numeral 244a). The method also can include the step of 246 adjusting the one of the force command 88 and the motion command 62 based on the obstacle detection and one of a default force command and a default motion command 62 for a predetermined obstacle detection (e.g., an obstacle within a predetermined angular range of the door, indicated as numeral 246a).

Thus, the controller 50 performs an adjustment the one of the force command 88 and the motion command 62. For example, if at an extreme vehicle inclination, a continued motion of the closure member at a given speed may cause the motor 36 of the actuator 22 to overheat, however if the speed of the closure member motion is changed by the controller 50 from the user selected preferred speed, the closure member may still be opened at such an inclination, but at a lower speed, and with out over heating the motor 36. So instead of transitioning to a manual mode (in which the closure member is moved solely by the user 75), the user 75 can still have a powered operation, but at a reduced performance level, so that the system 20, such as the actuator motor 36, is not damaged. Since the user preferences may be achieved on a flat surface, the boundary checks ensure that performance can still be met at other inclinations, or states of the vehicle 10.

Referring back to FIGS. 23 and 24, the method continues with the step of 248 determining whether there is an initial error during the initial boundary check. The next step of the method is 250 preventing issuance of the one of the force command 88 and the motion command 62 and 252 stopping the closure member in response to determining there is the initial error. The method continues with the step of 254 generating the one of the force command 88 and the motion command 62 based on at least one of the position and speed of the closure member and the force command 88 based on the motion input 56 using the at least one stored motion control parameter in response to not determining the initial error.

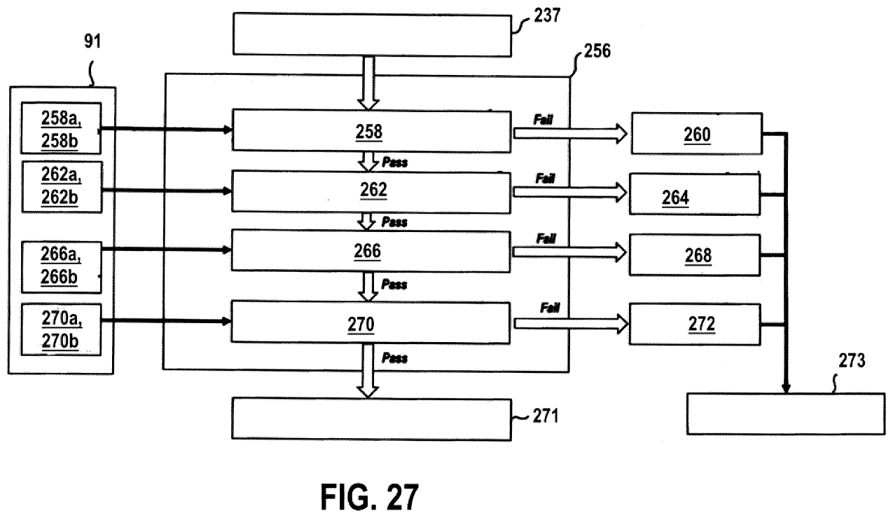

Next, the method includes the step of 256 performing an in-process boundary check during the generation of the one of the force command 88 and the motion command 62. In more detail, as best shown in FIG. 27, the step of 256 performing the in-process boundary check during the generation of the one of the force command 88 and the motion command 62 can include the step of 258 determining whether an acceleration curve of a motion profile is within acceleration limits (e.g., between a maximum acceleration limit 258a and a minimum acceleration limit 258b) of the plurality of pre-stored calibration limits or boundary conditions 91. The in-process boundary check 256 can also include the step of 260 registering an acceleration error in response to the acceleration curve not being within the acceleration limits. The in-process boundary check 256 can also include the step of 262 determining whether a velocity curve is within velocity limits (e.g., between a maximum velocity limit 262a and a minimum velocity limit 262b) of the plurality of pre-stored calibration limits or boundary conditions 91 in response to the acceleration curve being within the acceleration limits. In addition, the in-process boundary check 256 also includes the step of 264 registering a velocity error in response to the velocity curve not being within the velocity limits. Next, the in-process boundary check 256 includes 266 determining whether a deceleration curve is within deceleration limits (e.g., between a maximum deceleration limit 266a and a minimum deceleration limit 266b) of the plurality of pre-stored calibration limits in response to the deceleration curve being within the deceleration limits. The in-process boundary check 256 additionally includes the step of 268 registering a deceleration error in response to the deceleration curve not being within the deceleration limits. The method proceeds with the step of 270 determining whether an obstacle is detected within obstacle detection limits (e.g., between a maximum range detection limit 270a and a minimum range detection limit 270b) of the plurality of pre-stored calibration limits or boundary conditions 91 in response to the obstacle being detected within the obstacle detection limits. The in-process boundary check 256 also includes the steps of 271 determining one of the force command 88 and the motion command 62 to be valid and 272 registering an obstacle detected error in response to the obstacle detected not being within the obstacle detection limits and 273 stopping the closure member (e.g., stop the door, check the door or manual mode).

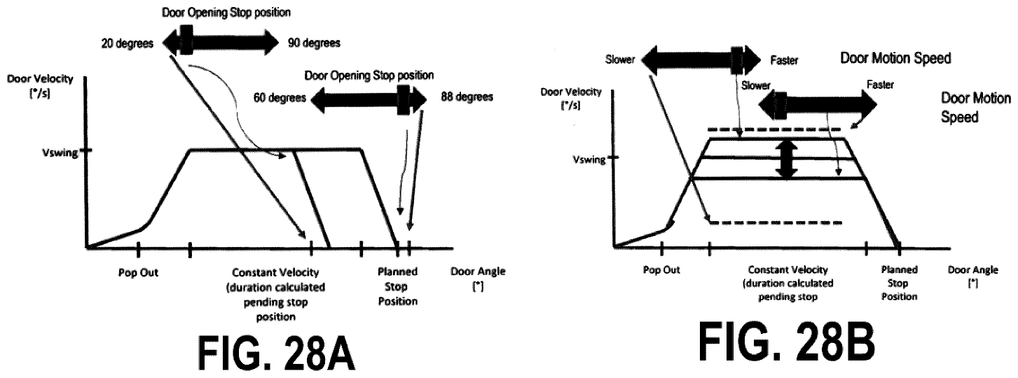

Referring back to FIG. 24, the method proceeds by 274 determining whether there is an in-process error during the in-process boundary check. The method continues with the step of 276 preventing issuance of the one of the force command 88 and the motion command 62 and 278 stopping the closure member in response to determining there is the in-process error. The next steps of the method are 280 commanding movement of the closure member by the actuator 22 receiving the one of the force command 88 and the motion command 62 to control an actuator output force acting on the closure member to move the closure member error and 281 ending the method (FIG. 23). The method also includes the step of 282 returning to the step of 256 performing the in-process boundary check in response to not determining the in-process error. FIGS. 28A and 28B show example profile modifications based on the user interface input (user selectable door stop position in FIG. 28A and user selectable speed in FIG. 28B). Also shown are examples of the plurality of pre-stored calibration limits for the motion profiles 68.

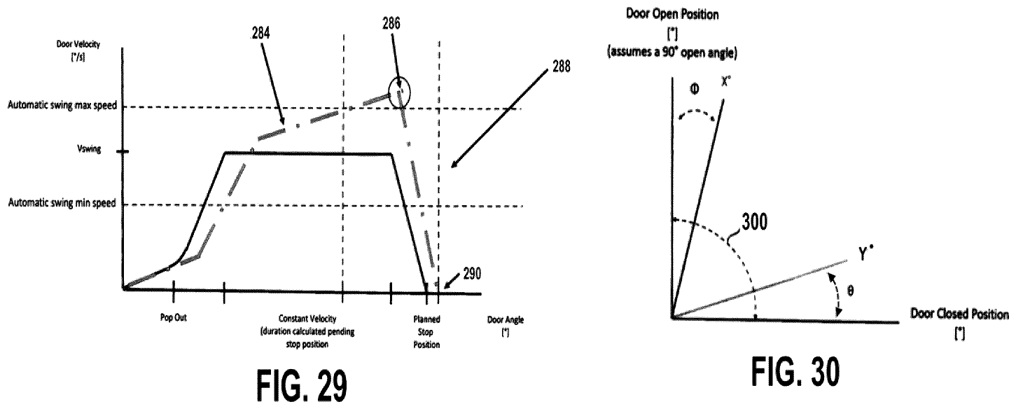

FIG. 29 illustrates example motion of the closure member outside of the plurality of pre-stored calibration limits. As shown, the actuator 22 may be commanded to brake the closure member as a result of the detection of the in-process error during the in-process boundary check to ensure that the closure member stops before reaching the hard stop position. As indicated by numeral 284, the door inclination changes (e.g., the user 75 has jacked up one side of the vehicle 10 to change a tire, causing the door to increase velocity during opening). At numeral 286, the door velocity increases beyond a calibration limit (boundary limit 91) (e.g., motor 36 would be insufficient to brake the door before reaching a hard stop if velocity is allowed to further increase). At numeral 288, an in process error is detected, the motor 36 is commanded to brake door to ensure that door stops before reaching the hard stop position and the max full travel position is shown at numeral 290.

So, the user interface 74, 76 may display user modifiable values limits as a function of the boundary conditions 91 or the plurality of pre-stored calibration limits, for example, in response to detecting the state of the vehicle 10 (battery level, inclination, temperature), and/or the controller 50 may check before operation that the closure member can be moved (initial boundary check), and the controller 50 can be configured to check during operation (in process) that the boundary limits are not exceeded, for example due to an extreme user input when the vehicle 10 is in an extreme operating state (e.g. hot temperature, extreme inclination).

FIG. 30 illustrates a range of movement of the closure member (e.g., door 12) between the open position and a closed position. While the open position and the closed position are shown as being 90 degrees apart from one another, it should be understood that other configurations and movements of the closure member 12 are contemplated (e.g., the open position and the closed position may be greater than or less than 90 degrees from one another). Based on the position and/or speed of the closure member 12 detected by the at least one closure member feedback sensor 64, the controller 50 can control the actuator 22 to prevent or minimize slamming of the closure member 12 (e.g., to prevent abuse by the user 75). Slam control conditions depend on the direction of the slam (opening or closing) and the angle at which the slam is detected. The angles X and Y shown in FIG. 30 are example slam control conditions in the open and close directions respectively and a full travel angle is indicated at 300.

Abuse caused by slamming of the closure member 12 may cause damage to the vehicle latch 83, vehicle door 12, door hinges 16, 18, and also may cause damage to the actuator 22 when the slam causes the actuator 22 to exceed an operating rating of the actuator. For example, a slam of the closure member 12 may itself cause the actuator 22 to operate above an operating rating which may cause damage to the actuator 22 leading to shortened life and reduced performance, and ultimately lead to failure requiring a replacement or repair of the actuator 22. In one example, the slam of the closure member 12 may cause the actuator 22 to operate above an operating rating, and for example cause the motor 36 of the actuator 22 to rotate above a maximum rotational speed limit of the motor 36 which above such speed limit may cause damage to the motor 36 in the form of a separation of coil windings due to high centrifugal forces in the configuration where the actuator 22 includes a DC brushed motor, or other types of damage. Such a slam event of the closure panel 12 may cause such exceeding of the maximum rotational speed limit of the motor 36, particularly when a gear reduction unit is coupled to the motor output causing a speed increase to the motor 36 as a result of a slower movement of the closure member 12. Furthermore, abuse caused to the actuator 22 responding to a slamming event in order to mitigate the damage caused by the slam to the vehicle door, latch, door hinges or the like, may also cause damage to the actuator 22 controlled in response, for example as a result of controlling the actuator 22 to reduce the speed of the closure member 12 caused by a slam without regards to the actuator 22 being controlled to exceed operating limits or ratings of the actuator 22 in order to meet such speed reductions, for example to ensure that the closure member 12 is stopped before undergoing a hard stop. For example, the present disclosure provides for control of the actuator 22 for responding to a slam event within the operating limits of the actuator 22 to prevent and/or mitigate damage to the actuator 22 resulting from a slam event, and for example control of the actuator 22 to maintain operation of the actuator 22 below a maximum rotational speed of the motor 36 (e.g. excessive speed may cause coil windings to become detached or separated), a maximum power rating of the motor 36 (e.g. excessive power supplied to the motor 36 of the actuator 22 may cause damage to electrical components and/or cause overheating), a maximum back electromotive force (EMF) output rating (e.g. allowing a motor 36 to be backdriven as a result of a slam of a closure member 12 without reducing the speed of the backdriven motor 36 may cause an excessive amount of back electromotive force voltage generated by the motor 36 resulting in overloading of electronic components, such as the controller 50 or other back EMF protection circuitry), a maximum thermal rating (e.g. operating the motor 36 for a long period of time in a stall or slow moving closure member as a result of an inclination of the door 12 against which the actuator 22 has to control movement of the door 12), and a maximum electrical braking rating (e.g. excessive power supplied to the motor 36 of the actuator 22 may damage to electrical components and/or lead to overheating). Other actuator limits or ratings are contemplated, such as any ratings or limit related to a speed reduction gear train coupled to the output of the motor 36.

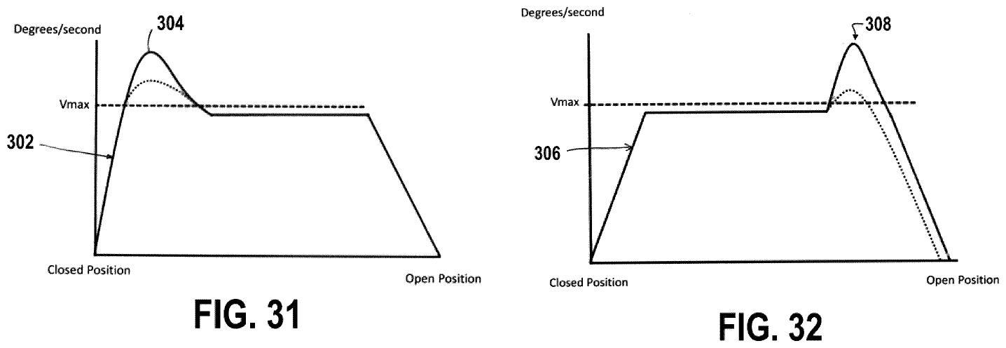

As shown in FIG. 31, there is an example of a slam of the closure member 12 towards the open position. Specifically, at numeral 302, the door begins to open in the automatic mode, but the user 75 decides to slam the door towards the open position causing an initial speed of the closure panel to exceed a predetermined maximum speed threshold Vmax, illustrated as a peak 304 as detected by the controller 50, resulting in the speed of the motor as backdriven through a speed reduction geartrain as a result of the slam exceeding a maximum speed rating of the motor 36, which may cause damage, for example causing the motor coils of a brush DC motor to separate. Also as a result a large spike in EMF may be generated by the slam in the motor, causing damage to electronic components connected to the motor 36.

Similarly, FIG. 32 illustrates an example of a slam of the closure member 12 towards the open position. Specifically, at numeral 306, the door begins to open in the automatic mode, but the user 75 decides to slam the door towards the open position causing an initial speed of the closure member 12 to exceed a predetermined maximum speed threshold Vmax, illustrated as a peak 308 as detected by the controller 50, resulting in the speed of the motor 36 as backdriven through a speed reduction geartrain as a result of the slam exceeding a maximum speed rating of the motor 36, which may causing damage, for example causing the motor coils of a brush DC motor to separate. Also as a result a large spike in EMF may be generated by the slam in the motor 36, causing damage to electronic components connected to the motor 36.

The control techniques as described herein will detect such a slam event causing the closure member 12 to exceed a predetermined maximum speed threshold and in response the controller 50 will control the actuator 22 to resist the motion of the closure member 12 towards the open position, for example by employing a dynamic braking or rheostatic braking control of the motor 36, or a DC injection braking control as examples. In order for the actuator 22 not to exceed its operating limits or ratings, the controller 50 described herein may be configured to control the actuator 22 such that the closure member 12 may be allowed to move to a hard stop position, or before a hard stop position (e.g. a secondary latch position) with a velocity (such as a non-zero velocity) having been reduced by the actuator 22 by a degree without operating the actuator 22 to limit which may cause damage thereto as shown in FIG. 32, as a result of a detection of a slam event, for example as a result of the closure member 12 exceeding a Vmax or predetermined speed threshold as in response controlling the actuator 22 to resist the motion of the closure member 12 before the door 12 is allowed to develop potential energy and increase in velocity. Since the actuator 22 is configured to resist the door motion, and not a mechanical brake or clutch or other type of mechanical coupling, promptly reducing the speed of the closure member 12 as a result of a slam initiated by a user allows the actuator to control and reduce the speed of the closure member 12 to within safe operating limits of the actuator 22 without causing excessive strain on the actuator 22 (shown as the dotted lines in FIGS. 31 and 32). As a result, the slam effects on the vehicle door 12 and components such as the latch 83 and hinge 16, 18 may be mitigated and damage to the actuator 22 may be avoided.

Thus, the controller 50 of the power closure member actuation system 20 is configured to monitor the at least one of the position and the speed of the closure member 12 using the closure member feedback sensor 64. The controller 50 is also configured to generate a command to reduce the speed of the closure member 12 as the closure member moves towards one of the open position and the closed position based on the at least one of the position and the speed of the closure member 12. The controller 50 is additionally configured to control movement of the closure member 12 by the actuator 22 receiving the command to vary an actuator output force acting on the closure member 12 to move the closure member 12. The controller 50 is configured to control movement of the closure member 12 by the actuator 22 to resist the movement of the closure member towards one of the open position and the closed position without exceeding an operating rating of the actuator which can damage the actuator based on the position and the speed of the closure member 12 determined using the closure member feedback sensor 64, which may be for example an accelerometer 87 in communication with controller 50. To increase sensitivity of detection of a slam event to allow the controller to react quickly and begin controlling the actuator to provide resistance to the door movement cause by a slam, the accelerometer 87 may be provided opposite the door hinges, for example and may be provided as part of the latch. The control of slamming discussed herein depends on the direction of the slam (e.g., the closure member 12 being slammed toward the open or closed positions) and the position or angle (for swing doors) of the closure member 12 where the slam is detected. Consequently, the speed or velocity of the closure member 12 can be an angular velocity. A first predetermined closure member angle Φ or X° (FIG. 30) is shown as an important condition for slam in the open direction (i.e., movement of the closure member toward the open position) and a second predetermined closure member angle θ or Y° (FIG. 30) is shown as an important condition for slam in the close direction (i.e., movement of the closure member toward the closed position).

As discussed, the controller 50 is operable in at least one of the automatic mode and the powered assist mode. In addition, the controller 50 is also operable in an anti-slam mode. In more detail, the controller 50 is configured to control the actuator 22 in one of the automatic mode and the powered assist mode to move the closure member 12. The controller 50 then determines whether the speed of the closure member 12 is greater than a predetermined maximum speed threshold. The controller 50 is then configured to continue to control the actuator 22 in one of the automatic mode and the powered assist mode to move the closure member 12 in response to the speed of the closure member 12 not being greater than the predetermined maximum speed threshold. In addition, the controller 50 is configured to exit the one of the automatic mode and the powered assist mode and enter the anti-slam mode in response to the speed of the closure member 12 being greater than the predetermined maximum speed threshold.

As explained above, the controller 50 is coupled to the cinch actuator or motor 99 of the latch 83 that moves the closure member (e.g., door 12) from a latch secondary position to a latch primary position. Thus, the controller 50 is further configured to detect a direction of movement of the closure member 12. The controller 50 is configured to determine whether the angle of the closure member 12 is less than the first predetermined closure member angle Φ in response to detecting that the closure member 12 is moving toward the open position.

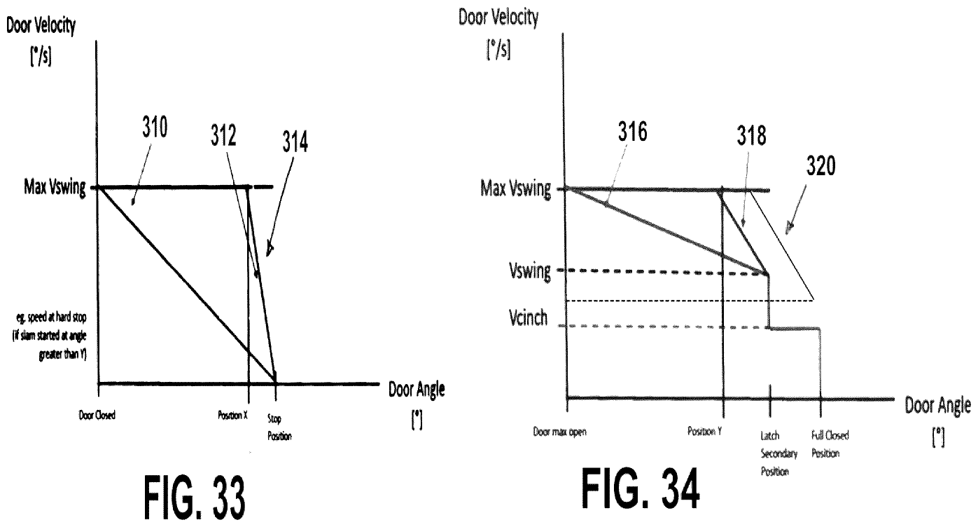

As best shown in FIG. 33, if the closure member 12 is moving toward the open position, the controller 50 is generally configured to vary a rate of deceleration of the closure member 12 as the closure member is moving toward the open position depending on the angle of the closure member 12 in the anti-slam mode. The controller 50 is also configured to ensure that the angular velocity Vswing of the closure member 12 is zero at a first predetermined closure member angle Φ before an open hard stop. A minimum deceleration 310 and maximum deceleration 312 along with an example maximum deceleration 314 are shown. The rate of deceleration of the angular velocity Vswing will depend on the angle at which the slam is detected and ensuring door angular velocity=0°/s at a predetermined distance before the hard stop. Thus, the closer the slam is detected to the hard stop, the faster the door will decelerate.

More specifically, the controller 50 is configured to control the actuator 22 to reduce the speed Vswing of the closure member 12 to allow an open hard stop in response to determining that the angle of the closure member 12 is not less than the first predetermined closure member angle Φ. The controller 50 controls the actuator 22 to reduce the speed of the closure member 12 to zero at or before the open position in response to determining that the angle of the closure member 12 is less than the first predetermined closure member angle Φ. The controller 50 then determines whether a manual control is detected and determines whether the closure member 12 is in the open position in response to determining that the manual control is not detected. The controller 50 is configured to return to detect the direction of movement of the closure member 12 in response to determining that the closure member 12 is not in the open position. The controller 50 exits the anti-slam mode in response to determining that the closure member 12 is in the open position. In addition, the controller 50 controls the actuator 22 in the powered assist mode and exit the anti-slam mode in response to determining that the manual control is detected.

As best shown in FIG. 34, if the closure member 12 is moving toward the closed position, the controller 50 is configured to verify that the angle of the closure member 12 is greater than a second predetermined closure member angle θ as the closure member 12 is moving toward the closed position in the anti-slam mode. The controller 50 is also configured to slow the closure member 12 to a predetermined reference speed Vswing depending on the angle of the closure member 12 in response to verifying that the angle of the closure member 12 is greater than the second predetermined closure member angle θ. The controller 50 additionally is configured to maintain the predetermined reference speed Vswing until the closure member 12 moves to a latch secondary position. The controller 50 slows the closure member 12 to a predetermined cinch speed Vcinch position in response to verifying that the angle of the closure member 12 is not greater than the second predetermined closure member angle θ. The controller 50 is configured to allow the closure member 12 to move to the latch primary position at the predetermined cinch speed Vcinch. A minimum deceleration 316 and maximum deceleration 318 along with an example deceleration 320 after the Y position (door will drive directly into the fill closed position) are shown.

So, if the slam is detected in the closing direction the controller 50 will allow the door to fully close. The controller 50 will verify the door angle at the instant the slam is detected. If the slam detected at any door position greater than angle Y, the controller will slow the door to a Vswing and maintain Vswing speed until door enters the cinch range of the latch (angle Y is defined as full closed+TBD degrees). If the slam event is initiated at a starting door position angle less than Y, the controller 50 will slow the door however, the door will close directly into full closed position. The rate of deceleration of Vswing will depend on the angle at which the slam is detected and ensuring door angular velocity=Vswing °/s at a predetermined distance before the latch secondary position. Thus, the closer the slam is detected to the latch, the faster the door will decelerate.

In more detail, the controller 50 determines whether the angle of the closure member is greater than the second predetermined closure member angle θ in response to detecting that the closure member is moving toward the closed position. The controller 50 is configured to control the actuator 22 to reduce the speed of the closure member 12 to allow the closure member 12 to enter the latch primary position in response to determining that the angle of the closure member 12 is not greater than the second predetermined closure member angle θ The controller 50 controls the actuator 22 to reduce the speed of the closure member 12 to allow the closure member 12 to enter the latch secondary position in response to determining that the angle of the closure member 12 is greater than the second predetermined closure member angle θ The controller 50 is configured to determine whether the manual control is detected. The controller 50 controls the actuator 22 in the powered assist mode and exits the anti-slam mode in response to determining that the manual control is detected. In addition, the controller 50 determines whether the closure member 12 is at the latch secondary position in response to determining that the manual control is not detected. The controller 50 is further configured to control the cinch actuator 99 to move the closure member 12 to the latch primary position in response to determining that the closure member 12 is at the latch secondary position. The controller 50 is also configured to generate an alert signal during the control of the cinch actuator 99 (e.g., to provide audible or haptic feedback to the user 75) and return to detect the direction of movement of the closure member 12. The controller 50 returns to control the actuator 22 to reduce the speed of the closure member 12 to allow the closure member 12 to enter the latch secondary position in response to determining that the closure member 12 is not at the latch secondary position.

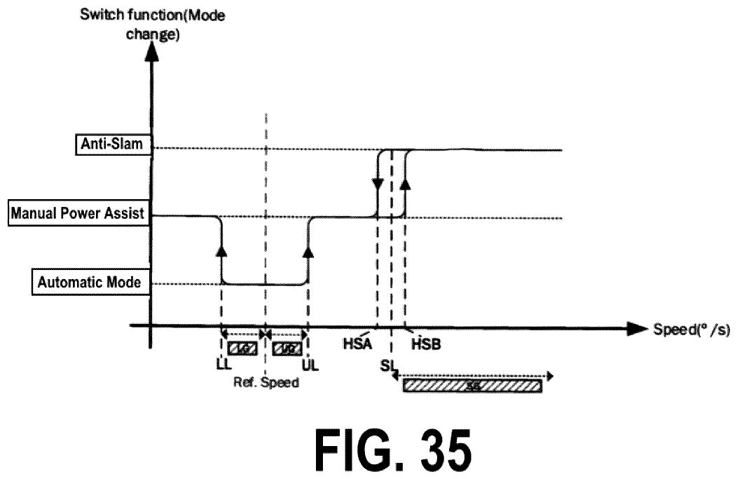

As best shown in FIG. 35, the controller 50 implements a hysteresis by dynamically updating the comparison limits used for important switching points in the algorithm. More specifically, the controller 50 is configured to allow continued movement of the closure member 12 in the automatic mode as long as the angular velocity of the closure member 12 is: (i) at a predetermined reference speed Vswing, or (ii) within an automatic mode upper gap UG between a predetermined reference speed Vswing and an automatic upper angular velocity UL, or (iii) within an automatic mode lower gap LG between the predetermined reference speed Vswing and an automatic lower angular velocity LL. The controller 50 enters the powered assist mode in response to the angular velocity of the closure member 12 being less than the automatic lower angular velocity LL, or greater than the automatic upper angular velocity UL. The controller 50 is configured to transition to the anti-slam mode once the angular velocity of the closure member 12 is a high speed upper threshold HSB greater than the predetermined maximum speed threshold SL. In addition, the controller 50 is configured to transition back to the powered assist mode once the angular velocity of the closure member 12 slows to a high speed lower threshold HSA less than the predetermined maximum speed threshold SL. Such operation helps avoid the algorithm jumping back and force from and to the switching in case of small noises and speed measurement tolerances.

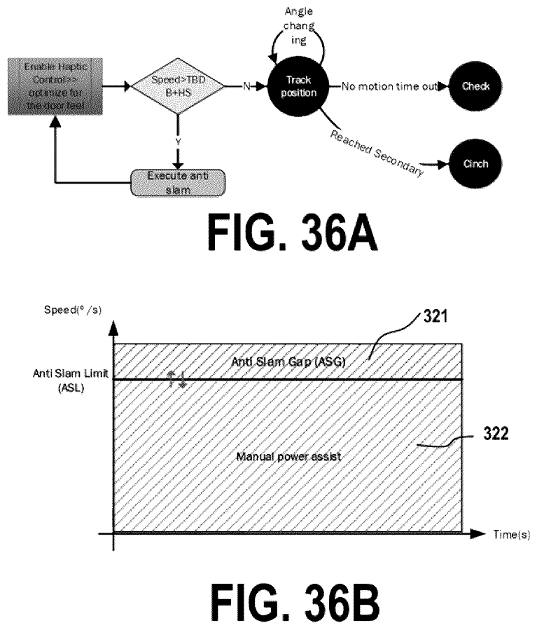

FIGS. 36A and 36B illustrate operation of the controller 50 in both the powered assist mode and the anti-slam mode. Specifically, as shown in FIG. 36B, an anti-slam gap (ASG) range 321 associated with the anti-slam mode and a manual power assist range 322 associated with the powered assist mode are shown and the controller 50 may transition between these two modes based on the speed of the closure member 12. In other words, upon execution of the anti-slam the controller 50 shall be able to switch back to the power assist mode if the speed returns to a normal reference value. This is shown via arrows in FIG. 36B to show the switching ability between modes and shall not been confused with the speed gap on acceleration/deceleration.

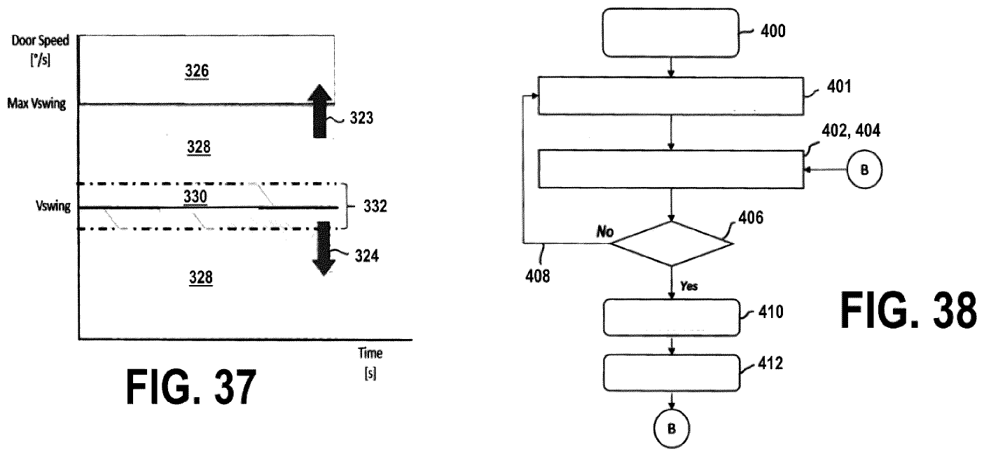

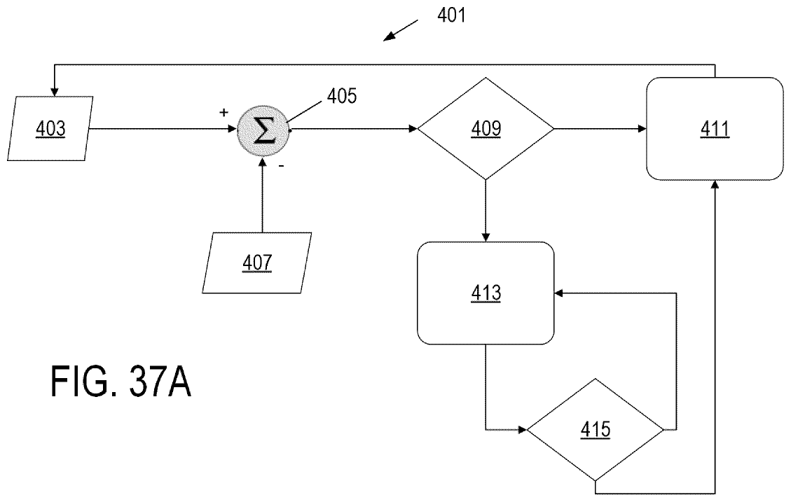

FIG. 37 illustrates the relationship between the speed of the closure member and the mode in which the controller 50 operates. The arrow labeled 323 indicates the user 75 accelerating the door out of the Vswing range and the arrow labeled 324 indicates the user 75 decelerating the door out of the Vswing range. The range of the power assist: anti slam mode is shown as 326, the range of the power assist mode is shown as 328, the range of the automatic mode is shown as 330, and an automatic speed range is shown as 332. FIG. 37A illustrates a method 401, for example as executed by the controller 50, for transitioning between the automatic mode and the power assist mode based on a detected deviation from a reference speed profile beyond the speed thresholds, such as from the upper (UL) and lower (LL) speed thresholds, as a result of a user manually moving the door 12. The non-contact detection system may be used in conjunction with the method 401 for confirming if the door 12 is being moved as a result of a user adjacent the door 12. The method 401 may include the steps of providing a reference speed profile 403, for example retrieving a stored door motion/speed profile from memory, such as memory 92, with which the door 12 is being moved in accordance with, then next at step 405 comparing, or determining a the difference between, the reference speed profile with the actual detected speed 407 of the door 12 to determine any deviations, or errors, of the door motion from the reference speed profile, then next determining if the deviation is greater than a threshold speed level in step 409, either being above the reference speed at an actual door angle by a predetermined threshold or being below the reference speed at an actual door angle by a predetermined threshold. If at step 409 the controller 50 does not determine the deviation exceeds the predetermined threshold, the method proceed with the controller 50 continuing to control the door 12 in the automatic mode at step 411 and returns to step 403. If at step 409 the controller 50 does determine the deviation exceeds the predetermined threshold, the method proceeds with the controller 50 transitioning to the power assist mode at step 413. If next at step 415 the controller 50 determines after receiving an automatic mode command e.g. a door close command using automatic mode, the controller 50 will determine if the speed of the door is zero, or in other words if the door is stationary. If the door is stationary, the controller 50 may proceed at step 411 to control the door in automatic mode. If the controller 50 does not determine that the door is stationary when the automatic mode command is received, the controller 50 may continue to control the door in the power assist mode at step 413. Verifying that the door is stationary before controlling the door in the automatic mode ensures that the power assist mode is not overridden, for example by an automatic mode command from a switch interior the vehicle, by e remote FOB, or the like as examples, to ensure the user moving the door using the power assist mode maintains in control of the door in power assist mode without being overridden by another operating mode of the system 20. Therefore the power assist mode whereby a user is in control and contacting the door is prioritized over other sources of control.

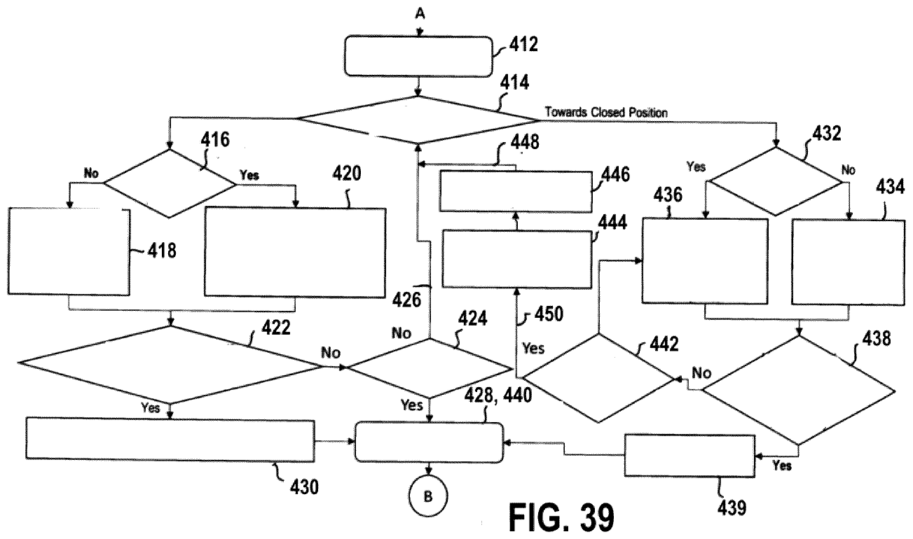

As best shown in FIGS. 38 and 39, a method of controlling the movement of a closure member 12 of the vehicle 10 between open and closed positions relative to the vehicle body 14 based on at least one of the position and the speed of the closure member 12 is also provided. The method includes the steps of 400 starting the door command generator function and 401 moving the closure member 12 relative to the vehicle body 14 using an actuator 22 of the power closure member actuation system 20 coupled to the closure member 12 and the vehicle body 14 (e.g., toward the open position). As discussed, the controller 50 is operable in at least one of the automatic mode, the powered assist mode, and the anti-slam mode. Thus, the method also includes the step of controlling the actuator 22 in one of the automatic mode and the powered assist mode to move the closure member 12. The method continues with the step of 402 determining at least one of a position and a speed of the closure member 12 using a closure member feedback sensor 64 of the power closure member actuation system 20. The next step of the method is 404 monitoring the at least one of the position and the speed of the closure member 12 using a controller 50 of the power closure member actuation system 20 coupled to the closure member feedback sensor 64 and the actuator 22.

Next, 406 determining whether the speed of the closure member 12 is greater than a predetermined maximum speed threshold. The method also includes the step of 408 continuing to control the actuator 22 in one of the automatic mode and the powered assist mode to move the closure member 12 in response to the speed of the closure member 12 not being greater than the predetermined maximum speed threshold. The next steps of the method are 410 exiting the one of the automatic mode and the powered assist mode and 412 entering the anti-slam mode in response to the speed of the closure member 12 being greater than the predetermined maximum speed threshold.

In general, the method also includes the step of generating a command to reduce the speed of the closure member 12 as the closure member 12 moves towards one of the open position and the closed position based on the at least one of the position and the speed of the closure member 12 using the controller 50. The method continues by controlling movement of the closure member 12 by the actuator 22 receiving the command to vary an actuator output force acting on the closure member 12 to move the closure member 12.

Referring to FIG. 39, the method further includes the step of 414 detecting a direction of movement of the closure member 12. So, if the closure member 12 is moving toward the open position, the method continues with the step of 416 determining whether the angle of the closure member 12 is less than a first predetermined closure member angle Φ in response to detecting that the closure member 12 is moving toward the open position. The next step of the method is 418 controlling the actuator 22 to reduce the speed of the closure member 12 to allow an open hard stop in response to determining that the angle of the closure member 12 is not less than the first predetermined closure member angle Φ. The method then includes the step of 420 controlling the actuator 22 to reduce the speed of the closure member 12 to zero at or before the open position in response to determining that the angle of the closure member 12 is less than the first predetermined closure member angle Φ. The method proceeds with the steps of 422 determining whether a manual control is detected and 424 determining whether the closure member 12 is in the open position in response to determining that the manual control is not detected. The next step of the method is 426 returning to detect a direction of movement of the closure member 12 in response to determining that the closure member 12 is not in the open position. The method proceeds with the steps of 428 exiting the anti-slam mode in response to determining that the closure member 12 is in the open position and 430 controlling the actuator 22 in the powered assist mode and exiting the anti-slam mode in response to determining that the manual control is detected.

If the closure member 12 is moving toward the closed position, the method includes the step of 432 determining whether the angle of the closure member is greater than a second predetermined closure member angle θ in response to detecting that the closure member 12 is moving toward the closed position. The method continues by 434 controlling the actuator 22 to reduce the speed of the closure member 12 to allow the closure member 12 to enter the latch primary position in response to determining that the angle of the closure member 12 is not greater than the second predetermined closure member angle θ. The method also includes the step of 436 controlling the actuator 22 to reduce the speed of the closure member 12 to allow the closure member 12 to enter the latch secondary position in response to determining that the angle of the closure member 12 is greater than the second predetermined closure member angle θ. The method additionally includes the steps of 438 determining whether the manual control is detected and 439 controlling the actuator 22 in the powered assist mode and 440 exiting the anti-slam mode in response to determining that the manual control is detected. The next step of the method is 442 determining whether the closure member 12 is at the secondary position in response to determining that the manual control is not detected. The method continues with the step of 444 controlling the cinch actuator 99 to move the closure member 12 to the latch primary position in response to determining that the closure member 12 is at the latch secondary position. Next, 446 generating an alert signal during the control of the cinch actuator 99 and 448 returning to detect the direction of movement of the closure member 12. The method proceeds by 450 returning to control the actuator 22 to reduce the speed of the closure member 12 to allow the closure member 12 to enter the latch secondary position in response to determining that the closure member 12 is not at the latch secondary position.

As previously discussed, the controller 50 implements a hysteresis by dynamically updating the comparison limits used for important switching points in the algorithm. Therefore, the method further includes the step of allowing continued movement of the closure member 12 in the automatic mode as long as the angular velocity of the closure member 12 is: (i) at a predetermined reference speed Vswing, or (ii) within an automatic mode upper gap UG between a predetermined reference speed Vswing and an automatic upper angular velocity UL, or (iii) within an automatic mode lower gap LG between the predetermined reference speed Vswing and an automatic lower angular velocity LL. The method continues by entering the powered assist mode in response to the angular velocity of the closure member 12 being less than the automatic lower angular velocity LL, or greater than the automatic upper angular velocity UL. The method also includes the step of transitioning to the anti-slam mode once the angular velocity of the closure member 12 is a high speed upper threshold HSB greater than the predetermined maximum speed threshold SL. The method additionally includes the step of transitioning back to the powered assist mode once the angular velocity of the closure member 12 slows to a high speed lower threshold HSA less than the predetermined maximum speed threshold SL.

Referring back to FIGS. 12 and 13, the controller 50 is configured to receive the at least one environmental condition to use in adjusting the force command 88 and/or the motion command 62. So, the controller 50 generates one of a force command 88 and a motion command 62 for supply to the power signal generator 118 using the at least one environmental condition. Motion velocity adjustment factor 122 may be correlated to the environmental condition. For example a sensed environmental condition below a temperature reading of 0 degrees Celsius may be correlated to an velocity adjustment factor 122 adjusted to result in an increase in the target motion velocity by ten percent, and for example a sensed environmental condition below a temperature reading of −10 degrees Celsius may be correlated to an velocity adjustment factor 122 adjusted to result in an increase in the target motion velocity by 15 percent. Again, the automatic mode initiation input 54 can be the closure member trigger signal from the closure member switch 58. It is recognized that controller 50 may be configured to generate a motion command 62 as a function of the environmental condition in other manners.

Specifically, FIG. 13 illustrates example changes to the duty cycle register corresponding to a change in the pulse width modulation duty cycle from 50% to 55%. Such a change may be prompted by the calculation of the motion command 62 by the motion command calculator of the controller 50 based on the at least one environmental condition. Again, the pulse width modulation duty cycle of the pulse width modulation control signal increases as shown.

Referring back to FIG. 19, as an example, the force command 88 based on the environmental condition may be increased when the environmental condition is sensed below a temperature reading of 0 degrees Celsius and is adjusted to move the closure member with more force in response to a manual input from the user 75 simulating a lighter physical closure member (e.g., door 12). For instance, the weight of the closure member is increased by a multiplier factor correlated to the environmental condition as an example. It is recognized that controller 50 may be configured to generate a force command 88 as a function of the environmental condition in other manners.

Referring back to FIG. 20, the controller 50 can alternatively calculate the force command 88 using post-compensation. For post-compensation, the controller 50 calculates the force command 88 as a function of an initial force command 132 calculated from the motion input 56, the closure member model 102, the at least one environmental condition, and the force sensitivity factor 130 in response to receiving the motion input 56 in the powered assist mode.

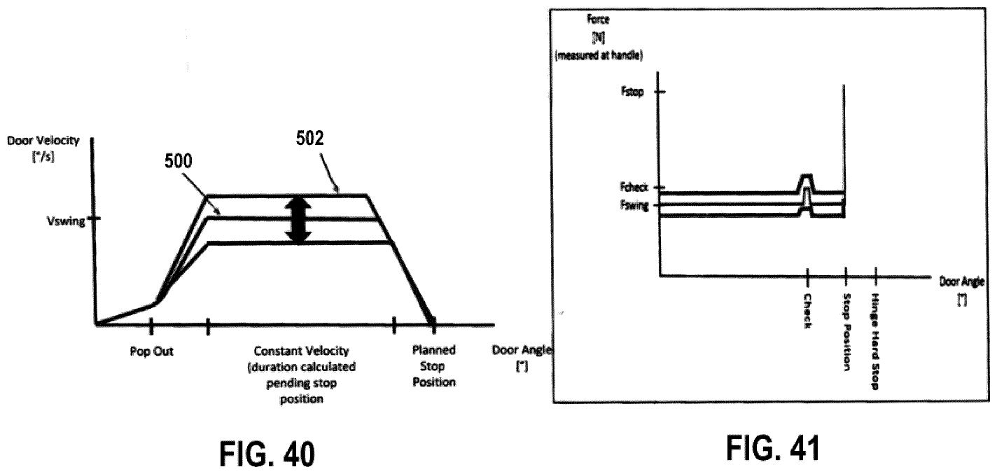

FIG. 40 shows adjustments to a motion profile related to the motion of the closure member for each of the plurality of closure member angles as a function of the sensed environmental condition and compased to a normal or default speed 500. A predetermined speed of the closure member Vswing can be increased or decreased as a function of temperature, for example, as indicated by numeral 502 (e.g., if the temperature detected is hotter or colder than predentermined thresholds).

FIG. 41 shows adjustments to a force profile related to the force experienced by the closure member are shown (e.g., measured at a handle of the closure member) for each of the plurality of closure member angles as a function of the sensed environmental condition. A predetermined assist force Fswing is provided by the actuator 22 throughout the range of motion of the closure member until a check position wherein the assist force increases to a higher predetermined assist force Fcheck and then back to Fswing until a stop position in which the assist force Fstop is applied to the closure member. This assist force can be increased or decreased as a function of environmental condition, such as temperature. For example, this assist force can be increased as a function of environmental condition, such as a windy environmental condition to assist in maintaining the closure panel in a door checked position during sensed windy conditions.

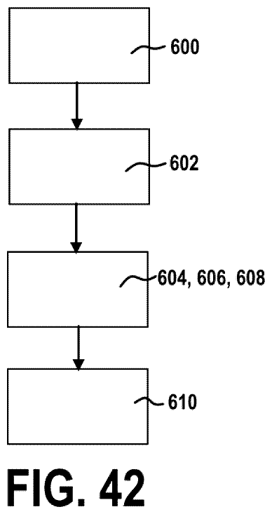

As best shown in FIG. 42, a method of controlling the movement of a closure member 12 based on at least one environmental condition of the vehicle 10 is also provided. The method includes the step of 600 receiving one of a motion input 56 and an automatic mode initiation input 54 to control movement of the closure member 12 in a powered assist mode in response to receiving the motion input and in an automatic mode in response to receiving the automatic mode initiation input. The method continues with the step of 602 detecting the at least one environmental condition of the vehicle 10 using an environmental sensor. The method proceeds by 604 generating one of a motion command 62 in the automatic mode and a force command 88 in the powered assist mode as a function of the at least one environmental condition. As discussed above, the environmental sensor 80, 81 can be a temperature sensor 80, thus the method can further include the step of 606 adjusting the one of the motion command 62 and the force command 88 based on an environmental temperature of the vehicle 10. Similarly, if the environmental sensor is a rain sensor 81, the method may further include the step of 608 adjusting the one of the motion command 62 and the force command 88 based on rain being detected. The next step of the method is 610 commanding movement of the closure member 12 by the actuator 22 receiving the one of the motion command 62 and the force command 88 to vary an actuator output force acting on the closure member 12 to move the closure member 12.

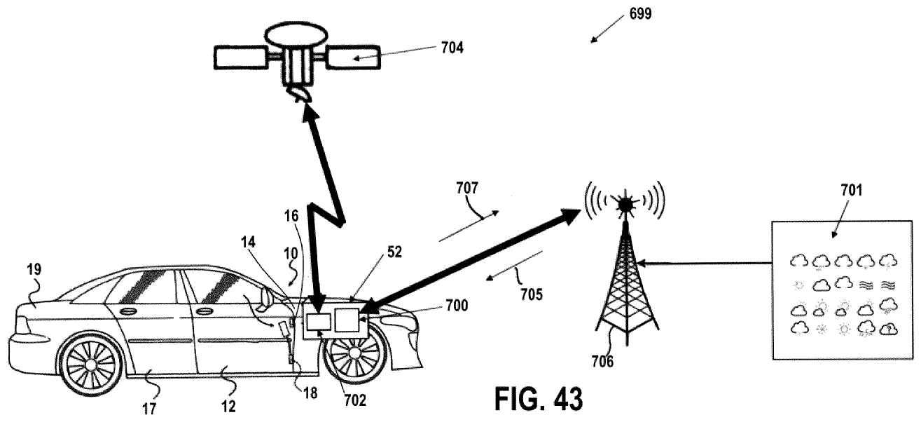

Now referring to FIG. 43, a communication system 699 is illustrated showing the environmental sensor 80, 81 replaced by, or complimented by a network connection with a remote server 701 providing local weather information or environmental conditions 705 via a cellular or wireless network 706. The BCM 52 may be provided with a communication interface 700 and a GPS module 702 configured to receive GPS data, for example from a GPS satellite 704. Communication interface 700 may be a wireless interface, for example a cellular network based wireless interface operating as a client for providing the current GPS information (e.g. position information 707) retrieved by the GPS module 702 over the wireless network 706 to the remote server 701, the remote server 701 configured to respond and transmit over the wireless network 706 to the communication interface 700 environmental data as a function of the provided current GPS positional information, such as temperature, wind speed, precipitation, humidity, pressure, and the like. Controller 50 will execute the hereinabove described door control techniques and methods using such network provided environmental data.

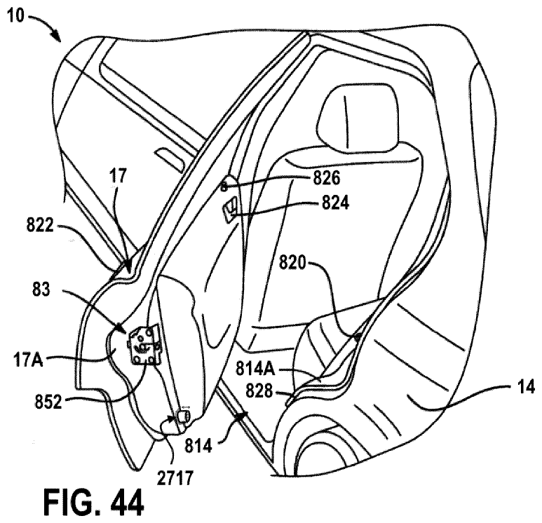

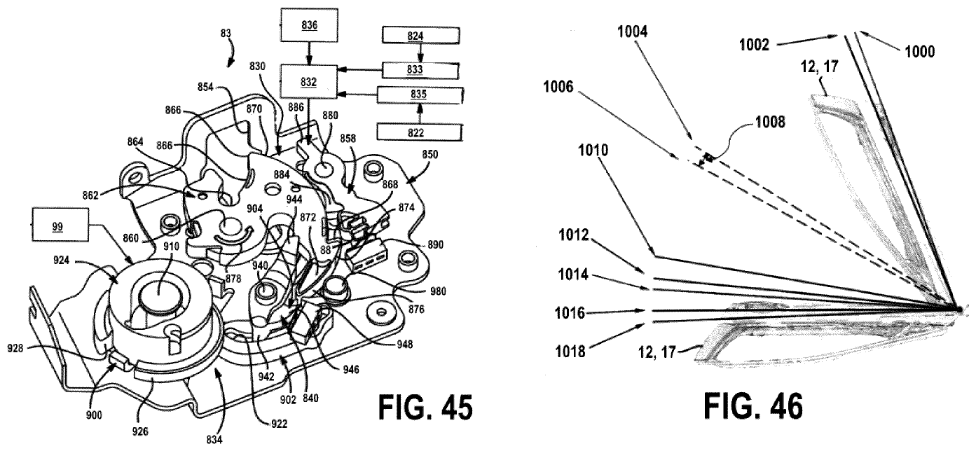

Referring now to FIG. 44, the motor vehicle 10 is shown to include a vehicle body 14 defining an opening 814 to an interior passenger compartment. The closure member, for example, rear passenger door 17, is illustratively shown pivotably mounted to vehicle body 14 for movement between an open position (shown) and a fully-closed position to respectively open and close opening 814 with latch assembly 83. Examples of latch assembly 83 can be found in U.S. Publication No. 2018/0100331, which is hereby incorporated by reference. While rear passenger door 17 is shown, it should be understood that the latch assembly 83 could alternatively or additionally be used for door 12 and/or power closure member actuation system 20 can be used for rear passenger door 17. The latch assembly 83 is shown secured to rear passenger door 17 adjacent to an edge portion 17A thereof and includes a latch mechanism 83 (FIG. 45) that is releasably engageable with a striker 820 fixedly secured to a recessed edge portion 814A of opening 814. As will be detailed, latch assembly 83 is operable to engage striker 820 and releaseably hold closure member 17 in its fully-closed position. An outside handle 822 and an inside handle 824 are provided for selectively actuating a latch release mechanism of latch assembly 83 to release striker 820 from the latch mechanism 830 and permit subsequent movement of closure member 17 to its open position. An optional lock knob 826 provides a visual indication of the locked state of closure latch assembly 83 and which may also be operable to mechanically change the locked state of latch assembly 83. A weather or door seal 828 is mounted on edge portion 814A of opening 814 in vehicle body 14 and is adapted to be resiliently compressed upon engagement with a mating sealing surface of closure member 17 when closure member 17 is held by the latch mechanism 830 of latch assembly 83 in its fully-closed position so as to provide a sealed interface therebetween which is configured to prevent entry of rain and dirt into the passenger compartment while minimizing audible wind noise, for example.

As best shown in FIG. 45, latch assembly 83 includes latch mechanism 830, a latch release mechanism 832, a latch cinch mechanism 134, a power release actuator 136, the cinch motor or power cinch actuator 99, a cinch disengage mechanism 840, and a power cinch disengage actuator. While shown separately and schematically, it will be appreciated by those skilled in the art of vehicular closure latches that the specific functions provided by one or more of the above-noted power actuators (836, 99) could be combined to provide coordinated actuation of any two or more of the noted mechanisms.

The various components of latch assembly 83 are oriented and/or positioned to establish an Unlatched mode when vehicle door 17 is located in its open position with closure latch assembly 83 displaced from striker 820 in FIG. 45. The various components of power closure latch assembly 83 may alternatively oriented and/or positioned to establish a Latched-Uncinched or “Secondary Latched” mode when vehicle or rear passenger door 17 is located in a first or “soft closed” (i.e., partially-closed) position with striker 820 retained by latch mechanism 830. Also, the various components of power closure latch assembly 83 may also oriented and/or positioned to establish a Latched-Cinched or “Primary Latched” mode when door 17 is located in a second or “hard closed” (i.e. fully-closed) position with striker 820 retained by latch mechanism 830. Movement of vehicle door 17 from its partially-closed position into its fully-closed position can be accomplished manually based on the closure force exerted by the vehicle operator thereon or, in the alternative, via a power-operated cinching operation configured to provide a “soft close” feature based on power cinch actuator 99 actuating latch cinch mechanism 834.

The latch assembly 83 is shown to include a frame plate 850 and a plate cover 852 (FIG. 44) supporting and enclosing the above-noted mechanisms and power actuators. Frame plate 850 is a rigid component configured to be fixedly secured to edge portion 17A of vehicle door 17 and which defines an entry aperture 854 through which striker 820 travels upon movement of vehicle door 17 relative to vehicle body 14. Latch mechanism 830 is shown, in this non-limiting example, as a single ratchet and pawl arrangement including a ratchet 856 and a pawl 858. Ratchet 856 is supported for rotational movement relative to frame plate 850 via a ratchet pivot pin 160. Ratchet 856 is configured to include a contoured guide channel 862 which terminates in a striker capture pocket 864, a ratchet engagement feature or closing notch 866, a cinching notch 868, and a first cam surface 870 extending between closing notch 866 and cinching notch 868. Ratchet 856 also is configured to include an arcuate extension 872 having a second cam surface 874 extending between a nose-shaped terminal end segment 876 and cinching notch 168. A ratchet biasing member, schematically shown by arrow 878, is adapted to normally bias ratchet 856 to rotate about ratchet pivot pin 860 in a first or “releasing” direction (i.e., counterclockwise in FIG. 45). Ratchet 856 is shown in FIG. 45 rotated to a striker release position with guide channel 862 generally aligned with entry aperture 854 in frame plate 850. As will be detailed, ratchet 856 is moveable through a range of motion between its striker release position, two distinct striker capture positions which include a secondary striker capture (i.e., the “soft closed”) position and a primary striker capture (i.e., the “hard closed”) position, and a ratchet overtravel position.

Pawl 858 is supported for rotational movement relative to a pawl pivot pin 880 extending from frame plate 850. Pawl 858 is configured to include a body segment having a latch shoulder 884 that is adapted to ride against first cam surface 870 of ratchet 856 in response to movement of ratchet 856 between its secondary and primary striker capture positions. Latch shoulder 884 on pawl 858 is also configured to engage closing notch 866 when ratchet 856 is located in its primary striker capture position. Pawl 858 also includes a release lug segment 886 and a switch lug segment 888. Power release actuator 836 acts on, or is coupled to, release lug segment 886 of pawl 858 via latch release mechanism 832 and is operable to cause latch release mechanism 832 to selectively move pawl 858 between a ratchet releasing position and a ratchet holding position. A pawl switch 890 (one of the plurality of primary and secondary ratchet position sensors or switches 85 shown in FIG. 5A) is mounted to frame plate 850 and is aligned with switch lug segment 888 of pawl 858 so as to provide a definitive pawl position signal when pawl 858 is located in its ratchet releasing position. A pawl biasing member (not shown) is provided for normally biasing pawl 858 in a first rotary direction (e.g., clockwise in FIG. 45) toward its ratchet holding position. Pawl 858 is shown in FIG. 45 located in its ratchet releasing position and can move to its ratchet holding position.

Latch release mechanism 832, while only shown schematically, is understood by skilled artisans to be operable in a first or “non-actuated” state to locate pawl 858 in its ratchet holding position and in a second or “actuated” state to locate pawl 858 in its ratchet releasing position. Typically, latch release mechanism 832 is configured to be actuated by one or more manually-actuated release mechanisms in addition to power release actuator 836. For example, FIG. 45 schematically illustrates an inside release mechanism 833 arranged to interconnect an inside handle 824 to latch release mechanism 832 so as to permit selective release of latch mechanism 830 via actuation of inside handle 824. Likewise, an outside release mechanism 835 is also schematically shown arranged to interconnect an outside handle 822 to latch release mechanism 832 so as to permit selective release of latch mechanism 830 via actuation of outside handle 822. Power release actuator 836, while only schematically shown, is understood to include any type of power-operated device (i.e., electric motor, etc.) capable of actuation to provide a power release function.

As noted, latch assembly 83 also includes latch cinch mechanism 834 controlled by power cinch actuator 99 as well as cinch disengage mechanism 840 controlled by a power cinch disengage actuator (not shown). Latch cinch mechanism 834 generally includes a cinch lever 200 and a cinch link 202 while cinch disengage mechanism 840 generally includes a disengage lever 204 and an actuation lever (not shown). Cinch link 202 is operatively coupled to disengage lever 204 such that selective actuation of at least one of power cinch actuator 99 and power cinch disengage actuator will cause coordinated movement of these two components. Again, while only shown schematically, power cinch actuator 99 and power cinch disengage actuator are contemplated to be power-operated actuators, such as electric motors, to provide selective control over actuation of latch cinch mechanism 834 and/or cinch disengage mechanism 140.

Cinch lever 900 is shown to be rotatably mounted to frame plate 850 via a cinch lever pivot pin 910. Cinch link 902 is an elongated component having a first end segment, a second end segment, and an intermediate segment therebetween. Intermediate segment of cinch link 902 includes an elongated, contoured guide slot 922. A cinch pulley 924 is rotatably mounted on cinch lever pivot pin 910 and includes a peripheral flange 926 defining a notch and an opening 928 within which cinch lever 900 is retained. As a result of this arrangement, rotation of cinch pulley 924 in a cinching (i.e., counterclockwise) direction via controlled actuation of power cinch actuator 99 will result in rotation of cinch lever 900 between its cinch start position and its cinch stop position. Cinch disengage mechanism 840 is operable for pivoting cinch link 902 (when located in its uncinched position) between its cinch link engaged position and its cinch link disengaged position.

Disengage lever 904 is rotatably mounted to frame plate 850 via a disengage lever pivot pin 940 and is configured to include a follower lug 942 that is retained in guide slot 922 of cinch link 902, an actuation lug 944, and a switch lug segment 946. A disengage lever switch 948 is mounted to frame 850 and is oriented to provide a definitive disengage lever position signal regarding the position of disengage lever 904. It is also noted that latch assembly 83 includes a retention pin 980 mounted to frame plate 850 in proximity to second end segment of cinch link 902. Retention pin 880 provides a hard stop to cinch link 902 in the event of a collision incident.

FIG. 46 shows various positions 1000, 1002, 1004, 1006, 1008, 1010, 1012, 1014, 1016, 1018 of the closure member (e.g., door 12 or 17) including a mechanical hard stop position 1000, a fully open position 1002, an example of an expected position 1004 of the closure member 12, 17, an example of an actual position 1006 of the closure member 12, 17, and a differential or delta 1008 between the expected position 1004 and the actual position 1006. The positions 1000, 1002, 1004, 1006, 1008, 1010, 1012, 1014, 1016, 1018 of the closure member 12, 17 shown in FIG. 45 also includes a pop out position 1010, a closure member or latch open position 1012, a latch secondary or secondary striker capture position 1014 (corresponding to a secondary closure member position), a closure member or latch fully closed position or primary striker capture position 1016 (corresponding to a primary closure member position) and a closure member or latch over travel position 1018. The positions 1000, 1002, 1004, 1006, 1008, 1010, 1012, 1014, 1016, 1018 shown are merely intended to be an example, other positions and configurations of the closure member 12, 17 are contemplated.

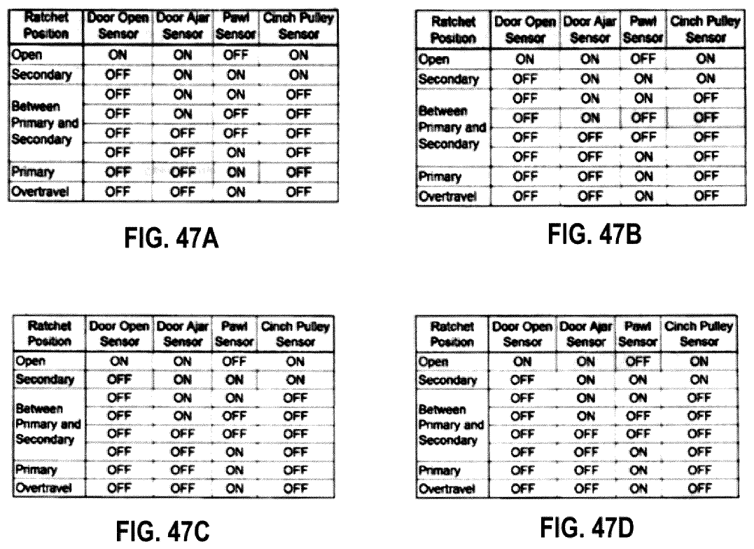

FIGS. 47A-47D illustrate latch status switch states of the latch assembly 83 (e.g., using sensors 190, 248). So, the position of the closure member 12, 17 can be determined using sensors 190, 248 of the latch assembly 83, for example. The at least one closure member feedback sensor 64 and/or a motor position sensor associated with actuator 22 can alternatively or additionally be used to determine the position and/or speed of the closure member, as discussed.

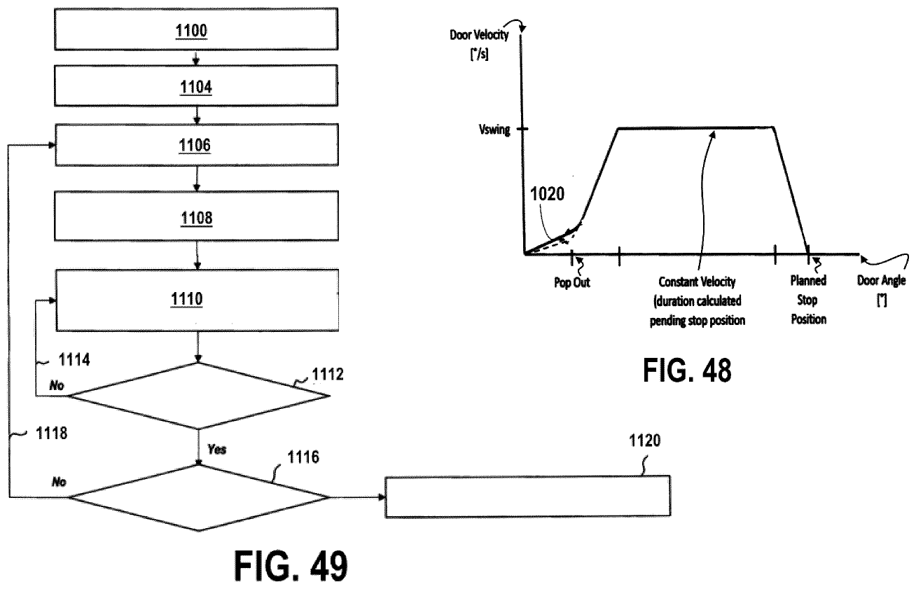

FIG. 48 illustrates an example closure member motion profile 68 showing how a speed of the closure member 12, 17 could be affected by an aging seal load. As discussed above, the controller 50 is configured to receive one of a motion input 56 and an automatic mode initiation input 54 to control movement of the closure member 12, 17 to the open position. The controller 50 is also configured to control movement of the closure member 12, 17 by commanding the actuator 22 using the one of the motion input 56 and the automatic mode initiation input 54. As shown, receipt of the motion input 56 and/or the automatic mode initiation input 54, can also cause the power closure member actuation system 20 to command the latch assembly 83 to unlock/unlatch (e.g., using the release actuator 836) allowing the closure member 12, 17 to being opening under a seal load to the pop out position. The closure member 12, 17 will seamlessly continue motion under power (e.g., by the actuator 22) in order to fulfill the open request at a pre-planned angle, for example. The seal load of seal 828 that has aged reduces a pop-out speed (i.e., a speed differential shown by the dashed line and indicated with numeral 1020) until the ratchet 156 will not rotate from its primary or secondary positions.

Therefore, the controller 50 is additionally configured to monitor at least one of the actual speed and the actual position of the closure member 12, 17 using the at least one closure member feedback sensor 64 (or using the latch status switches as shown in FIGS. 47A-47D). The controller 50 also calculates at least one of a position differential (e.g., shown in FIG. 46 as the delta 1008) between the expected position 1004 of the closure member 12, 17 and the actual position 1006 of the closure member 12, 17 and the speed differential (e.g., shown in FIG. 48) between an expected speed of the closure member 12, 17 and the actual speed of the closure member 12, 17. The controller 50 can then adjust the commanding the actuator 22 to compensate for the at least one of the position differential and the speed differential to move the closure member 12, 17 to at least one of the expected position and the expected speed. Thus, the controller 50 of the power closure member actuation system 20 can maintain consistent performance of the actuator 22 by adding varying levels of power (e.g., from the actuator 22) to augment losses from the door seal 828 or other component wear or lubrication changes over the lifetime of the vehicle. The controller 50 could take the date and mileage and cycle count 97 stored in memory device 92 (FIG. 5) into account as well when determining the amount of compensation that may be needed.

The controller 50 is also configured to determine whether the closure member 12, 17 has moved to the expected position. The controller 50 can then return to adjust the commanding the actuator 22 to compensate for the at least one of the position differential 1008 and the speed differential to move the closure member 12, 17 to at least one of the expected position and the expected speed in response to determining that the closure member 12, 17 has not moved to the expected position. The controller 50 is additionally configured to determine whether the closure member 12, 17 has moved to a final position in response to determining that the closure member 12, 17 has moved to the expected position. The controller 50 can then return to monitor at least one of the actual speed and the actual position of the closure member 12, 17 using the at least one closure member feedback sensor 64 in response to determining that the closure member 12, 17 has not moved to the open position. The controller 50 is also configured to command the actuator 22 to stop movement of the closure member 12, 17 in response to determining that the closure member 12, 17 has moved to the final position. Since the controller 50 can also be in communication with a latch 83, the controller 50 is further configured to issue a command to a latch 83 to release. For example, the controller 50 can be configured to command the power release actuator 836 (FIG. 45) to move the pawl 158 to the ratchet releasing position.

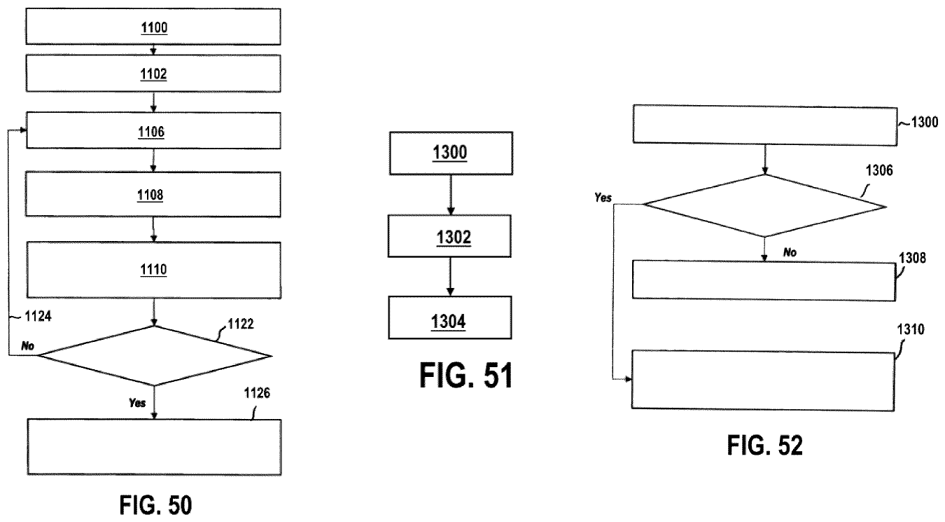

As best shown in FIGS. 49 and 50, a method of controlling the movement of the closure member 12, 17 of the vehicle 10 is also provided. The method includes the step of 1100 receiving one of a motion input 56 and an automatic mode initiation input 54 to control movement of the closure member 12, 17 to the open position. The method can also include the step of 1102 issuing a command to a latch 83 to release. The method can then include the step of 1104 controlling movement of the closure member 12, 17 by commanding the actuator 22 using the one of the motion input 56 and the automatic mode initiation input 54. The method continues by 1106 monitoring at least one of an actual speed and an actual position of the closure member 12, 17 using at least one closure member feedback sensor 64 configured to sense at least one of the actual speed and the actual position of the closure member 12, 17 (the actual position of the closure member can be monitored via latch signals, door position signals, or a door actuator position signal, for example). Next, the method includes the step of 1108 calculating at least one of a position differential between an expected position of the closure member 12, 17 and the actual position of the closure member 12, 17 and a speed differential between an expected speed of the closure member 12, 17 and the actual speed of the closure member 12, 17 (e.g., the load of the seal 828 cannot move the closure member such that the latch 83 moves out of the secondary position). The method proceeds with the step of 1110 adjusting the commanding the actuator 22 to compensate for the at least one of the position differential and the speed differential to move the closure member 12, 17 to at least one of the expected position and the expected speed (e.g., the closure member is moved to the expected position as would a load from the 828 move it to, for example, using proportional integral differential (PID) control). As discussed, such compensation could also, for example, could take the date and mileage and cycle count 97 stored in memory device 92 (FIG. 5A) into account.

Referring to FIG. 49 specifically, if the closure member 12, 17 does not move in an expected manner, for example, as a result of an increase in friction due to a lack of lubrication about the hinges or in the actuator gear train, a change in the operation of the motor (e.g., motor brushes wearing in, etc.), the power closure member actuation system 20 can compensate. So, the method can additionally include the step of 1112 determining whether the closure member 12, 17 has moved to the expected position. The next step of the method is 1114 returning to the step of adjusting the commanding the actuator 22 to compensate for the calculated differential to move the closure member 12, 17 to at least one of the expected position and the expected speed in response to determining that the closure member 12, 17 has not moved to the expected position. The method can continue with the step of 1116 determining whether the closure member 12, 17 has moved to a final position in response to determining that the closure member 12, 17 has moved to the expected position. Then, the method includes the step of 1118 returning to the step of monitoring at least one of the actual speed and the actual position of the closure member 12, 17 using the at least one closure member feedback sensor 64 configured to sense the at least one of the actual speed and the actual position of the closure member 12, 17 in response to determining that the closure member 12, 17 has not moved to the final position. The method also includes the step of 320 commanding the actuator 22 to stop movement of the closure member 12, 17 in response to determining that the closure member 12, 17 has moved to the final position.

As discussed above, the seal load can vary depending on the temperature and aging of the seal 828. So, the method can continue with the step of 1122 determining whether the closure member 12, 17 has moved to the open position (e.g., has the load of the seal 828 moved the closure member to a position where the latch 83 has moved past the secondary position). The method can continue with the step of 1124 returning to the step of monitoring one of a speed and a position of the closure member 12, 17 using the at least one closure member feedback sensor 64 configured to sense an actual position of the closure member 12, 17 in response to determining that the closure member 12, 17 has not moved to the open position. The method also includes the step of 1126 commanding the actuator 22 to move the closure member 12, 17 in one of an automatic mode and a powered assist mode in response to determining that the closure member 12, 17 has moved to the open position (i.e., normal door control can commence).

Referring back to FIG. 12, the controller 50 is also configured to receive the at least one environmental condition to use in adjusting the force command 88 and/or the motion command 62 and the force command 88 and/or the motion command 62 may also be modified by the artificial intelligence learning algorithm 61 based on the monitoring and analysis by the controller 50 of historical operation of the power closure member actuation system 20. So, the controller 50 generates one of a force command 88 and a motion command 62 for supply to the power signal generator 118 as modified by the artificial intelligence learning algorithm 61.

In accordance with an operational example, motion velocity adjustment factor 122 may be correlated to the environmental condition and/or modified by the artificial intelligence learning algorithm 61. For example a sensed environmental condition below a temperature reading of 0 degrees Celsius may be correlated to an velocity adjustment factor 122 adjusted to result in an increase in the target motion velocity by ten percent, and for example a sensed environmental condition below a temperature reading of −10 degrees Celsius may be correlated to an velocity adjustment factor 122 adjusted to result in an increase in the target motion velocity by 15 percent. Based on the monitoring and analysis of the historical operation of the power closure member system 20 by the controller 50, the velocity adjustment factor 122 may also be modified by the artificial intelligence learning algorithm 61. Specifically, the controller 50 can adjust the plurality of automatic closure member motion parameters 68, 93, 94, 95 based on the monitoring and analysis of the historical operation of the power closure member system 20 that are used in the determination of the motion command 62 using the artificial intelligence learning algorithm 61. Again, the controller 50 generates a pulse width modulation control signal based on the motion command 62 using a duty cycle register 126 and a comparator 128 of the pulse width modulation control signal generator 118 of the controller 50 in the automatic mode. It is recognized that controller 50 may be configured to generate a motion command 62 as a function of the environmental condition and/or as modified by the artificial intelligence learning algorithm 61 in other manners.

Referring back to FIG. 13, changes to the duty cycle register corresponding to a change in the pulse width modulation duty cycle may be prompted by the calculation of the motion command 62 by the motion command calculator of the controller 50 based on the at least one environmental condition and/or as modified by the artificial intelligence learning algorithm 61. Consequently, the pulse width modulation duty cycle of the pulse width modulation control signal increases as shown.

Referring back to FIG. 19, the controller 50 is also configured to receive the at least one of the position and speed of the closure member from the at least one closure member feedback sensor 64 in the powered assist mode. Therefore, the controller 50 is configured to determine the force command 88 based on the motion input 56 and the at least one of the position and speed of the closure member using the force command algorithm 98 and the closure member model 102 of the controller 50 in the powered assist mode. Based on the monitoring and analysis of the historical operation of the power closure member system 20, the controller 50 can adjust the plurality of powered closure member motion parameters 96, 100, 102, 106 that are used in the determination of the force command 88 using the artificial intelligence learning algorithm 61. Thus, the controller 50 is configured to generate a pulse width modulation control signal based on the force command 88 to vary the actuator output force acting on the closure member to assist movement of the closure member using the pulse width modulation control signal generator 118 of the controller 50 in the powered assist mode.

The controller 50 also calculates the force command 88 using pre-compensation and is further configured to calculate the force command 88 based on the motion input 56 and a function of a force sensitivity factor 130, the at least one environmental condition, and the closure member model 102 as modified by the artificial intelligence learning algorithm 61 in response to receiving the motion input 56 in the powered assist mode. For example, force command 88 based on a sensed environmental condition may be increased when a sensed environmental condition below a temperature reading of 0 degrees Celsius is adjusted to move the closure member with more force in response to a manual input from the user 75 simulating a lighter physical closure member (e.g., door 12). For instance, the weight of the closure member is increased by a multiplier factor correlated to the environmental condition as an example. It is recognized that controller 50 may be configured to generate a force command 88 as a function of the environmental condition and/or as modified by the artificial intelligence learning algorithm 61 in other manners.

Referring back to FIG. 20, as discussed, the controller 50 can alternatively calculate the force command 88 using post-compensation. For post-compensation, the controller 50 calculates the force command 88 as a function of an initial force command 132 calculated from the motion input 56, the closure member model 102, the at least one environmental condition, and the force sensitivity factor 130 as modified by the artificial intelligence learning algorithm 61 in response to receiving the motion input 56 in the powered assist mode. The closure member model 102 utilizes the plurality of model parameters 106 including, for example, a closure member weight attribute and a closure member friction attribute and a closure member inertia attribute and a closure member length attribute. For instance, the controller 50 will determine a required change in sensitivity as a function of the sensed environmental condition, the system 20 will apply the force sensitivity factor 130 to the result of force command calculations 132 which will result in a change in the input value to the duty cycle calculation by the pulse width modulation control signal generator. The modification to the sensitivity is done by adjusting the force command 88 (post-processing).

Referring back to FIG. 40, adjustments to a motion profile related to the motion of the closure member for each of the plurality of closure member angles are shown. Such adjustments can be a function of the sensed environmental condition and/or due to adjustments to the automatic closure member motion parameters 68, 93, 94, 95 by the artificial intelligence learning algorithm 61. A predetermined speed of the closure member Vswing can be increased or decreased as a function of temperature, for example. Similarly, referring back to FIG. 41, adjustments to a force profile related to the force experienced by the closure member (e.g., measured at a handle of the closure member) for each of the plurality of closure member angles is also shown. Such adjustments can be a function of the sensed environmental condition and/or due to adjustments to the powered closure member motion parameters 96, 100, 102, 106 by the artificial intelligence learning algorithm 61. A predetermined assist force Fswing is provided by the actuator 22 throughout the range of motion of the closure member until a check position wherein the assist force increases to a higher predetermined assist force Fcheck and then back to Fswing until a stop position in which the assist force Fstop is applied to the closure member. This assist force can be increased or decreased as a function of environmental condition, such as temperature and may also be modified by the artificial intelligence learning algorithm 61. For example, this assist force can be increased as a function of environmental condition, such as a windy environmental condition to assist in maintaining the closure panel in a door checked position during sensed windy conditions.

Referring back to FIG. 43, the power closure member actuation system 20 can further include the wireless network interface 700 in communication with the controller 50 and configured to receive at least one environmental condition 705 of the vehicle 10 at a position of the vehicle 10 from the remote server 701. Thus, the historical operation monitored and analyzed using the artificial intelligence learning algorithm 61 includes the at least one environmental condition 705 of the vehicle 10. As a result, the controller 50 is further configured to adjust the plurality of automatic closure member motion parameters 68, 93, 94, 95 and the plurality of powered closure member motion parameters 96, 100, 102, 106 based on the at least one environmental condition of the vehicle 10. Similarly, the power closure member actuation system 20 can include the global positioning system module 702 configured to receive global positioning system data and at least one environmental condition 705 of the vehicle 10 from the global position system satellite 704. Therefore, the historical operation monitored and analyzed using the artificial intelligence learning algorithm 61 includes the global positioning system data and the controller 50 is further configured to adjust the plurality of automatic closure member motion parameters 68, 93, 94, 95 and the plurality of powered closure member motion parameters 96, 100, 102, 106 based on the global positioning system data.

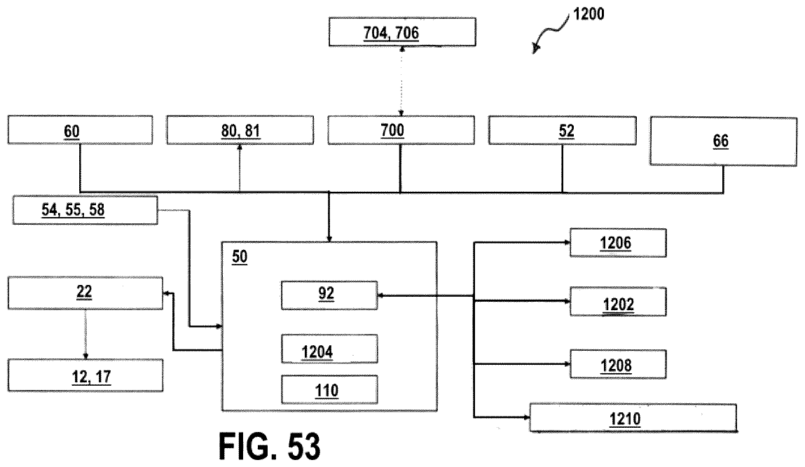

FIG. 53 shows an exemplary system 1200 for executing the artificial intelligence learning algorithm 61 using a neural network 1202 and/or for training the neural network. In more detail, as discussed above the controller 50 can include the memory device 92 and the processor or other computing unit 110. The controller 50 also includes data storage 1204. Code 1206 (e.g., software instructions for the artificial intelligence learning algorithm 61), the neural network 1202 (e.g., trained), training code 1208, and a historical dataset 1210 (e.g., previous inputs and associated vehicle states) are stored in the memory device 92.

An example neural network 1202 is shown in FIG. 54 and includes a first input node 1212 (e.g., input to operate), a second input node 1214 (e.g., environmental state or environmental conditions), a third input node 1216 (e.g., vehicle location), and a fourth input node 1218 (e.g., time of day). The neural network 1202 also includes a first hidden layer 1220, a second hidden layer 1222, a third hidden layer 1224, a fourth hidden layer 1226, a fifth hidden layer 1228, and a sixth hidden layer 1230 interconnected with the input nodes 1212, 1214, 1216, 1218 and with one another. The neural network 1202 additionally includes a first output node 1232 (e.g., closure member opening/closing speed), a second output node 1234 (e.g., door stop position), a third output node 1236 (e.g., window open command), and a fourth output node 1238 (e.g., automatic closure member closing after timeout period) interconnected with the hidden layers 1220, 1222, 1224, 1226, 1228, 1230. Nevertheless, other configurations of layers and nodes are contemplated.

As best shown in FIGS. 51-52, a method of controlling the movement of a closure member 12 of the vehicle 10 using a powered closure member actuation system 20 is also provided. Referring initially to FIG. 51, the method includes the step of 1300 receiving one of a motion input 56 associated with a powered assist mode and an automatic mode initiation input 54 associated with an automatic mode. Next, the method includes the step of 1302 sending the actuator 22 one of a motion command 62 based on a plurality of automatic closure member motion parameters 68, 93, 94, 95 in the automatic mode and a force command 88 based on a plurality of powered closure member motion parameters 96, 100, 102, 106 in the powered assist mode to vary an actuator output force acting on the closure member 12 to move the closure member 12. The method proceeds with the step of 1304 monitoring and analyzing historical operation of the power closure member actuation system 20 using an artificial intelligence learning algorithm 61 and adjusting the plurality of automatic closure member motion parameters 68, 93, 94, 95 and the plurality of powered closure member motion parameters 96, 100, 102, 106 accordingly.

As discussed above, the plurality of automatic closure member motion parameters 68, 93, 94, 95 includes at least one of a plurality of closure member velocity and acceleration profiles 68 and a plurality of closure member stop positions 93 and a closure member check sensitivity 94 and a plurality of closure member check profiles 95. The plurality of powered closure member motion parameters 96, 100, 102, 106 includes at least one of a plurality of fixed closure member model parameters 96 and a force command generator algorithm 100 and a door model 102 and a plurality of closure member component profiles 106.

As best shown in FIG. 52, if the environmental sensor 80, 81 is a rain sensor 81, the method can further include the step of 1306 determining whether rain is detected using the rain sensor 81 (e.g., user historical data shows a manual override of the power open cycle to open the closure member 12 faster when it is raining). The method also includes the step of 1308 utilizing a first speed algorithm for moving the closure member 12 in response to determining that rain is not detected using the rain sensor 81. The method can proceed with the step of 1310 utilizing a second speed algorithm (e.g., the second speed algorithm can implement a higher speed of the closure member 12 than the first speed algorithm) for moving the closure member 12 in response to determining that rain is detected using the rain sensor 81. So, the second speed algorithm can be based on the user historical data to optimize performance.

In addition, since the powered closure member actuation system 20 can further include the global positioning system module 702 (FIG. 43) configured to receive global positioning system data and from the global position system satellite 704, the method can also include the step of receiving at least one environmental condition of the vehicle 10 at a position of the vehicle 10 from a remote server 701 using a wireless network interface 700 communicating over wireless links (707, 705). The method can also include the step of adjusting the plurality of automatic closure member motion parameters 68, 93, 94, 95 and the plurality of powered closure member motion parameters 96, 100, 102, 106 based on the at least one environmental condition of the vehicle 10.

Thus, the described artificial intelligence learning enhancement to the door motion control algorithm allows the controller 50 (e.g., in software) the ability to modify the motion and force algorithm outputs 62, 88. For example a neural network shown in FIG. 54 implemented in software may be employed as an example. The modifications can be based on historical user data to identify usage trends (door swing speed, door open angle, door open angle based on vehicle location (GPS input—home, office, parking lot), environmental condition (rain, cold, hot), etc). The controller 50 then predicts user expectation for door function based on this historical data. The ultimate intent is for the controller 50 to open the power open door 12 the same as the user 75 would do manually for any given situation. The powered closure member actuation system 20 disclosed herein consequently provides a highly optimized power door solution that is unique to each driver. So instead of certain door performance values or parameters being hardcoded into the algorithm, the powered closure member actuation system 20 disclosed herein provides that the actual algorithm is modified. The powered closure member actuation system 20 disclosed herein advantageously improves the user interface with the vehicle 10 by adjusting the performance settings to suit individual use cases rather than a single setting for all cases. Further, the controller 50 can learn and incorporate user patterns to anticipate and optimize the interaction (e.g., if a user always opens the door 12 on hot days to cool the vehicle 10, the system 20 may choose to lower a window and/or open a door 12 before operator physically reaches the vehicle 10, thus saving time). If, for example, an operator continually overrides the power close at 5 pm (i.e., in a rush), the system 20 may choose to implement a higher speed power close at 5 pm as compared to other times.

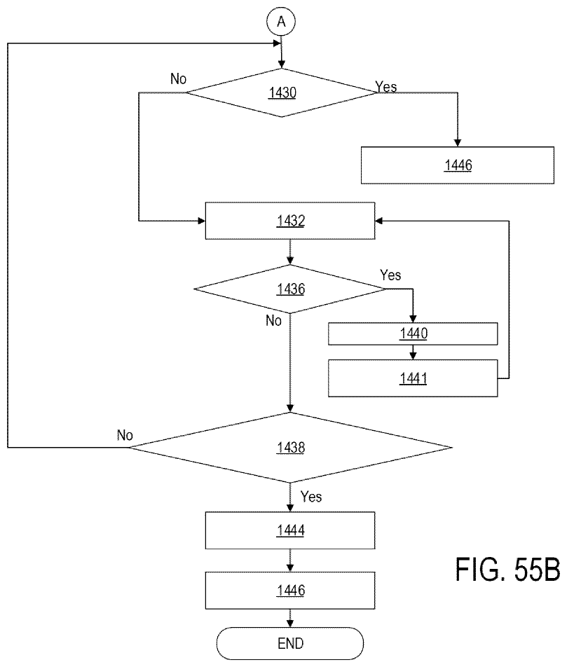

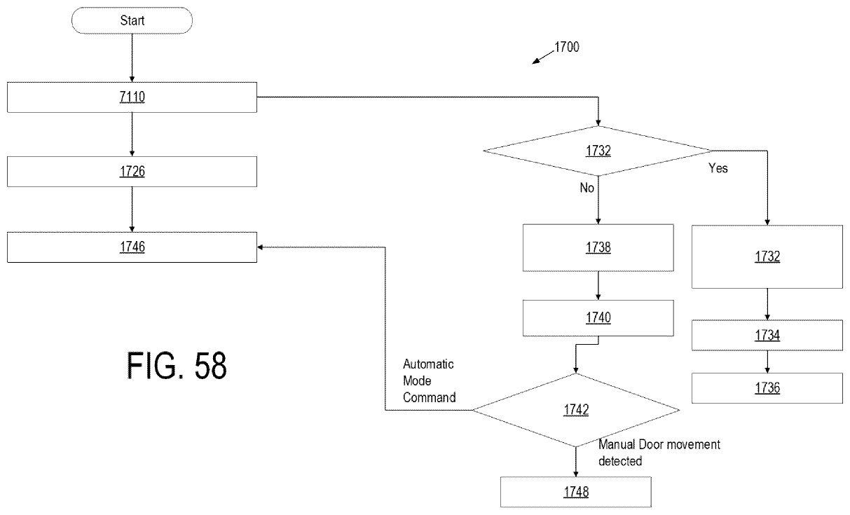

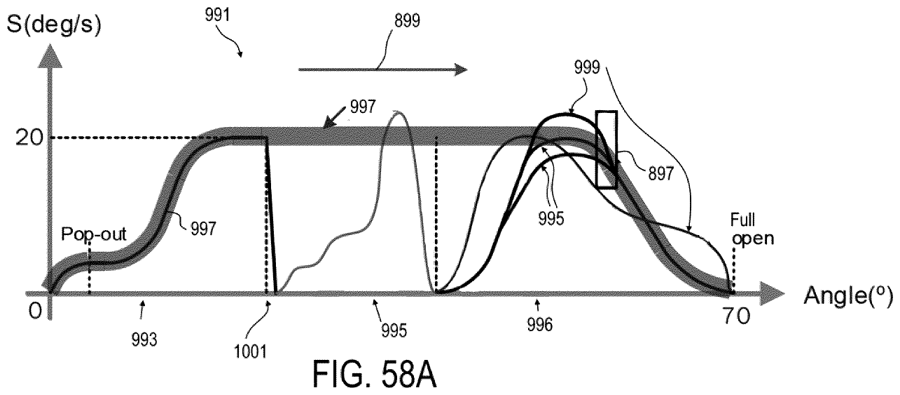

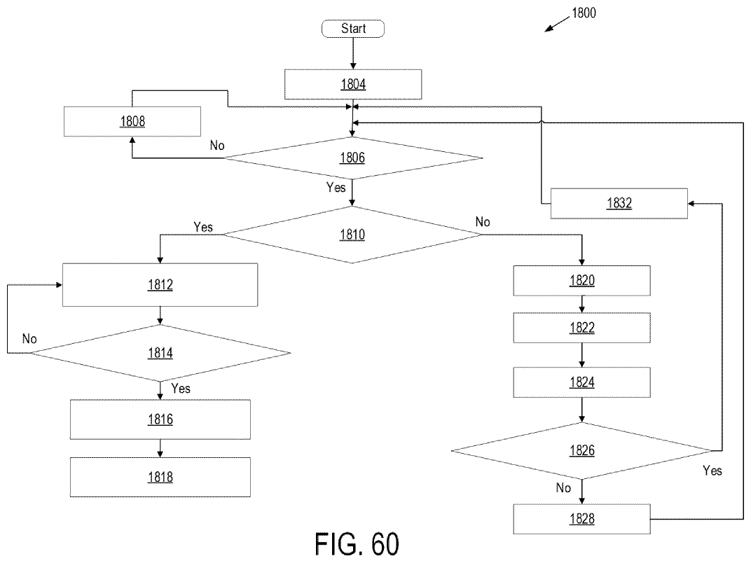

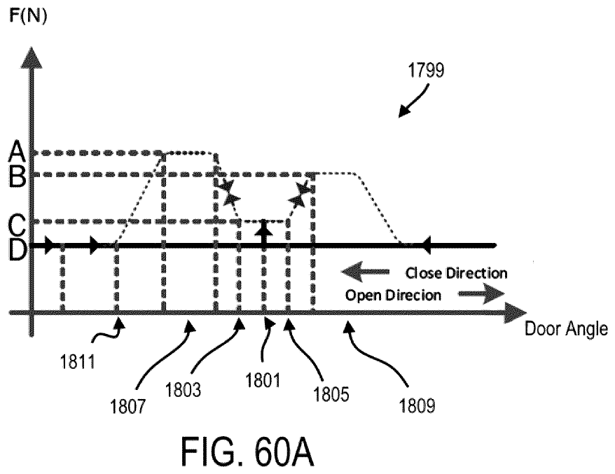

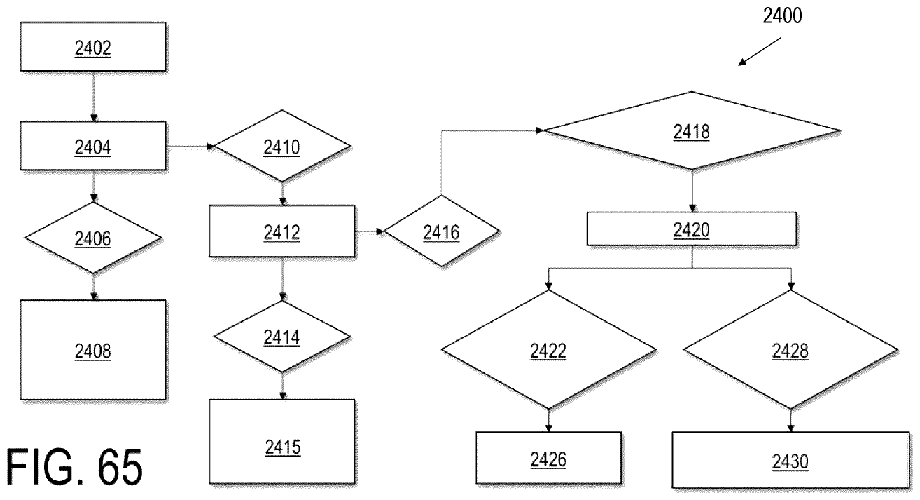

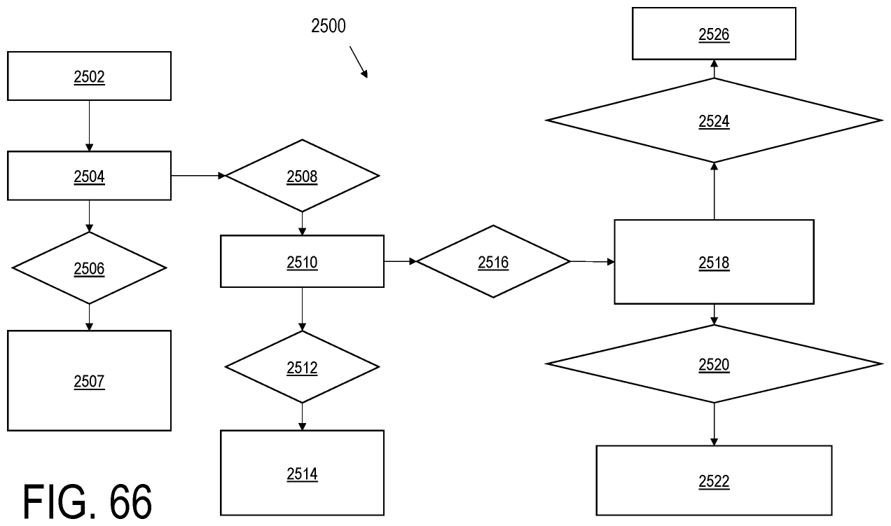

Now referring additionally to FIG. 55A to FIG. 66, there are provided some illustrative flow diagrams of the powered closure member actuation system 20 in operation. For example, referring to FIG. 55A and FIG. 55B, there is illustrated a method 1400 of moving a door from a fully latched position when operating in the automatic mode. The method begins by the controller 50 receiving an automatic open command at step 1402 for example from an inside door handle switch or wireless device such as a FOB, cellular phone, and the like. The method next continues to step 1406 of controlling the latch 83 to release the door from its primary latched position. For example, an electronic signal may be transmitted from the controller 50 to the latch 83 for commanding the latch 83 to control the power release motor of the latch 83. The method next continues to step 1408 of not controlling the actuator 22 after the latch 83 has been released e.g. controlling a power reset function of the latch 83 to return the pawl into a condition where it may block the ratchet or controlling the latch 83 to maintain its power released state. The method allows for the expansive seal force imparted against the door by the weather seal about a perimeter of the vehicle body 14 the closure member is configured to close off due to its compressed state between the vehicle body 14 and the door 12 when the door is fully closed to urge the door 12 out of its primary latched position and towards the pop-out position of the door 12 (for example at a 3 degree door open angle), without assistance from the actuator 22. In other words, the actuator 22 is not powered until after the door 12 has been moved away from its primary closed position to its pop-out position under the force of the seal load. Therefore, there is provided a powered closure member actuation system 20 having a controller 50 in communication with a power release mechanism of a latch 83 and an actuator 22 for moving the door 12, where the controller 50 is configured to control the power release mechanism to release the latch 83 to allow the door to move under the influence of a door seal to a pop-out position without controlling the actuator 22, or in other words the actuator 22 is not powered during the pop-out under seal load of the door 12, and the controller is further configured to control the actuator 22 to move the door 12 after the door 12 has reached the pop-out position. The method next continues to step 1410 with the step of detecting if the door has moved to the pop-out position, for example position 1012 of FIG. 46. If the controller 50 has detected that the door 12 has moved to the pop-out position, at step 1412 the method proceeds with the step of controlling the activation of the non-contact obstacle detection system e.g. the at least one non-contact obstacle detection sensor 66. In one possible configuration the non-contact obstacle detection system is only activated during the automatic door mode, and will be disabled, or enabled but signals to the controller 50 from the non-contact obstacle detection system will be ignored by the controller 50, in the power assist mode so as to not trigger interruptions in door motion due to the user being in proximity to the door 12 during power assist mode which would be detected by the non-contact obstacle detection system. If the controller 50 has not detected that the door 12 has moved to the pop-out position, at step 1414 the method proceeds with determining if a stop command has been received by the controller 50 before the pop-out position of the door 12 has been reached. If the controller 50 has not received a stop command, similar to an automatic mode initiation input 54 however for intending to stop the door 12, before the door 12 has moved to the pop-out position, at step 1416 the method proceeds to determining if the door 12 has moved away from the primary latched position (see FIG. 46), for example by receiving hall sensor signals from the latch 83 indicating the various positions of the latch 83 components. If the controller 50 has determined the door 12 has moved away from the primary latched position, the method returns to the step 1410 of detecting if the door 12 has moved to the pop-out position. If the controller 50 has determined the door 12 has not moved away from the primary latched position, the method proceeds to execute a blocked or frozen door routine (as illustratively shown in FIGS. 65 and 66) at step 1420 having determined that the door 12 is in a blocked state for example if an object is leaned up against the door 12 or a frozen state for example if ice buildup is present between the door 12 and the vehicle body 14. The method after having executed the blocked or frozen door routine (for example of FIGS. 65 and 66), the method will return to step 1416 to determine if as a result of executing the locked or frozen door routine, the door 12 has successfully moved from the primary latched position. If the controller 50 has received a stop command before the door 12 has moved to the pop-out position at step 1416 the method proceeds to step 1424 of resetting the latch 83 and that is to allow the pawl to return into a locking engagement with the ratchet when the ratchet is returned to a primary striker holding position. Next following step 1424 the method continues with the step of not controlling the cinch actuator 99 at step 1426. Next, following step 1426 the method continues with the step of transitioning the operating state of the powered closure member actuation system 20 from the automatic mode to the manual or power assist mode. Following step 1412, the controller 50 may determine if an obstacle has been detected next to the vehicle 10 using the non-contact detection system, and for example within a swing path of the door in a step 1430. If at step 1430 the controller 50 determines that no obstacle is detected next to the vehicle 10, or the door 12, the controller 50 may command in a step 1432 the power door actuator 22 to move the door 12 away from the pop-out door position and towards the open position, or control the latch 83 to allow the door to move to the pop-out position and transition the mode of operation to a power assist mode. Controller 50 may control the actuator 22 to move the door in step 1432 to a planned door position which may be a predetermined position such as at a 75 degree door angle. The method continues to step 1436 whereby the controller 50 continues to determine during door motion if an obstacle has been detected next to the vehicle 10 using the non-contact detection system, and for example within a swing path of the door 12. For example, while an obstacle may not have been detected in step 1430 or an obstacle within the swing path of the door 12 may not have been detected in step 1430, an obstacle may have subsequently moved into the swing path of door 12 during the door opening. If no obstacle is detected in step 1436, the method continues with the step of the controller 50 monitoring the door position and detecting if the door position has move to its planned door position at step 1438. If an obstacle is detected in step 1436, the method continues with the step 1440 of executing an unplanned stop routine to stop the door movement. Next at step 1441, once the controller 50 has received an automatic mode resume command, for example as a result of a user depressing an inside handle switch for a second time, the method may return to step 1432, and resume the door motion profile when the system 20 is operating in the automatic mode, such as a position versus speed motion profile as discussed herein in some examples, from the point where the door motion stopped. Transition continuity is provided, or in other words, characteristics of continuity of operation from exact the same “operating point” without any discrete change in the state and controlling variables to ensure that the door does not experience any sudden jerks providing a smooth unnoticeable transition between modes. Upon recurring the original open command, the door 12 shall continue to be moved tracking to the opening profile and end the operation with the underlying open profile. The controller 50 may control the door motion after resumption by converging, illustrated at box 897 in FIG. 58A the door motion profile to the profile before the resume is initiated within the final 20% of the final door angle. The controller 50 may start the door motion after a door resume command is received with the same profile, for example the same slope as the original opening door motion profile before resumption. The door motion after the resume command may be controlled so as to not overshoot the door profile movement speed to reduce the occurrence of door oscillation for providing a smooth door motion. For example, at the point of interruption the system variables and data may be stored into memory before the interrupt and recalled after the resume command is received to provide for a continuity of operation from the same operating point before the interruption and after the resume from interruption. When switching between automatic and power assist mode e.g from automatic mode to power assist mode upon an interruption of the automatic mode, or from the power assist mode to the automatic mode after a resume command, the power closure member actuation system 20 may have continuity of operation from the same operating points, and in other words without any discrete change in the state and controlling variables. Therefore, there is provided a powered closure member actuation system 20 having a controller 50 in communication with an actuator 22 configured to control the actuator 22 to move the door 12 according to a door motion profile, where the controller 50 is configured to control the actuator 20 following an interruption in the control of the actuator 22 according to the door motion profile before the interruption without exceeding the maximum operating limits of the door motion profile after resuming from the interruption. For example, such exceeding of operating limits is shown as line 999 in FIG. 58A above the automatic mode door motion profile 997 before interruption at position 1001. Motion after resumption indicated by line 995 contained below the operating limits of line 997 are targeted. FIG. 58A illustrates door motion chart 991 of speed versus door angle illustrating the door motion during automatic mode operation in the opening direction 899 before interruption 993, the door motion during power assist operation following an interruption in automatic mode operation 995, followed by a resumption of the automatic mode operation having a motion profile not exceeding the door motion before interruption 996, in accordance with an illustrative embodiment. If at step 1438, the controller 50 has not detected or determined that the door 12 has moved to its final door opened position, the method returns to step 1430 of monitoring using the non-contact obstacle sensors to determine if an obstacle has been detected next to the vehicle 10. If at step 1438 the controller 50 has detected or determined that the door has moved to its planned door open position, the controller 50 may at step 1444 control the actuator 22 to stop the door 12. The controller 50 may beforehand anticipate that door 12 reaching the planned position at a position before the planned position and reduce the velocity of the door 12 to match or nearly match with a cinch velocity for providing a seamless transition between power operating mode and cinch mode in accordance with the exemplary teachings herein above. Therefore, there is provided a powered closure member actuation system 20 having a controller 50 in communication with an actuator 22 and an ancillary actuator for controlling motion of the door (e.g. an actuator of door presenter or ice breaker 2717, a cinch actuator 99) where the controller 50 is configured to transition control between the actuator 20 and the ancillary actuator such that the velocities of the door 12 when controlled by the actuator 20 or the ancillary actuator match, or substantially match, during the transition of control. Following step 1444 the method continues with the step of the controller 50 activating the door checking operation of the actuator 22 (see FIG. 60) to check the door 12 at the planned position at step 1446 when the door 12 is stationary in manners as described herein above for example. If the door is biased (e.g. for example as a result of the geometries of the hinges) to swing slightly towards one of the open position or the closed position under the force of gravity depending on the position of the door when stopped, the actuator 22 may be required to be supplied a degree of power sufficient to resist motion of the door motion due to this bias. Over time, such supply of power for powering the actuator 22 operating in such a door checking mode may deplete any source of such power, such as a backup battery supply or the like. As a result the controller 50 may be configured to after a time out period of time, such as 15 minutes for example, control the actuator 22 to move the door to one of the fully opened position or to the fully closed position. If the door is moved to the fully closed position, the door checking function for preventing movement of the door would now be assumed by the door latch 83 and the actuator 22 can be depowered or deactivated and energy for the source of power preserved. If a separate door check device is provided and that is not as a door check function resulting from control of the actuator 22 but from a friction based braking or detent mechanism for example, the controller 50 may activate the door check device in the alternative to controlling the actuator 22 to check the door 12 at the planned position. If at step 1430 the controller 50 determines that an obstacle is detected next to the vehicle 10 during the door motion, the controller 50 may command the door to stop in a step 1432. After step 1446 the method may end and the door may remain at the planned stopped position until the controller 50 receives a next automatic door mode command, or the user controls the door 12 in the power assist mode.

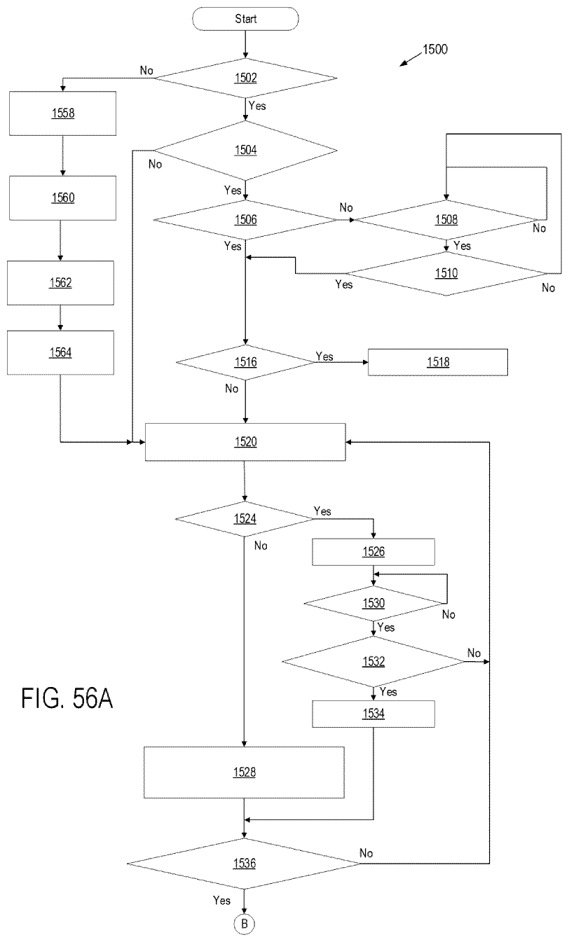

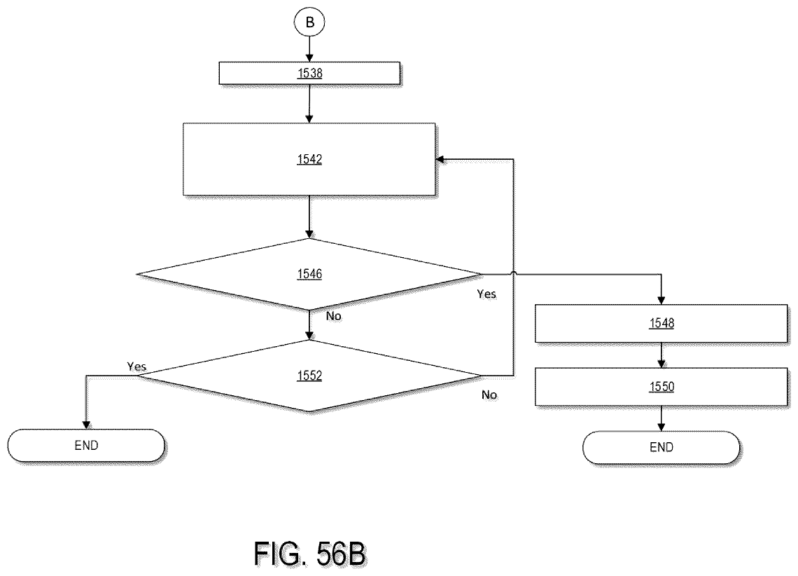

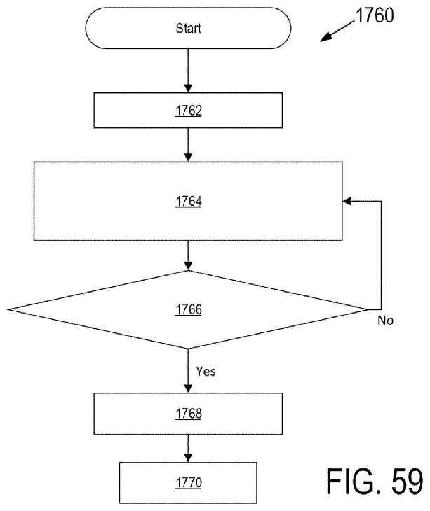

Now referring to FIGS. 56A and 56B, there is shown a method 1500 illustrating the operation of the power closure member actuation system 20 for closing the door from an open position. The method 1500 begins by the controller 50 monitoring for a user or human originating indication of their intent to close the door 12, for example by the controller 50 monitoring for an automatic close command at step 1502 such as from an inside door handle switch, or key FOB button, or remote device input, in a manner as described herein above as examples only. The door 12 may be at any opened position when the controller 50 receives the automatic close command. If at step 1502 the controller 50 determines that a human has intended for the door 12 to move to the closed and fully latched position, at step 1504 the controller 50 may determine using the non-contact obstacle detection system if a user is next to or in proximity to the door 12. Controller 50 may be able to distinguish better a human object and a non-human object based on signals detected by the non-contact obstacle detection system, for example if the non-contact obstacle detection system includes radar sensors, a human may be differentiated from a non-human object based on tracking velocities of the object, reflectivity characteristics of the object, size of the object as determined by the differences between the transmitted radar waves being received by the radar sensor after having been reflected by the object as a human which may alter the transmitted waves in detectable ways. If at step 1504 the controller 50 determines a user is in proximity to the door 12, such as within a threshold distance to the door e.g. 1 meter, next at step 1506 the method may proceed with the step of the controller 50 determining if the door 12 is stationary. This step 1506 may be optionally performed to ensure the user is not manually moving the door to avoid a conflict situation between the manual movements of the door by the user being overridden by the automatic control of the door. If at step 1506 the controller 50 does not determine that the door 12 is stationary the controller 50 may proceed to step 1508 whereat the controller 50 may monitor for detection of the door 12 having stopped moving and if not having stopped moving the controller 50 may continue to monitor for the door 12 being stationary. If at step 1508 the controller 50 determines that the door is stationary, the method may proceed to the next step of detecting if the door has not moved from stationary for a predetermined period of time at step 1510. If at step 1510, the controller 50 determines that the door 12 has not remained stationary for a predetermined period of time, the method may return to step of 1508 to determine if the door 12 has stopped moving. If at step 1510, the controller 50 determines that the door has remained stationary for a predetermined period of time, or continuing from step 1506, next, the method proceeds to the controller 50 determining using the non-contact obstacle detection system if an obstacle has been detected within the closing path of the door at step 1516. If at step 1516 the controller 50 determines using the non-contact obstacle detection system that an obstacle has been detected within the closing path of the door 12, the controller 50 may proceed to step 1518 to execute a planned stop position routine to stop the door 12 in manners as illustratively described herein (e.g. before contacting the obstacle, allowing some contact with the obstacle). If at step 1516 the controller 50 determines using the non-contact obstacle detection system that an obstacle has not been detected within the closing path of the door 12, the controller 50 may proceed to step 1520 to control the actuator 22 to move door towards secondary latched position. If at step 1504 the controller 50 determines a user is not in proximity to the door, the method may proceed to bypass steps 1506 and 1516 and proceed to step 1520. Optionally providing such a bypass mode thereby allows reducing any door closing delays due to a non-stationary door condition. Also, the bypass mode may employ a door motion profile that moves the door as rapidly as possible without the profile have smooth transitions between acceleration portions and constant velocity portions of the door as is employed during the automatic mode which may be provided for the user visualizing a smooth door closing. With no user in proximity to the door 12 as detected by the non-contact obstacle detection system for viewing such a smooth door motion, the door motion may be controlled for optimizing the rapidity of motion in less time as compared to that in automatic mode. In a possible configuration, a contact-based only obstacle detection sensing may be employed during this bypass. In another possible configuration, both contact-based obstacle detection and non-contact based detection may be employed with the actuator 22 controlling the door motion having an overall reduced speed when a user is not detected in proximity to the vehicle to increase safety during a potentially unsupervised closing of the door 12 if such a configuration is desired to satisfy any regulatory safety requirements. Next following step 1520, the method proceeds to step 1524 of determining if an obstacle is detected in the closing path of the door 12 during door closing towards secondary latched position before the door has moved to secondary latched position if a user has been detected in proximity to the door 12. If at step 1524 the controller 50 has determined an obstacle is detected in the closing path of the door 12, the method may proceed with the controller 50 executing an unplanned stop routine at step 1526. If at step 1524 the controller 50 has determined an obstacle is not detected in the closing path of the door 12, the method may proceed with the controller 50 controlling the actuator 22 to reduce door velocity prior to reaching the secondary latched position at step 1528 and may include for example controlling the actuator 22 to reduce door velocity prior to reaching the secondary latched position such that the door velocity may match or may be slightly greater than the predetermined cinch velocity determined by the cinch actuator 99 providing a smooth transition between door closing modes (e.g. between the automatic mode and the cinching mode as each controlled by different actuators). Next, after step 1526, the method proceeds to the step of the controller 50 determining if a resume command has been received at step 1530. If the controller 50 at step 1530 determines a resume command has been received at step 1532 the method next proceeds at step 1534 with the controller 50 determining if the door angle has stopped at a position is less than a small angle position. For example the small angle position may be ten degrees of the door 12 angle relative to the body 14. If the controller 50 at step 1532 determines the door angle has stopped at position that is less than a small angle position, the method may proceed with the controller 50 executing the small angle close routine (see FIG. 59) at step 1534. If the controller 50 at step 1532 determines the door angle has not stopped position is less than a small angle position, the method may proceed with returning to the step 1520 to control the actuator 22 to move door towards secondary latched position without exceeding the door motion profile before interruption in the motion. The controller 50 when controlling the actuator 22 to move door towards secondary latched position may control the actuator 22 not move the door above a door speed that is greater than a door speed during the cinching of the door by a cinch mechanism. In other words, the door motion will not be controlled to return to tracking the door motion profile before interruption to prevent door oscillations but will be controlled not to exceed the operating limits of the next mode of operation, the cinching mode in this particular example. From steps 1528 and step 1534, the method proceeds to the controller 50 detecting if the door 12 has moved to the secondary latched position at step 1536. If the controller 50 has not detected the door 12 having moved to the secondary latched position at step 1536, the method may proceed with returning to the step 1520 to control the actuator 22 to move door 12 towards secondary latched position. If the controller 50 has detected the door 12 having moved to the secondary latched position at step 1536, the method may proceed to step 1538 with the controller 50 disabling the actuator 22. Next, the method may proceed with activating the cinch actuator 99 to move door 12 from secondary latched position towards primary latched position at step 1542. Next, the method may proceed with the controller 50 in step 1546 of determining if an object is detected during cinch and if a pinch condition is occurring or is about to occur using the contact obstacle detection system and/or the non-contact obstacle detection system. If the controller 50 in step 1546 determines an object is detected during cinching mode of operation, the method may proceed with step 1548 of the controller 50 deactivating the cinch actuator 99. The method may next proceed at step 1550 to activate the actuator 22 to reverse door motion towards secondary position. An ancillary actuator, such as door presenter 2717 may additionally or alternatively be activated. The method may proceed to step 1552 with the controller 50 determining if the door 12 has reach fully closed position as a result of actuating the cinch motor 99 if no obstacles are detected at step 1546. If the controller 50 does not detect the door 12 having reach fully closed position in step 1552, or the primary latched position the method may return to step 1542. If at step 1502 the controller 50 determines that a human has not intended for the door 12 to move, for example the command to close the door originates from a vehicle control system, such as an autonomous vehicle control system, the method may bypass the steps associated with a human originated command and proceed to step 1558 with the controller 50 determining if the user has left the cabin e.g. has egressed from the vehicle 12 using detection sensors in and around the vehicle 12. For example, the controller 50 may communicate with a passenger seat sensor that indicates when a user is no longer sitting in the seat due to a detected weight being lifted off of the sensor. Next, the method proceeds to step 1560 with the controller tracking the user motion away from vehicle 12 using the obstacle detection system, which may include the obstacle detection system sensing areas adjacent the door 12 as well as other long range sensor systems such as the sensor system used for the ADAS system if the vehicle 12 is equipped with such a system, and other detection or vision systems. Next, the method proceeds to step 1562 with the controller 50 determining if the user has left a predetermined distance from the closure member 12, such as the user being outside a proximity zone. A non-contact detection system such as an FMCW radar based system capable of detecting range may be employed for example. Next at step 1564, once the controller 50 has determined the user has exited from the proximity of the vehicle at step 1525, the method may proceed with the controller 50 controlling the vehicle door at a maximum operating mode, such as at the maximum closing and opening speeds since the risk of any obstacles from a user is reduced after detecting the user having left the proximity of the vehicle is mitigated by the inherent distance, or if additional safety is required for an unsupervised closing by the user, the controller 50 may proceed to control the vehicle door 12 at a slower operating speed with increased obstacle detection sensitivities and door stopping reaction times. Also, extra steps such as issuing alerts during door closing adding noise to the environment, ensuring the door is stationary to avoid conflict between power assist mode and automatic mode, scanning for obstacles reducing the chances of false detections, may be bypassed and not performed. Therefore, there is provided a powered closure member actuation system 20 having a controller 50 in communication with an obstacle detection system (e.g. a non-contact based obstacle detection system) and an actuator 22, where the controller 50 is configured to control the actuator 20 in a bypass mode to move the door more rapidly, or within a shorter period of time from a starting position to end position when a user is not detected in a proximity to the door using the obstacle detection system as compared to when a user is detected in proximity to the vehicle door.

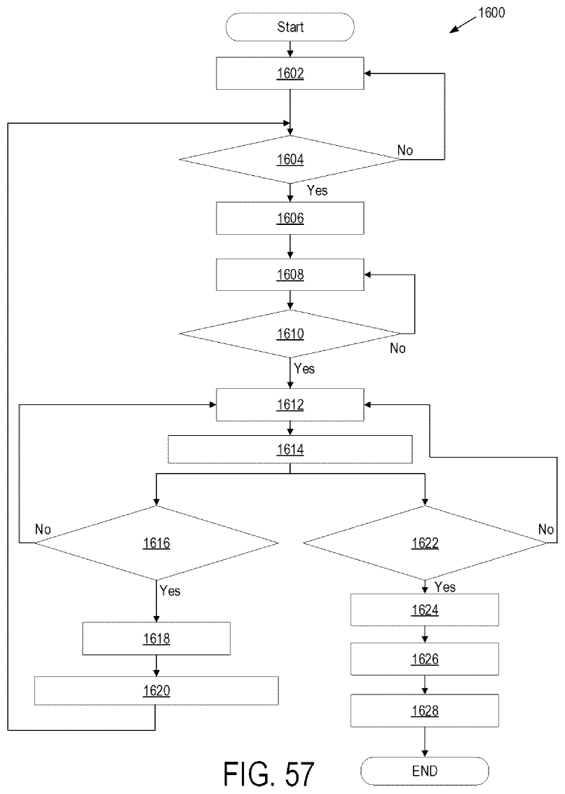

Now referring to FIG. 57, there is shown a flowchart of a method 1600 illustrating the operation of the power closure member actuation system 20 for moving the door when the power closure member actuation system 20 is operating in the power assist mode from a stopped door position. The method begins by the controller 50 monitoring for a user or human within, and possibly approaching the door within, a proximity detection zone detected by the non-contact obstacle detection system indicating a user which may possibly desire to move the door 12 in power assist mode at step 1602. The system 20 may be operating already in an automatic mode, or maybe stationary during this step. The method next proceeds to step 1604 of the controller 50 determining if a user has been detected by the non-contact detection system to be in proximity to the door 12. If the controller 50 determines in step 1604 that a user has been detected by the non-contact detection system to be in proximity to the door, the method may proceed at step 1606 to the controller 50 reducing or eliminating the holding force of door checking force, for example the resistive force generated by the actuator 22 or other braking mechanism if the door 12 is so subjected to, when a door check function is active in anticipation of the user attempting to move the door manually and allowing the user to avoid detecting any holding. If the controller 50 determines in step 1604 that a user has not been detected by the non-contact detection system to be in proximity to the door, the method may return to step 1604. The method next proceeds to step 1608 of the controller 50 monitoring if a user has taken manual control of the door, and for example by monitoring for a door movement using a door motion system (e.g. sensor system) if the door is already stationary. If the controller 50 determines in step 1610 that a user has taken manual control of the door at step 1612 the controller 50 may transition in step 1610 to the power assist mode and control the actuator 22 in power assist mode as described in more details herein, for example once the user has moved beyond the position limits of the door check function having overcame the resistive door check force, which may have been reduced or eliminated in step 1606. For example the controller 50 may detect a change in either the position of the door or the motion of the door, or both, as a condition for transitioning to the power assist mode. Following step 1612 the method will proceed to step 1614 with the controller 50 disabling the NCOD (Non-Contact Obstacle Detection) system or ignoring any signals from the NCOD system indicating that an object is detected due to the user being constantly adjacent the door during power assist operation and since the user is in manual control of the door and can control the door to judge if the door should be stopped or moved accordingly to avoid collision with an obstacle in lieu of the non-contact obstacle detection system. Therefore, there is provided a powered closure member actuation system 20 having a controller 50 in communication with an obstacle detection system (e.g. a non-contact based obstacle detection system) and an actuator 22, where the controller 50 is configured to control the actuator 20 in the automatic mode and process signals from the obstacle detection system and is further configured to control the actuator 20 in the power assist mode and ignore signals from the obstacles detection system. In another possible configuration, the controller 50 may ignore signals from the obstacle detection system of a subset of detection zones, such as for example when a user is closing the door standing outside and adjacent the vehicle, the obstacle detection system having a detection zone being the exterior outward facing volume adjacent the vehicle where the user would be required to stand in order to move the door to a closed position using a sensor for example provided in an outside door handle, or the side rear view mirror, such signal indicating an obstacle detected in the form of the user is ignored, while the controller 50 may consider signals from the obstacle detection system sensor facing inwards from the door for detecting objects between the door and the vehicle body 14, such as signals from a sensor facing inwards such as a radar sensor facing inwards as provided behind an inner trim panel, or a outwardly sensor positioned at a rocker panel. In a possible configuration the controller 50 may consider signals from a contact based sensor when operating in the power assist mode, such as signals from the anti-pinch strip as one example. When the system 20 is operating in a manual mode, signals from the obstacle detection system may be ignored. Following step 1614 the method may proceed with the controller 50 detecting if the user has stopped manual control of the door at a position between fully opened and secondary latched position at step 1616. For example the user may bring the door to a stop under his manual control during power assist mode, or the user may release the door such that any manual input upon the door by the user stops. If the controller 50 determines in step 1616 that a user has ceased manual control of the door, the method will proceed next at step 1618 with the controller 50 controlling the actuator 22 in door check mode. The controller 50 may alternatively or additionally control another electromechanical door check or brake device, if provided as part of the power closure member actuation system 20. Next following step 1618, the method may proceed next with enabling the non-contact detection system in step 1620 and returning to the step 1604 for detecting if a user has moved out of range of the door, or if the user has remained within range of the door for assisting the controller 50 in making any further decisions about the control of the door, such as for determining if wind may be moving the door, if an automatic close command is received for controlling the door accordingly for the safety of the user adjacent the door as examples. Following step 1614 the method may proceed with the controller 50 detecting at step 1622 if the user has stopped manual control of the door at a position between secondary latched position and primary latched position. For example the user may impart to the door a force before the secondary door position which may drive the door past secondary position and directly into primary latched position. If the controller 50 determines in step 1622 that the user has stopped manual control of the door at a position between secondary latched position and primary latched position, the method may proceed at step 1624 to not control the actuator 22 to provide a door check function on the door between these positions. Next, the method may proceed at step 1626 to activate the non-contact obstacle detection system for detecting pinch events. The controller 50 may activate the non-contact obstacle detection system, or the contact anti-pinch sensor system when the door has been detected to have been moved to secondary door position. Next, the method may proceed at step 1628 to activate the cinch actuator 99 to cinch the door 12 to the primary latched position. The door 12 will be in primary latched position and the method may end. Therefore, there is provided a powered closure member actuation system 20 having a controller 50 in communication with an obstacle detection system (e.g. a non-contact based obstacle detection system and a contact based obstacle detection system) and at least one actuator for moving the door, where the controller 50 is configured to process or receive signals from the obstacle detection system based on the mode of operation of the door in at least one of a power assist mode, an automatic mode, a manual mode, and a cinching mode.

Now referring to FIG. 58, there is shown a flowchart illustrating a method of operation of the power closure member actuation system 20 for controlling the door during an unplanned stop when the door is being moved by the power closure member actuation system 20 configured in automatic mode. The unplanned stop routine beings at step 1710 with the controller 50 having to determine the cause of the travel interruption and control the actuator 22 or another brake mechanism if provided, or both to stop the motion of door. Next, the method may proceed from step 1710 to step 1728 with the controller 50 waiting to receive an automatic door mode command to resume the door motion before the travel interruption occurred at step 1726. Once the automatic mode command to resume the door motion in automatic mode has been received the method may proceed to step 1746 described below. The controller 50 at step 1710 may determine the cause of the travel interruption to be from an external source for example as detected by the controller 50 sensing a delta current from the actuator signal control lines detected for predetermined period of time caused by an external force acting upon the door 12. If the controller 50 at step 1728 determines the cause of the travel interruption to be originating from an external source, the controller 50 next at step 1732 determines if the non-contact obstacle detection system detects an object, which may be a user as the object. If at step 1730 the controller 50 determines the non-contact obstacle detection system has detected an object, the method may proceed at step 1732 to interpret the intervention as a user commanded manual input (e.g. request to open, close or stop door, where the user is detected by the non-contact obstacle detection system. Next the method proceeds to step 1734 of the controller 50 transitioning to a power assist mode to assist the user with manually moving the door in a manner as illustratively described herein above. Next the method proceeds to step 1736 of the controller 50 disabling the non-contacting obstacle detection system since the user is now assumed to have control of the door and is able to stop and move the door to avoid any obstacles from contacting the door and therefore no interruption in the door motion such as braking or stopping the door when an obstacle is detected will occur when in power assist mode. If at step 1732 the controller 50 determines the non-contact obstacle detection system has not detected an object, the method may proceed at step 1738 to interpret the intervention as a non-operator input (for example, a non-user force may be imparted on the door, such as by a wind gust or a mechanical upset). Next the method proceeds at step 1740 of the controller 50 controlling the actuator 22 to stop the door motion. Next the method proceeds at step 1742 of the controller 50 determining if an automatic door mode command or power assist door mode command has been received. Therefore, there is provided a powered closure member actuation system 20 having a controller 50 in communication with an obstacle detection system (e.g. a contact based obstacle detection system or a non-contact based obstacle detection system), a door motion sensing system (e.g. such as an absolute position sensor for detecting door motion, or a hall sensor for detecting motor shaft position, or a ripple counting system for counting ripples in the motor current indicating rotation of the motor as examples, or other circuitry and sensing configurations), and an actuator 22, where the controller 50 is configured to control the actuator 20 to stop the door as a function of an obstacle not being detected using the obstacle detection system and the detection of the door moving using the door motion sensing system. If the controller 50 at step 1742 determines an automatic mode command is received by the controller, the method will proceed to step 1746 of the controller 50 controlling the actuator 22 to continue to move door to planned door open position in automatic mode. If the controller 50 at step 1742 determines a power assist mode command is received by the controller 50, the method will proceed to step 1748 of the controller 50 executing the power assist mode routine to control the door 12 motion.

Now referring to FIG. 59 there is illustrated a method of controlling the door 12 from a small angle stopped position greater than secondary position in automatic mode 1760, also referred to as a small angle position close command routine. The method begins with the controller 50 determining if a command to close the door has been received at step 1762, for example if the door 12 has been previously stopped at a small door open angle position and the controller 50 has received a door resume command in automatic mode. The method next proceeds upon the controller 50 receiving a door close command to control the actuator 22 in automatic mode at step 1764, and for example to control the actuator 22 to accelerate the door to a velocity for moving the door 12 to the secondary latched position. The controller 50 may control the actuator 22 to stop the door 12 at the secondary latched position with zero velocity, or may control the actuator 22 to move the door to secondary latched position with an approximately zero velocity. The controller 50 may control the actuator 22 to move the door 12 at the secondary latched position with a velocity matching a cinching velocity as described herein above. Next the method proceed to step 1766 whereat the controller 50 will determine or detect if the door 12 has moved to secondary latched position. If at step 1776 the controller 50 detects the door 12 has moved to secondary latched position, the method will proceed to step 1768 of the controller 50 disabling the actuator 22. The controller 50 may alternatively monitor the door position as it approaches secondary closed position and control the actuator 22 to reduce the speed of the door 12 slightly before the door reaching secondary such that the door 12 moves into secondary closed position at zero or nearly zero velocity, or to match the cinching velocity. Alternatively, the controller 50 may control the actuator 22 to allow some approach velocity of the door to ensure the latch 83 will be latched into secondary latched position at least. If at step 1776 the controller 50 does not detect the door 12 has moved to secondary latched position, the method will return to step 1774. Next, the method proceed to step 1770 to activate the cinch actuator 99 to move the door 12 from secondary latched position towards primary latched position in a manner as described in details herein above. Therefore, there is provided a powered closure member actuation system 20 having a controller 50 in communication with a door motion sensing system (e.g. such as hall sensors provided within the latch 83 for detecting the state of the latch 83 indicative of the position of the door 12), a cinch mechanism for moving the door from a cinch start position, such as secondary latched position to a cinch end position, such as primary latched position, at a cinch velocity, and an actuator 22, where the controller 50 is configured to control the actuator 22 to move the door 12 to the cinch start position with a velocity that matches (e.g. approximately, or exactly matches) the cinch velocity.

Now referring to FIG. 60 there is illustrated a method 1800 of checking or holding the door 12 after controlling the door in automatic mode or power assist mode, also referred to as an infinite door check function or routine. The method begins at step 1802 with the controller 50 controlling the actuator 22 to check the door 12 at the stopped position, or in other words the door check function using the actuator 22 is on. Next at step 1806 the controller 50 will monitor for door movement. If at step 1806 the controller 50 does not detect door movement, for example after 0.75 seconds of no movement, the method will at step 1808 not control the actuator 22 to apply a resistance to movement or to move the door to conserve power, or alternatively the controller 50 may control the actuator 22 to apply some resistance to movement such as for example using a field oriented control (FOC) braking methodology if actuator 22 is provided with a brushless motor for example, and next return to the step 1806, or alternatively the controller 50 may control the actuator 22 to apply some resistance to movement such as if the door is biased due to the hinge orientation or configuration in a direction away a stopped position to at least resist the bias from moving the door 12 when in the checked position. If at step 1808 the controller 50 does detect door movement, the method will proceed to step 1810 to detect if a user is proximate to the door 12 using the non-contact obstacle detection system. In other words, after the door has stopped and the door check function is activated, the controller 50 will not supply power, or will only increase power delivery to the actuator 22 to hold/check the door at this stopped position only if the controller 50 detects a deviation from the stopped position. Therefore the door check function executed by the controller 50 may not continuously apply a force to the door to maintain the door in the checked position, but rather only if the door 12 is detected to move away from the checked position. The door may be configured to be balanced, and not biased towards one of the closed positions and the opened positions. Therefore, there is provided a powered closure member actuation system 20 having a controller 50 in communication with a door motion sensing system, and an actuator 22, where the controller 50 is configured to control the actuator 20 to not to apply a checking force to the door 12 when the door is not moving from a stationary position and to apply a checking force to the door when the door is sensed using the door motion sensing system to be moving away from the stationary position, the force checking force counteracting an external force moving the door away from the stationary position. At step 1810, for example the controller 50 may be configured to determine if the obstacle is not a user based on tracking the user in an area adjacent the door 12, sensing characteristics such as size, reflectivity if the non-contact obstacle system is a radar based system of the user adjacent the door 12, and/or using any PKE/FOB system in conjunction with an identifying wireless device the user may be carrying. If at step 1810 the controller 50 detects an obstacle or a non-user is proximate to the door 12, the method will proceed with the step at 1812 of the controller 50 controlling the actuator 22 to increase check door force, or resistance to movement of the door 12, based on door position and door check force profile above power assisted force, for example using force profiles as described illustratively herein. Next the method will proceed to step 1814 with the controller 50 determining or detecting if the door position is at a predetermined position or distance from the stop position (before the door has been moved). If at step 1814 the controller 50 determines or detects the door position is at a predetermined position or distance from the stop position, the method proceeds at step 1816 to deactivate the door check function, and in other words, to not control the actuator 22 to resist the door movement. Therefore the controller 50 will control the actuator 22 to return the door 12 back to the initial door checked position if a deviation of the door does not exceed an angular change in the door position. During this angular change the controller 50 will increase the resistive force countering the force causing the door to move away from the door checked position until the door has surpassed the predetermined position or distance from the stop position, as seen in FIG. 60A. During this process, in one possible configuration, a maximum power delivery to the actuator 22 may be capped by the controller 50 to conserve power, such as 30 watts. Next, the method proceeds with the step 1818 of controlling the door 12 in a power assist mode. If at step 1810 the controller 50 does not detect a user is proximate to the door 12, the method will proceed with the step at 1820 of the controller 50 controlling the actuator 22 to resist the door movement to stop the door motion. For example a gust of wind may cause the door to move when no user has been detected. Next the method will proceed to step 1822 with the controller 50 controlling the actuator 22 to return the door to the position before the door movement. This possible configuration may be contrasted with a configuration whereby a user intentionally moves the door to a new position where at the door check function is reset when the door is stopped at such a new position which may be allowed if the NCOD system detects a user adjacent the door 12, whereas a configuration where the door is moved by an external force not applied by a user detected using the obstacle detection system may be returned to its initial stationary position so as to avoid position creep where over time the door may be moved away from its initial door checked position and eventually striker an obstacle, or move to a position where it may be in the path of obstacles e.g. into a traffic lane or pedestrian or bicycle walkway. Next, the method will proceed to step 1824 with the controller 50 using a door check door profile with an increased holding force or a more aggressive door checking profile. For example the controller 50 will apply a greater resistive force within a smaller door movement angle, or response time will be decreased and resistive response force will be increased. Next the method will proceed to step 1826 with the controller 50 determining if a user has been detected adjacent the door 12 using the non-contact obstacle detection system, and in other words if a user has now entered into proximity with the door 12 where it may be likely the user will like to control the door manually or in power assist mode. If at step 1826 the controller 50 determines that a user has been detected, the method will proceed to step 1828 with the controller 50 using a normal door check profile or normal response force and time, or even a less aggressive door check profile in anticipation and lower response forces of the user manually taking control of the door to allow the user to not have to overcome the augmented door check force in step 1824. From step 1828 the method proceeds with returning to step 1806. If at step 1826 the controller 50 determines that a user has not been detected, for example the user has moved out of proximity of the door 12, the method will proceed to step 1832 with the controller 50 using a normal door check profile, or even a less aggressive door check profile after a predetermined of time has passed after the controller 50 has not detected a user using the non-contact obstacle detection system. From step 1832 the method proceeds with returning to step 1806. Therefore, there is provided a powered closure member actuation system 20 having a controller 50 in communication with an obstacle detection system and an actuator 22, where the controller 50 is configured to control the actuator 20 to apply a first checking force to the door 12 when an obstacle, for example a user, is detected adjacent the door using the obstacle detection system, and to apply a second checking force different, for example greater or lessor, than the first checking force to the door when an obstacle, or user, is not detected adjacent the door 12 using the obstacle detection system. With reference additionally to FIG. 60A, there is illustrated an exemplary force profile 1799 applied to the door 12 by the actuator 22 after the door 12 has moved to a stopped position 1801 by the controller 50 controlling the actuator 22 in automatic mode or power assist mode whereat the door check function is activated. The controller 50 will during operating in the door check mode control the actuator 22 with a generated reference force D either in power assist mode or automatic mode until the door 12 reaches the final angle 1801 where the reference force D jumps to a higher value of check force C, which would be maintained as the reference force while the door position is between door angles 1803, 1805. Alternatively, the door 12 may be controlled to stop at final angle 1801 at which point the actuator 22 is not supplied with energy after the door is stationary until a deviation away from the final angle 1801 is detected at which point the controller 50 will detect door motion and control the reference force D to increase to the higher value of check force C. As an infinite check function, the check force C should be higher than the normal swing force D to maintain the door position 1801 unless a higher amount of force (such as an external force applied by a user) is applied to the door 12. When the door position reaches the knee angle 1803 or 1805, the reference force starts to increase. Any user attempting to manually move the door will sense an increased resistive force against the user manual force input on the door. At certain door angles 1807, 1809 the resistance force will remain constant over an angular movement of the door 12, and thereafter return to the generated reference force D. Further beyond a release angular position 1811, the door check function may be deactivated of turned off. If the door position does not pass beyond the release angular position 1811, the actuator 22 may be controlled to return the door to the final angle 1801, or the door check profile may be reinitialized at this new final angle 1801, or in other words the door check force profile of FIG. 60A is re-centered about the new final angle 1801. As shown in FIG. 60A, the controller 50 may increase or decrease the check force (ranging between A and C) according to various considerations, such as the state of the vehicle 10 or door 12, to provide an asymmetrical and dynamic infinite door check function. For example, the controller 50 in response to detecting the vehicle 10 on an incline tending to impart a gravity force on the door 12 to urge the door towards the closed position, the door check force B may be shifted or increased to further resist the door movement only in the closing direction to resist the external gravity force tending to impart on the door a door closing motion. And likewise the door check force B may be shifted or decreased to further resist the door movement only in the opening direction such that a user does not have to overcome both the external gravity force as well as the door check force B when the user attempts to move the door in the opening direction. FIG. 60A shows such an asymmetrical door check for profile, which may also be provided as a symmetrical door check force profile. Therefore, there is provided a powered closure member actuation system 20 having a controller 50 in communication with an vehicle sensor for detecting the state of the vehicle, such as an inclination or orientation of the vehicle, and an actuator 22, where the controller 50 is configured to control the actuator 20 to apply a door check force during one direction of door movement that is different than the door check force during another direction, such as the opposite, of door motion.

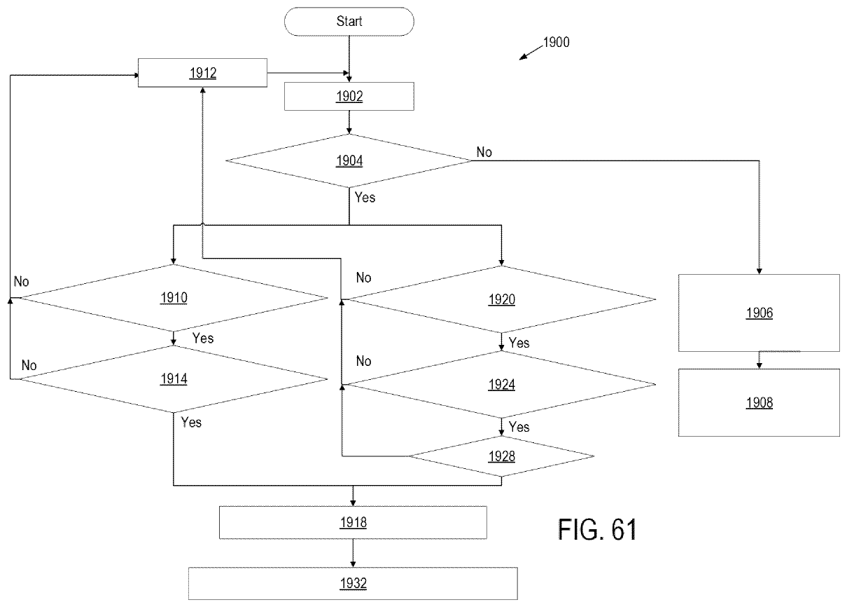

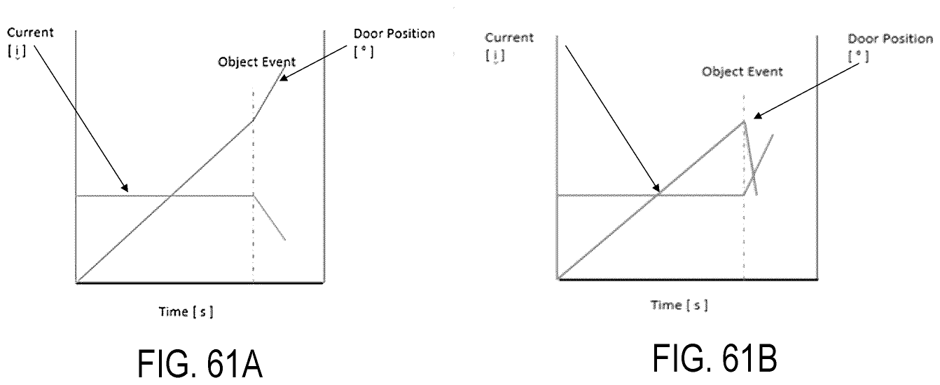

Now referring to FIG. 61, there is illustrated a method of determining a travel override state of the operation of the power closure member actuation system 20 operating for moving the door in automatic mode, for example as caused by a user grasping the door 12 during its motion with the intent of moving the door 12 either manually or in a power assist mode and ceasing the automatic mode operation of the door 12, that is to interrupt the door operating in the automatic mode. The method begins with the controller 50 at step 1902 determining or detecting an unexpected change in position or acceleration or velocity of the door. Such a determination may be made based on an unexpected change in the door position using a door position sensor, or a detection in current spikes detected in the actuator signal lines as described in more details herein below. The method next proceeds with the controller 50 at step 1904 determining or detecting using the non-contact obstacle detection system if a user is adjacent to the door 12 to determine if a user may be causing the unexpected change in position or acceleration or velocity of the door 12. If at step 1904 the controller 50 does not determine or detect a user is next to the door 12, the method may proceed with the step of the controller 50 determining at step 1906 that the interruption or intervention in the door motion is caused by a non-user applied force, such as applied by a gust of wind or a mechanical upset. Next the method proceeds to the step 1908 of the controller 50 using the actuator 22 to stop the door, and for example control the actuator 22 to immediately stop the door 12 in the shortest possible distance for example without damaging the actuator. If at step 1904 the controller 50 does determine or detect a user is next to the door 12, the method may proceed with the step 1910 of the controller 50 determining or detecting if the door is being accelerated in the same direction as the door motion. If at step 1910 the controller 50 does not determine or detect the door being accelerated in the same direction as the door motion, the controller 50 may at step 1912 control the actuator 22 to compensate for unplanned door movement, for example by increasing the resistance to the unexpected door movement. If at step 1910 the controller 50 does determine or detect the door being accelerated in the same direction as the door motion, the controller 50 may at step 1914 determine or detect if the door is accelerating exceeding the automatic door operating range or threshold. FIG. 61A illustrates an example of current and position signals received by the controller 50 for example from the actuator 22 or a position sensor as described in detail herein above used to illustratively identify travel override by a user. In this case, motion is shown in the open direction, but the example is applicable for the closing direction as well. In the exemplary FIG. 61A, the current may decrease due to input of force from operator causing a speed reduction in the actuator 22 while the door position (and rate of change of position) may increase. If at step 1914 the controller 50 does not determine or detect if the door is accelerating exceeding automatic door operating range or threshold, the method may proceed to step 1912. If at step 1914 the controller 50 does determine or detect the door 12 is accelerating exceeding automatic door operating range or threshold, the controller 50 may determine a manual override has occurred at step 1918. If at step 1904 the controller 50 does determine or detect a user is next to the door, the method may proceed with the step 1920 of the controller 50 determining or detecting if the door is being deaccelerated in the same direction as the door motion. If at step 1920 the controller 50 does not determine or detect the door being deaccelerated in the same direction as the door motion, the controller 50 may at step 1912 control the actuator 22 to compensate or increase resistance against the unplanned door movement. If at step 1920 the controller 50 does determine or detect the door being accelerated in the same direction as the door motion, the controller 50 may at step 1924 determine or detect if the door is decelerating exceeding automatic door operating range or threshold. If at step 1924 the controller 50 does not determine or detect if the door is accelerating exceeding automatic door operating range or threshold, the method may proceed to step 1912. If at step 1924 the controller 50 does determine or detect the door is deaccelerating exceeding automatic door operating range or threshold, the controller 50 may determine at step 1928 if the door direction has reversed, for example from an opening direction to a closing direction. FIG. 61B illustrates an example of current and position signal used to identify travel reversal. The current shown in FIG. 61B may increase due to input of force from operator causing a resistance against the opening door movement while the door position may decrease. If at step 1928 the controller 50 does determine or detect the door motion has reversed direction, the controller 50 may determine a manual override has occurred at step 1918. If at step 1928 the controller 50 does not determine or detect the door motion has reversed direction, the method may proceed to step 1912. The method may proceed from step 1918 with the step of the controller 50 transitioning from the step of controlling the door in the automatic door mode to the power assist door mode in step 1932. As a result, the power closure member actuation system 20 may allow the user to override the automatic door mode at any time during automatic door motion, and move the door for example more rapidly than as controlled during automatic power door mode. Therefore, there is provided a powered closure member actuation system 20 having a controller 50 operable in the power assist mode and the automatic mode, the controller 50 also being in communication with an obstacle detection system, a door motion sensing system, and an actuator 22, where the controller 50 is configured to transition from the automatic mode to the power assist mode when the controller 50 senses a user using the obstacle detection system and detects a door motion using the door motion sensing system when the controller is moving the door in automatic mode.

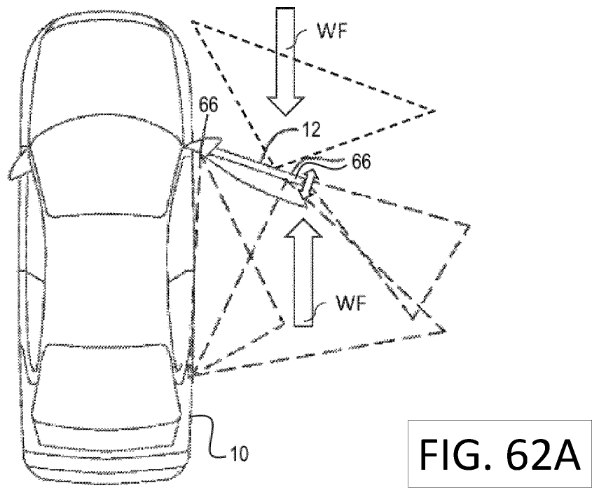

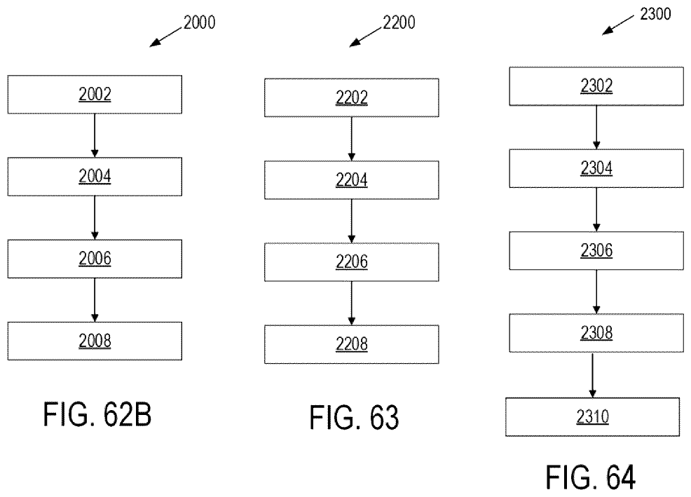

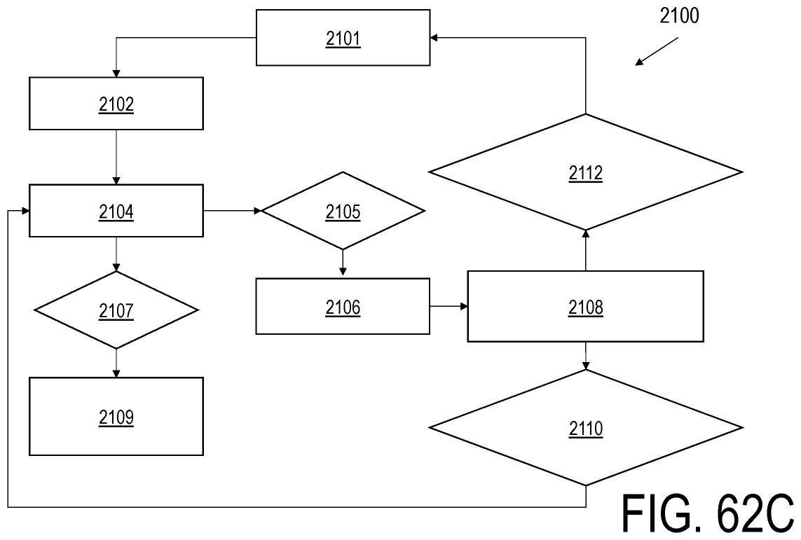

Now referring additionally to FIG. 62A, the power closure member actuation system 20 can utilize the at least one angle sensor to detect a position and movement of the closure member 12. It is understood door position and movement may be detected in other manners as illustratively described herein. Consequently, the controller 50 may be configured to detect movement of the closure member 12. Since the power closure member actuation system 20 can also detect obstacles or persons near the closure member 12 (e.g., using the at least one non-contact obstacle detection sensor 66. Illustratively three sensors 66 are shown having separate fields of view (FOVs) illustratively shown using dotted lines), the controller 50, for instance, may determine that any detected movement of the closure member 12 is likely due to Wind Force (WF), an example of an external non-user force. Thus, after the controller 50 detects no contact by a person, or not persons in proximity to the door which may cause door motion, causing movement of the closure member 12 using the non-contact obstacle detection sensors or system, the motion of the closure member 12 by the power closure member actuation system 20 (e.g., by actuator 22) can be stopped or otherwise altered as a result. So, if the controller 50 detects that no obstacle is present using the at least one non-contact obstacle system, the controller 50 may control the actuator 22 to alter movement (e.g., ceases movement) of the closure member 12 in response to no obstacle being detected while movement of the closure member 12 is detected. Therefore, instead of the power closure member actuation system 20 being only operated to sense obstacles to stop the door or closure member when the obstacle is present, the power closure member actuation system 20 can additionally detect movement of a closure member 12 not caused by a person physically moving it, for example, as caused by wind, and without using additional and specialized wind sensors such as wind vanes or anemometers or other complex motion detection calculations and algorithms. As a result, any manual movement of the door can be discerned from wind (WF) to allow the user to correctly transition the mode of the power closure member actuation system 20 into a manual or power assist mode from the door check mode without the manual control of the door being interpreted as a wind force which would result in the actuator 22 or another braking device being control to stop or resist the movement of the door 12.

As best shown in FIG. 62B, a method of operating the power closure member actuation system 20 to detect movement of the closure member 12 due to non-physical contact with the closure member 2000 is additionally provided, and for example due to wind, such as a sudden gust of wind, acting on the door. The method begins with the step of 2002 determining whether the closure member 12 is in an open position. The next step of the method is 2002 determining whether the closure member 12 is moving (e.g., while in the open position). The method continues with the step of 2004 of determining whether no obstacle is detected using the non-contact obstacle detection system. The method proceeds with the step of 2006 altering motion of the closure member using the actuator 22 in response to the closure member moving and no obstacle being detected. Specifically, the step of altering motion of the closure member in response to the closure member moving and no obstacle being detected may further be defined at step 2008 as ceasing motion of the closure member 12 (using the actuator 22, or another brake mechanism, such as an electromechanical brake device within the actuator, or remote from the actuator such as one provided on a door check device, as examples and without limitation) in response to the closure member moving and no obstacle being detected. For example the motion of the closure member 12 resisting the influence of the wind (WF) may be provided by control of the actuator 22 alone, and/or using a separate brake mechanism.

As best shown in FIG. 62C a method of operating the power closure member actuation system 20 to detect movement of the closure member 12 due to physical contact with the closure member 2100 by a user to allow the user to take control of the door 12, for example in manual mode or power assist mode, is additionally provided. The method may include steps executed by the controller 50 and begins with the step 2102 of determining whether the closure member 12 is moving (e.g., while in the open position), for example by the controller 50 monitoring for a change in a door position signal from a position sensor or other position sensing means or technique. The method continues with the step of 2104 of monitoring the non-contact obstacle detection system followed by determining at step 2105 whether no obstacle is detected using the non-contact obstacle detection system. The method proceeds with the step of 2106 of altering motion of the closure member 12, for example by the controller 50, controlling the actuator 22 in response to the closure member moving and no obstacle being detected. Specifically, the step of altering motion of the closure member in response to the closure member 12 moving and no obstacle being detected may further be defined as ceasing motion of the closure member 12 in response to the closure member 12 moving and no obstacle being detected. For example the motion of the closure member 12 by a non-user imparted force, or external system force, on the door 12 may be provided by control of the actuator 22 alone, and/or using a separate brake mechanism. The method may proceed with the step of 2109 of transitioning the power closure member actuation system to the power assist mode, e.g. the controller 50 will control the door motion in a power assist mode as described herein above, in response to the closure member 12 moving and an obstacle, or the user, being detected in step 2107. Therefore, if a user is detected next to the door 12, the door check function will not be applied or will be disabled when a user moves the door, with the controller 50 having determined a wind force or the like is not moving the door unintentionally. Next the method proceeds with the step 2108 of verifying motion of door within a predetermined period of time (e.g. seconds) by the controller 50. If at step 2108 the motion of door is detected within a predetermined period of time at step 2110, the method returns to step 2104. If at step 2108 the motion of door is not detected within a predetermined period of time at step 2112, the method proceeds to step 2101 of controlling the actuator 22 in door check mode, and then returning to step 2102.

As best shown in FIG. 63, a method of operating the power closure member actuation system 20 to detect movement of the closure member 12 due to non-physical contact with the closure member 2200 is additionally provided. The method begins with the step of 2202 determining whether a closure member 12 is in an open position. The next step of the method is 2204 determining whether the closure member 12 is moving (e.g., while in the open position). The method continues with the step of 2206 determining using a motion sensor (for example such as an accelerometer/inclinometer) a change in motion or inclination of the vehicle 10 which may cause the closure member 12 to move unintentionally, for example as a result of a person entering the vehicle 10 on an opposite side of the vehicle 10 causing the closure member 12 to move as a result, or otherwise. The method proceeds with the step of 2208 altering motion of the closure member 12, for example by controlling the actuator 22, in response to the closure member 12 moving and detecting/determining that there is a motion of the vehicle 12. Specifically, the step of altering motion of the closure member 12 in response to the closure member 12 moving and detecting/determining that there is a motion of the vehicle 10 may further be defined as 2208 ceasing motion of the closure member 12 in response to the closure member 12 moving and detecting/determining that there is a motion of the vehicle 10.

As best shown in FIG. 64, a method of operating the power closure member actuation system 20 to detect movement of the closure member 12 due to non-physical contact with the closure member 2300 is additionally provided combing the steps of FIGS. 62 and 63 described hereinabove. The method begins with the step of 2302 determining whether a closure member is in an open position. The next step of the method is 2304 determining whether the closure member is moving (e.g., while in the open position). The method continues with the step of 2306 determining whether an obstacle is detected using the NCOD system, for example a person may be standing and detected next to the closure panel 12 without the intent of moving the closure panel or any interaction with the closure panel 12. The method continues with the step of 2308 determining using a motion sensor (for example such as an accelerometer/inclinometer) a change in motion or inclination of the vehicle which may cause the closure member to move unintentionally, for example as a result of a person entering the vehicle on an opposite side of the vehicle causing the closure member to move as a result, or as a result of a shift in an unstable ground as examples. The method proceeds with the step of 2310 altering motion of the closure member in response to the closure member moving and detecting/determining that there is a motion of the vehicle and an obstacle being detected. Specifically, the step of altering motion of the closure member in response to the closure member moving and detecting/determining that there is a motion of the vehicle and an obstacle being detected may further be defined as ceasing motion of the closure member in response to the closure member moving and detecting/determining that there is a motion of the vehicle 12.

Now referring to FIG. 65, there is provided a method 2400 for moving a door 12 from a closed door position when the door 12 is in a frozen state. The method includes the step 2402 of receiving by the controller 50 an open door command, such as an open door command for automatic mode motion of the door 12 as described herein above for example. Next, the method proceeds with the steps of monitoring the non-contact obstacle detection system using the controller 50 to determine if an object is detected adjacent the door at step 2404. If at step 2406 the controller 50 determines that an object is detected adjacent the door, the controller 50 will determine that the door is in a blocked state, such as a large object is abutting against the door. The controller 50 will therefore not control the actuator 22 to move the door 12 towards an open position at step 2408. The controller 50 may activate an alert, such as a chime for indicating to the user the state of the actuation of the door. In one possible configuration, the controller 50 may control interface devices 74, 76 to display the state of the door system 20 for providing more information to the user other than an uninformative chime or beep. For example, the interface devices 74, 76 may be controlled to display the next allowed input to the user: “Door operating in power assist mode” or “Door has been stopped, press switch to continue in automatic mode, or assume control of door” or “Obstacle detected, door has been moved to open position. Assume manual control for remainder of door motion” or “Door is frozen and cannot be powered open. Manual control of the door only”. Such a display of a user interface device may be provided at other locations on the vehicle, such as on the applique exterior of the vehicle as an example for a user to take recognition of the state of the door from the exterior of the vehicle. At step 2410 the controller 50 determines that an object is not detected adjacent the door, the controller 50 will determine that the door may be opened without collision with an obstacle. The controller 50 will therefore control the actuator 22 to move the door towards an open position in step 2412. The method may proceed to the step of determining if an error signal is received by the controller 50 at step 2414. If the controller 50 receives at step 2414 an error signal (for example an overload signal), the controller 50 may control the actuator 22 in step 2415 to cease and not move the door, having determined for example that an electrical error or other error has occurred. The controller 50 may issue an alert as a chime for indicating to the user the state of the actuation of the door. If the controller 50 does not receive at step 2416 an error signal, the controller 50 may proceed to step 2418 of determining or detecting if there is motion of the door, and if there is door motion detected within a predetermined period of time e.g. 3 seconds. If at step 2418, the controller 50 does not detect motion, the method continues to the step 2420 of verifying the temperature of the vehicle or door. If at step 2422 the controller 50 determines that the detected temperature is less than a predetermined temperature, such as 0.5 degrees Celsius, the method may proceed to the next step 2426 of the controller 50 controlling the an ice breaker or an door presenter mechanism (such as presenter 2717 having a moveable plunger being a separate device from the actuator 22) to move the door 12 away from the closed position to overcome the frozen door state e.g. to break any ice and/or and may control the actuator 22 to output a higher than normal (e.g. as compared to during normal power assist or automatic mode) output force, such as at least a 400N force as measure from the door handle, for breaking the ice to free the frozen door state. If at step 2428 the controller 50 determines that the detected temperature is greater than a predetermined temperature, such as 0.5 degrees Celsius, the method may proceed to the next step 2430 of the controller 50 determining that the door is mechanically stuck and the door is being prevented from moving away from the primary closed position due to ice buildup for example, and the controller 50 not controlling the actuator 22 (e.g. a primary door mover) or the door presenter 2717 or other ancillary door mover to move the door to prevent damage. The controller 50 may activate an alert, such as a chime for indicating to the user the state of the actuation of the door.

Now referring to FIG. 66, there is provided a method 2500 for moving a door from a closed door position when the door is in a mechanically blocked or stuck or jammed state. Such a state may occur for example if the vehicle has been in a crash and a portion of the door or frame becomes deformed preventing the door from moving away from the closed position normally as but an example. The method includes the step 2502 of receiving by the controller 50 an open door command, such as an open door command in automatic mode as described herein above for example. Next, the method proceeds with the step of the controller 50 using the non-contact obstacle detection system to determine if an object is detected adjacent the door at step 2504. If at step 2506 the controller 50 determines that an object is detected adjacent the door, the controller 50 will determine that the door is in a blocked state, such as a large object is abutting against the door and the door is not mechanically stuck or blocked. The controller 50 will therefore not control the actuator 22 to move the door towards an open position at step 2507. The controller 50 may activate an alert, such as a chime for indicating to the user the state of the actuation of the door. If at step 2508 the controller 50 determines that an object is not detected adjacent the door, the controller 50 will determine that the door may be opened without collision with an obstacle. The controller 50 will therefore control the actuator 22 to move the door towards an open position in step 2510. The method may proceed to the step of determining if an error signal is received by the controller 50 at step 2512. If the controller 50 receives at step 2512 an error signal, the controller 50 may control the actuator in step 2514 to cease and not move the door, having determined for example that an electrical error has occurred. The controller 50 may issue an alert as a chime for indicating to the user the state of the actuation of the door. If the controller 50 does not receive at step 2516 an error signal, the controller 50 may proceed to step 2518 of determining or detecting if there is motion of the door, and if there is door motion detected within a predetermined period of time e.g. 3 seconds. If at step 2518 the controller 50 does not detect motion of the door, the method continues to the step 2520 of verifying if the door remains stationary for a predetermined period of time while the controller 50 is controlling the actuator 22 to attempt to move the door 12. If at step 2520 the controller 50 determines that the door remains stationary for a predetermined period of time while the controller 50 is controlling the actuator 22 to attempt to move the door, the method may proceed to the next step 1422 of the controller 50 determining that the door is in a mechanically stuck door state and cease controlling activation of the actuator 22 at step 2522. The controller 50 may alternatively control both the actuator 22 and a separate mechanism such as a door presenter 2717 in tandem to attempt to move the door 12 away from its mechanically blocked position for a period of time before concluding that the door is mechanically stuck. If at step 2524 the controller 50 determines that the door moves as a result of actuation of the actuator 22, or the door presenter being activated in conjunction with the actuator 22, the method may proceed to the next step 2526 of the controller 50 continuing to move the door using the actuator 22 to a planned position. Therefore, there is provided a powered closure member actuation system 20 having a controller 50 being in communication with a primary actuator (e.g. actuator 22) for moving the door between the opened position and the closed position and a secondary actuator (e.g. presenter 2717) for moving the door between a partially opened position and the closed position, where the controller 50 is configured to individually control (e.g. one is controlled for moving the door while the other is not controlled for moving the door) the primary actuator for moving the door over a first range of motion (for example from the pop-out position to an opened position) and the secondary actuator for moving the door over a second range of motion (for example from the closed position to the pop-out position). In another possible configuration, the controller 50 may control the primary actuator and the secondary actuator simultaneously to move the door over the second range of motion which may be when the controller 50 detects a frozen or blocked state of the door.

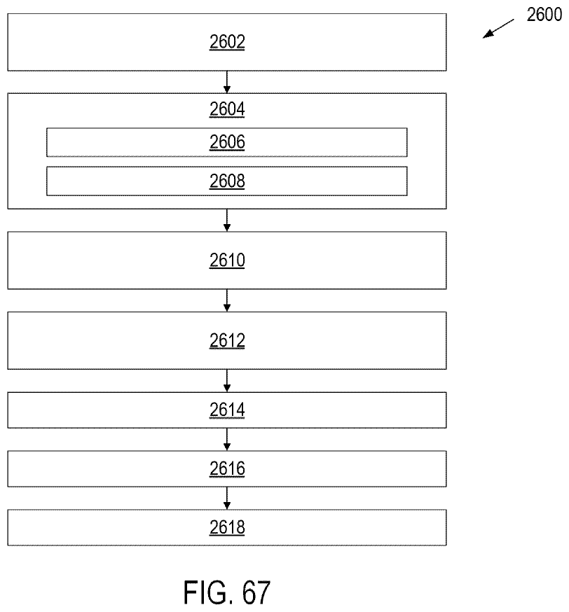

Now referring to FIG. 67, there is illustrated a method executed by the controller 50 for calculating the force command 88 for controlling the actuator output force to move the door 2600, and for example move the door in power assist mode. The method begins at step 2602 with the controller 50 receiving a signal representative of a force applied to the closure panel by a user using the feedback sensor 64 for example, or more generally the feedback system, as described in more details herein above. The method continues at step 2604 with the controller 50 determining the relevant torque moments about a common reference point, for use in the calculation. For example, the common reference point of the relevant torque moments is about the door pivot axis 2650 (See FIG. 70). The method includes in other words determining using the controller 50, at least one torque value about a pivot axis 2650 of the closure panel 12 affecting, either hindering or encouraging pivoting of the closure panel 12 about the pivot axis. The step 2604 may also include substep 2606 including the controller 50 determining if any auxiliary door systems are active such as the presenter 2717, for example as a result of a frozen door state or blocked door state as described in details herein above. For example, the controller 50 may determine if a door presenter 2717 or secondary door mover is activated to also assist with moving the door 12, or if an electromechanical brake is active to assist for slowing or braking the motion of the door. Such auxiliary door systems may be selectively activated by the controller 50 for acting on the door 12 for a portion of the door angle, at discrete door angles, or for the entire motion of the door 12 in different operations of the power closure member actuation system 20, and may be provided to compliment the actuator 22 for moving or slowing the door, or provide other functionality to the door 12. The step 2604 may also include substep 2608 including the controller 50 determining a state change in the door 12. For example, the controller 50 may determine if a door weight has increased or decreased, such as the example of a spare wheel being added or removed from a tailgate or liftgate; if seal load has changed such as for example a convertible roof being removed such that the door does not have to act against additional door seals during closing; if a crash condition has occurred such as for example the controller 50 will assume that some damage has occurred that will increase torque resisting door opening. The method continues to step 2610 with the controller 50 receiving door and vehicle state information from sensors or stored in memory for updating the calculation of the force command 88 in real time during door motion. For example, the controller 50 will receive door angle data for updating the relevant torque moments in real time during door movement control. For example the controller 50 will receive stored data regarding door cycles for updating the relevant torque moments relating to wear and tear in real time during door moving e.g. torque due to friction may increase over time or door open/closing cycles and may affect the torque at different door angles. Therefore the door motion may not be simulated in advance of door opening, but the controller 50 will calculate the relevant torque moments during door motion with updated data received from the various sensors and data stored in memory. The method continues to step 2612 with the controller 50 calculating each torque moment separately as a function of received door and vehicle state information in real time. The method continues to step 2614 with summing the individually calculated torque moments to determine a net torque response about door pivot axis. In other words, the step 2616 includes the controller 50 determining a net torque response using the at least one torque value about the pivot axis 2650 to determine the net torque response. For example since the calculation is performed in real time, and not simulated, during a door opening from closed position, the controller 50 may detect a frozen door and also include in the superposition calculation a torque moment due to a door presenter or a secondary mover assisting with overcoming the frozen door condition. Once the door has been unfrozen, the controller 50 will not include in its superposition calculation the torque moment due to the door presenter or secondary door mover. Since the frozen condition cannot be simulated ahead of time, in other words the controller 50 cannot determine when the frozen door condition will end depending on the amount of ice buildup and at what location in the door open angle, the controller 50 will be able to remove from its calculation step the torque moments due to the presenter 2717 without having to recalculate other torque moment values, resulting in a less complex force calculation process. The method continues to step 2616 with the controller 50 calculating a compensating net torque response about door pivot axis 2650 based on the summation of the calculated torque moments in step 2612. And in other words, the controller 50 will calculate a force command to negate the net torque response value to assist the user with moving the closure while providing the user with a controllable resistance sensed by the user. Such a resistance as experience by the user may be quantified by using a force sensor detecting the force as measured at a position on the door such as on the door handle, or at an edge of the door as examples. The method next continues to step 2618 with the controller 50 controlling the actuator 22 using the calculated compensating net torque response as determined in step 2618. As a result the actuator 22 can be controlled in real time with precise torque to compensate for other torque moments acting upon the door 12. In other words, the controller 50 will control an output torque from an actuator via transmission of a force command 88 from the controller 50 to the actuator 22 to negate or reduce the net torque response value to assist the user with moving the closure panel. In one possible configuration, the controller 50 can modify the output torque from an actuator to completely negate the net torque response providing the user with the sensation of a weightless door, with the user experiencing no resistance or substantially no resistance in response to applying the force input on the door. In another possible configuration, the controller 50 can modify the output torque from an actuator to not negate the net torque response providing the user with the sensation of a weighted door, with the user experiencing resistance in response to applying the force input on the door. In some instances, with the progression of door 12 made of lite weight materials such as composites, it may be desirable for the system 20 operating in power assist mode to normally increase the resistance to the user using the actuator 20 to increase the sensed weight of door so that a user experiences a door motion similar to that during moving a traditionally weight door, such as one made of metal. In such a situations, the system 20 in power assist mode is configured to normally introduce resistance into the door motion as opposed to reducing resistance and providing assistance.

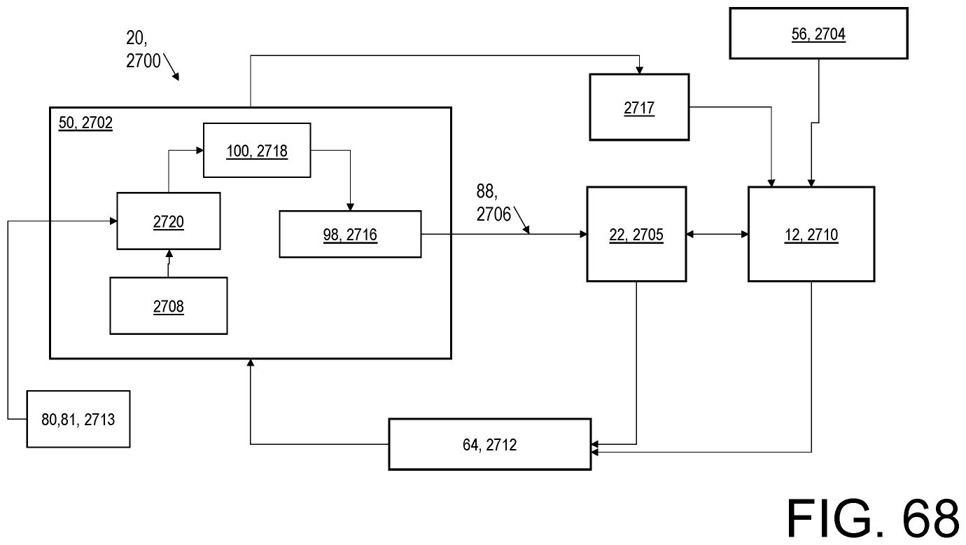

Now referring to FIG. 68, in accordance with another exemplifying configuration of the power closure member actuation system 20, 2700, the controller 50, 2702 is configured to receive one of the motion input 56, 2704 associated with the power closure member actuation system 20, 2700 operating in the power assist mode. The controller 50, 2702 is then configured to send the actuator 22, 2705 the force command 88, 2706 based on at least one calculated torque moment 2705 based on torque models 2708 stored in memory of the controller 50, 2702, in the powered assist mode to vary the actuator 22, 2705 output force acting on the closure member 12, 2710 to move the closure member 12, 2710. In addition, the power closure member actuation system 20, 2700 includes at least one closure member feedback sensor 64, 2712 for determining at least one of a position and a speed and an attitude of the closure member 12, 2710. Thus, the at least one closure member feedback sensor 64, 2712 detects signals from either the actuator 22, 2705 by counting revolutions of the electric motor 36, 2714, absolute position of an extensible member (not shown), or from the door 12, 2710 (e.g., an absolute position sensor on a door hinge as an example) to provide position information to the controller 50, 2702. Other types of feedback systems may be provided for sensing the position of the door 12. The controller 50, 2702 is also configured to receive the motion input 56, 2704 and enter the powered assist mode to output the force command 88, 2706 (e.g., using a force command generator 98, 2716 of the controller 50, 2702 as a function of a force command algorithm 100, for example configured as the superposition algorithm 2718 stored in memory as described herein above. The superposition algorithm 2718 is configured to receive the output of the torque calculator 2720 configured to determine the net torque response about door pivot axis 2650 using the torque models 2708 also stored in memory which are updated in real time based on receiving signals representative of the position and speed of the closure member 12, 2710 for feedback sensors 64, 2712, and also possibly from other sensors 2713 such as environmental sensors 80, 81 for example, as well as other parameters relating to the current state of the closure member 12, 2710. The superposition algorithm 2718 will output the compensating net torque response and the the controller 50, 2702 is configured to generate the force command 88, 2706 based on the calculated net torque response to control an actuator output force acting on the closure member 12, 2710 to move the closure member while providing a change in the resistance experienced by a user moving the door compared to a normal non-powered controlled door. Therefore, there is provided a powered closure member actuation system 20 having a controller 50 operable in the power assist mode, the controller 50 being in communication with an actuator 22, where the controller 50 is configured to control the actuator 22 to inconsistently vary a resistance detectable at the door during the motion of the door. In another possible configuration, the inconsistently variation in the resistance detectable at the door, such as by a user or a force sensor, replicates the inconsistent variation in the resistance detectable at the door when the door motion is not being controlled by the actuator 22.

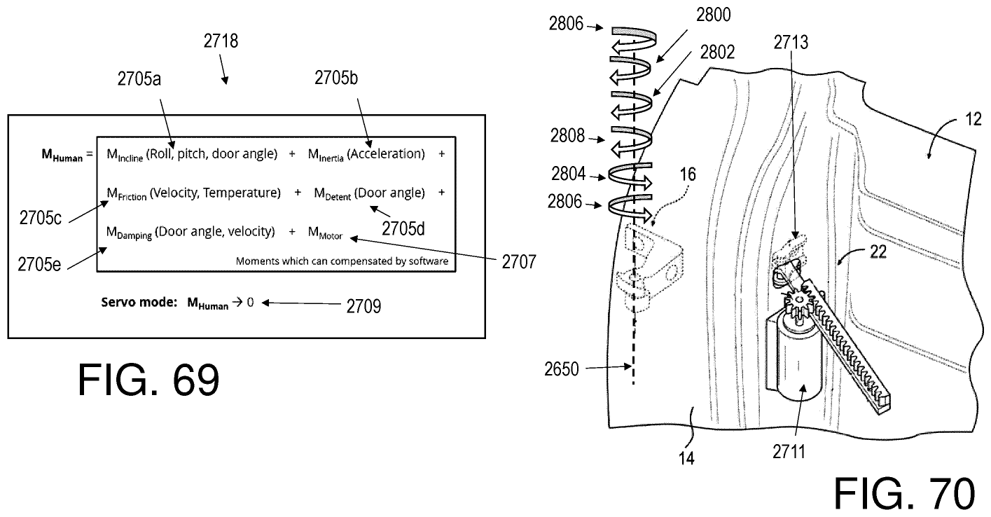

Now referring to FIGS. 69 and 70, there is illustrated an example of a superposition algorithm (FIG. 69) executed by the controller 50 using at least one relevant torque moment 2705. For example shown in FIG. 69 are the relevant torque moments 2705a relating to inclination, or hinge bias, as examples acting about the door pivot axis 2560 which may illustratively act to cause the door 12 to swing open as shown (clockwise direction) in FIG. 70 as arrow 2800; the relevant torque moment 2705b relating to the inertia of the door which initially acts against the door from moving towards the open position, but acts to continue to urge the door towards the open position as the velocity of the door increases shown in FIG. 70 as arrow 2802, a relevant torque moment 2705c relating to friction which acts to resist the door opening towards the opening position shown in FIG. 70 as arrow 2804 shown counterclockwise about axis 2650, a relevant torque moment 2705d relating to detent positions of the door hinge or a door check if the vehicle is configured with such detents tending to resist the door from moving towards the open position at only a predetermined angular position of the door, for example as shown in FIG. 70 as arrow 2806. Other relevant torque moments 2705, such as a damping torque moment 2705e, for example as imparted by a dampening strut or device or the like which may affect the door motion may be included in the superposition calculation. The superposition algorithm 2718 may calculate the compensating net torque response 2707 to negate the sum of the individual relevant torque moments as would be provided by the torque moment of the actuator 22 and the the controller 50 is configured to generate the force command 88 based on the calculated net torque response to control the actuator output force acting on the closure member to generate the compensating net torque response 2707 and as a result move the closure member to either control a resistance experienced by the user when moving the door in power assist or control an assistance experienced by the user when moving the powered door, as represented by arrow 2808 in FIG. 70. Arrow 2808 is shown as being clockwise in direction to provide an assistance with moving the door towards the open position, but may be counterclockwise to provide resistance to door motion towards the open position. The compensating net torque response 2707 may be variable over the angular change of the door to provide a consistent door feel to the user over the entire motion of the door 12 regardless of the door weight, the speed of motion of the door, gravitational effects, and the like which may vary over the angular change of the door 12. In another possible configuration, the compensating net torque response 2707 may be variable over the angular change of the door to provide an in-consistent door feel to the user over the entire motion of the door 12 to introduce changes in resistance or assistance for sensing by the user over the angular change of the door 12. For example, such inconsistencies may provide sensations to the user by increasing in forces around simulated detent positions. As another example, the controller 50, 2702 may provide inconsistencies in resistance and assistance so that a user experiences the same forces during moving the door in manual mode but with such forces being scaled to provide the user with a familiar door opening experience such as would be with moving a manual un-powered door, but with the forces reduced as sensed by the user. For example, the controller 50, 2702 may be configured to vary the resistance such that the user still experiences a force associated with overcoming the inertia of the door when at rest, or for example the controller 50, 2702 may be configured to vary the resistance such that the user still experiences a force associated with the continued inertia of the door when at motion, of for example the controller 50, 2702 may be configured to vary the assistance such that the user still experiences a force associated with overcoming the effect of gravity when the door is being moved and the vehicle 10 is at an inclination such that the door does not feel as if it is on level surface. Such a purposeful introduction of inconsistencies in door resistance and assistance is provided to mimic the forces normally associated with an unpowered door that the user is familiar with to provide a varying degree of haptic feedback to the user as compared to a powered assistance that is consistent throughout the door motion which users may not be familiar with as compared to when moving an unpowered door. During door motion, the compensating net torque response 2707 may be positive to provide an assisting force to the door and also be negative to provide a resistive force to the door, such that the user during the manual interaction of the door will experience the same, or the scaled, force over the entire door's motion. In some instances, the controller 50 may calculate the compensating net torque response 2707, for example by applying an internal scaling variable, such that the resistive force experienced by the user is reduced to almost zero for providing a weightless door sensation, and in other configurations, the controller 50 may calculate the compensating net torque response 2707 such that the resistive force experienced by the user is increased for providing a heavier door sensation to the user. In this illustrative example the clockwise torque about the axis 2650 caused by the actuator 22 will act to move the door while also reducing the resistance experienced by the user acting on the door, or in other words the required opening torque moment 2709 the user has to input to move the door 12 about the axis 2650. Therefore, depending on the desired experience of the user, the control of the actuator can cause the user to experience wither a heavier door (more resistance felt by the user when moving the door) or a lighter door (less resistance felt by the user when moving the door), and one that simulates a normal unpowered door motion but with scaling forces sensed by the user moving the door. The sensed forces by the user can be measured using a force sensor as discussed herein above. FIG. 70 illustrates actuator 22 as a rack and pinion type actuator with an extendable rack, as but one type of actuator 22 which may be employed in the power closure member actuation systems 20 described herein. In one possible configuration, the actuators 22 described herein are not provided with a clutch, and in otherwise have a continuously engaged drive (e.g. always coupled) connection between the motor 2711 and the mounting bracket 2713 on the vehicle body 14. Therefore in both the power assist mode and the automatic mode, the controller 50 may in one possible configuration control the door as a function of the position of the door in real time in order to determine the force command 88 or the motion command 62. While the user when moving the door in power assist mode may have a quasi-manual control of the door, the power closure member actuation system 20 may limit the speed of the door at which the user may move the door when operating in power assist mode, for example the controller 50 may limit or cap the speed of the door to a maximum of 60 degrees per second, and may transition to the anti-slam mode above this speed as described herein above.

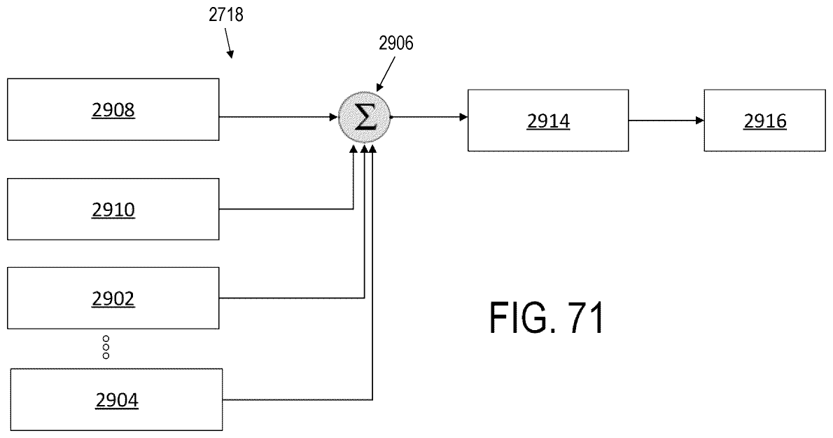

Now referring to FIG. 71, there is illustrated an example of the controller 50, 2702 determining if any auxiliary door systems are active and updating the relevant torque moments to include a relevant torque moments related to an auxiliary door system, such as a door presenter 2717 for the door angles which the door presenter 2717 will be activated, for example to assist with an ice breaking function as described herein above. For example, the controller 50, 2702 may determine if a door presenter is activated to also assist with moving the door, and include the relevant torque moment(s) 2902 of the auxiliary system(s) acting about the axis 2650 updated in real time based on the door angle for inclusion as part of the superposition calculation function 2718. Such auxiliary door systems may be selectively activated for acting on the door for a portion of the door angle as shown by arrow 2808 in FIG. 70. Other door systems having a related relevant torque moments 2904 may be included or removed by the controller 50 when performing the superposition function 2718, such as if a separate door check mechanism is acting on the door, if a separate brake mechanism is acting on the door, if another door is interacting with the door such as in the case of a B-pillarless door system, as examples and without limitation. Therefore, the controller 50, 2702 may execute a summation 2906 of the net torque response 2908 as illustratively determined in method step 2612 described herein above, which with reference to FIG. 69 includes illustratively the summation of torque moments 2705a to 2705d, the compensating torque 2910, as illustratively determined in method step 2616 and illustratively the torque moment of the actuator 22 about the axis 2650 described herein above, and proceed to calculate a force command 2912 using the force command generator 2914 to be supplied to the motor 2916. Any inclusion or exclusion of the relevant torque moment(s), such as torque moment(s) 2902 if door presenter 2717 is influencing the door movement can be added or removed without effecting the normal (without auxiliary door systems influencing door motion) power assist compensation calculations when such other relevant torque moment(s) due to the auxiliary system(s) is not being activated (for example based on door angle), or not being available (for example not being installed on the vehicle, or disabled due to damage). As a result the power closure member actuation system 20 can support the expansion of additional door motion influencing functions during door motion such as functions only operable during certain ranges of motion of the door or states of the door, or support the modularity of different configurations of the power closure member actuation system 20 such as the installation of additional mechanisms such as a mechanical door check, dampeners such as counterbalancing struts, an electromechanical brake mechanism, and so forth without limitation.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed is:

1. A power closure member actuation system for moving a closure member of a vehicle between open and closed positions relative to a vehicle body, the power closure member actuation system comprising:
an actuator coupled to the closure member and the vehicle body configured to move the closure member relative to the vehicle body;
a closure member feedback sensor for determining at least one of a position and a speed of the closure member; and
a controller in communication with the closure member feedback sensor and the actuator, the controller configured to control movement of the closure member by the actuator to resist the movement of the closure member towards one of the open position and the closed position without exceeding an operating rating of the actuator which can damage the actuator based on the position and the speed of the closure member determined using the closure member feedback sensor.

2. The power closure member actuation system as set forth in claim 1, wherein the actuator includes a motor operably coupled to a reduction geartrain operably coupled to the closure member.

3. The power closure member actuation system as set forth in claim 2, wherein the power closure member actuation system is provided without a mechanical brake or mechanical coupling to assist said resist the movement of the closure member towards one of the open position and the closed position.

4. The power closure member actuation system as set forth in claim 1, further comprising an inclination sensor in communication with the controller, the inclination sensor configured to detect an inclination of the closure member, wherein the controller is further configured to control movement of the closure member by the actuator based on the inclination of the closure member determined using the inclination sensor.

5. The power closure member actuation system as set forth in claim 2, wherein the operating rating comprises at least one of a maximum rotational speed of the motor, a maximum power rating of the motor, a maximum back electromotive force output rating, a maximum thermal rating, and a maximum electrical braking rating.

6. The power closure member actuation system as set forth in claim 2, wherein the controller is further configured to determine whether the speed of the closure member is greater than a predetermined maximum speed threshold causing to exceed a maximum speed operating rating of the actuator and in response to the speed of the closure member being greater than the predetermined maximum speed threshold control the actuator to reduce the speed of the closure member to return the motor to below the maximum speed operating rating of the actuator.

7. The power closure member actuation system as set forth in claim 1, wherein the controller is operable in at least one of an automatic mode and a powered assist mode and an anti-slam mode and the controller is configured to:
control the actuator in one of the automatic mode and the powered assist mode to move the closure member,
determine whether the speed of the closure member is greater than a predetermined maximum speed threshold,
continue to control the actuator in one of the automatic mode and the powered assist mode to move the closure member in response to the speed of the closure member not being greater than the predetermined maximum speed threshold, and
exit the one of the automatic mode and the powered assist mode and enter the anti-slam mode in response to the speed of the closure member being greater than the predetermined maximum speed threshold.

8. The power closure member actuation system as set forth in claim 1, wherein the position of the closure member is an angle of the closure member and the controller is further configured to:
detect a direction of movement of the closure member,
determine whether the angle of the closure member is less than a first predetermined closure member angle in response to detecting that the closure member is moving toward the open position,
control the actuator to reduce the speed of the closure member to allow a open hard stop in response to determining that the angle of the closure member is not less than the first predetermined closure member angle,
control the actuator to reduce the speed of the closure member to zero at or before the open position in response to determining that the angle of the closure member is less than the first predetermined closure member angle.

9. The power closure member actuation system as set forth in claim 1, wherein the position of the closure member is an angle of the closure member and the controller is further configured to:
determine whether the angle of the closure member is greater than a second predetermined closure member angle in response to detecting that the closure member is moving toward the closed position,
control the actuator to reduce the speed of the closure member to allow the closure member to enter a latch primary position of a latch in response to determining that the angle of the closure member is not greater than the second predetermined closure member angle,
control the actuator to reduce the speed of the closure member to allow the closure member to enter a latch secondary position in response to determining that the angle of the closure member is greater than the second predetermined closure member angle.

10. The power closure member actuation system as set forth in claim 9, wherein the position of the closure member is an angle of the closure member and the controller is coupled to a cinch actuator of a latch for moving the closure member from a latch secondary position to a latch primary position and the controller is further configured to:
detect a direction of movement of the closure member,
determine whether the angle of the closure member is less than a first predetermined closure member angle in response to detecting that the closure member is moving toward the open position,
control the actuator to reduce the speed of the closure member to allow an open hard stop in response to determining that the angle of the closure member is not less than the first predetermined closure member angle,
control the actuator to reduce the speed of the closure member to zero at or before the open position in response to determining that the angle of the closure member is less than the first predetermined closure member angle,
determine whether a manual control is detected,
determine whether the closure member is in the open position in response to determining that the manual control is not detected,
return to detect a direction of movement of the closure member in response to determining that the closure member is not in the open position,
exit the anti-slam mode in response to determining that the closure member is in the open position,
control the actuator in the powered assist mode and exit the anti-slam mode in response to determining that the manual control is detected,
determine whether the angle of the closure member is greater than a second predetermined closure member angle in response to detecting that the closure member is moving toward the closed position,
control the actuator to reduce the speed of the closure member to allow the closure member to enter the latch primary position in response to determining that the angle of the closure member is not greater than the second predetermined closure member angle,
control the actuator to reduce the speed of the closure member to allow the closure member to enter the latch secondary position in response to determining that the angle of the closure member is greater than the second predetermined closure member angle,
determine whether the manual control is detected,
control the actuator in the powered assist mode and exit the anti-slam mode in response to determining that the manual control is detected,
determine whether the closure member is at the latch secondary position in response to determining that the manual control is not detected,
control the cinch actuator to move the closure member to the latch primary position in response to determining that the closure member is at the latch secondary position,
generate an alert signal during the control of the cinch actuator and return to detect the direction of movement of the closure member, and
return to control the actuator to reduce the speed of the closure member to allow the closure member to enter the latch secondary position in response to determining that the closure member is not at the latch secondary position.

11. The power closure member actuation system as set forth in claim 9, wherein the position of the closure member is an angle of the closure member and the speed of the closure member is an angular velocity of the closure member and the controller is further configured to:
vary a rate of deceleration of the closure member as the closure member is moving toward the open position depending on the angle of the closure member in the anti-slam mode, and
ensure that the angular velocity of the closure member is zero at a first predetermined closure member angle before an open hard stop.

12. The power closure member actuation system as set forth in claim 9, wherein the position of the closure member is an angle of the closure member and the speed of the closure member is an angular velocity of the closure member and the controller is further configured to:
verify that the angle of the closure member is greater than a second predetermined closure member angle as the closure member is moving toward the closed position in the anti-slam mode,
slow the closure member to a predetermined reference speed depending on the angle of the closure member in response to verifying that the angle of the closure member is greater than the second predetermined closure member angle,
maintain the predetermined reference speed until the closure member moves to a latch secondary position, and
slow the closure member to a predetermined cinch speed in response to verifying that the angle of the closure member is not greater than the second predetermined closure member angle, and
allow the closure member to move to a latch primary position at the predetermined cinch speed.

13. A power closure member actuation system for moving a closure member of a vehicle between open and closed positions relative to a vehicle body, the power closure member actuation system comprising:
an actuator coupled to the closure member and the vehicle body configured to move the closure member relative to the vehicle body;
a closure member feedback sensor for determining at least one of a position and a speed of the closure member;
a controller in communication with the closure member feedback sensor and the actuator, the controller configured to:
control the actuator in one of an automatic mode and a powered assist mode to move the closure member,
determine whether the speed of the closure member is greater than a predetermined maximum speed threshold,
continue to control the actuator in one of the automatic mode and the powered assist mode to move the closure member in response to the speed of the closure member not being greater than the predetermined maximum speed threshold, and
exit the one of the automatic mode and the powered assist mode and enter an anti-slam mode in response to the speed of the closure member being greater than the predetermined maximum speed threshold.

14. The power closure member actuation system as set forth in claim 13, wherein the controller when in one of the automatic mode and the powered assist mode and the anti-slam mode is configured to control movement of the closure member by the actuator to resist the movement of the door towards one of the open position and the closed position without exceeding an operating rating which can damage the actuator based on the position and the speed of the closure member determined using the closure member feedback sensor.

15. The power closure member actuation system as set forth in claim 14, further comprising an inclination sensor in communication with the controller, the inclination sensor configured to detect an inclination of the closure member, wherein the controller is further configured to control movement of the closure member by the actuator based on the inclination of the closure member determined using the inclination sensor.

16. The power closure member actuation system as set forth in claim 13, wherein the position of the closure member is an angle of the closure member and the speed of the closure member is an angular velocity of the closure member and the controller is further configured to:
allow continued movement of the closure member in the automatic mode as long as the angular velocity of the closure member is: (i) at a predetermined reference speed, or (ii) within an automatic mode upper gap between a predetermined reference speed and an automatic upper angular velocity, or (iii) within an automatic mode lower gap between the predetermined reference speed and an automatic lower angular velocity,
enter the powered assist mode in response to the angular velocity of the closure member being less than the automatic lower angular velocity, or greater than the automatic upper angular velocity,
transition to the anti-slam mode once the angular velocity of the closure member is a high speed upper threshold greater than the predetermined maximum speed threshold, and
transition back to the powered assist mode once the angular velocity of the closure member slows to a high speed lower threshold less than the predetermined maximum speed threshold.

17. A method of controlling the movement of a closure member of a vehicle between open and closed positions relative to a vehicle body based on at least one of a position and a speed of the closure member using a power closure member actuation system, comprising the steps of:
moving the closure member relative to the vehicle body using an actuator of the power closure member actuation system coupled to the closure member and the vehicle body;
monitoring the at least one of the position and the speed of the closure member using a controller of the power closure member actuation system coupled to a closure member feedback sensor and the actuator; and
controlling movement of the closure member by the actuator to resist the movement of the door towards one of the open position and the closed position without exceeding an operating rating of the actuator which can damage the actuator based on the position and the speed of the closure member determined using the closure member feedback sensor.

18. The method as set forth in claim 17, wherein the controller is operable in at least one of an automatic mode and a powered assist mode and an anti-slam mode and the method further includes the steps of:
controlling the actuator in one of the automatic mode and the powered assist mode to move the closure member;
determining whether the speed of the closure member is greater than a predetermined maximum speed threshold;
continuing to control the actuator in one of the automatic mode and the powered assist mode to move the closure member in response to the speed of the closure member not being greater than the predetermined maximum speed threshold; and
exiting the one of the automatic mode and the powered assist mode and enter the anti-slam mode in response to the speed of the closure member being greater than the predetermined maximum speed threshold.

19. The method as set forth in claim 18, wherein the position of the closure member is an angle of the closure member and the controller is coupled to a cinch actuator of a latch 83 for moving the closure member from a latch secondary position to a latch primary position and the method further includes the steps of:
detecting a direction of movement of the closure member;
determining whether the angle of the closure member is less than a first predetermined closure member angle in response to detecting that the closure member is moving toward the open position;
controlling the actuator to reduce the speed of the closure member to allow an open hard stop in response to determining that the angle of the closure member is not less than the first predetermined closure member angle;
controlling the actuator to reduce the speed of the closure member to zero at or before the open position in response to determining that the angle of the closure member is less than the first predetermined closure member angle;
determining whether a manual control is detected;
determining whether the closure member is in the open position in response to determining that the manual control is not detected;
returning to detect a direction of movement of the closure member in response to determining that the closure member is not in the open position;
exiting the anti-slam mode in response to determining that the closure member is in the open position;
controlling the actuator in the powered assist mode and exit the anti-slam mode in response to determining that the manual control is detected;
determining whether the angle of the closure member is greater than a second predetermined closure member angle in response to detecting that the closure member is moving toward the closed position;
controlling the actuator to reduce the speed of the closure member to allow the closure member to enter the latch primary position in response to determining that the angle of the closure member is not greater than the second predetermined closure member angle;
controlling the actuator to reduce the speed of the closure member to allow the closure member to enter the latch secondary position in response to determining that the angle of the closure member is greater than the second predetermined closure member angle;
determining whether the manual control is detected;
controlling the actuator in the powered assist mode and exit the anti-slam mode in response to determining that the manual control is detected;
determining whether the closure member is at the secondary position in response to determining that the manual control is not detected;
controlling the cinch actuator to move the closure member to the latch primary position in response to determining that the closure member is at the latch secondary position;
generating an alert signal during the control of the cinch actuator and return to detect the direction of movement of the closure member; and
returning to control the actuator to reduce the speed of the closure member to allow the closure member to enter the latch secondary position in response to determining that the closure member is not at the latch secondary position.

20. The method as set forth in claim 19, wherein the position of the closure member is an angle of the closure member and the speed of the closure member is an angular velocity of the closure member and the method further includes the steps of:
allowing continued movement of the closure member in the automatic mode as long as the angular velocity of the closure member is: (i) at a predetermined reference speed, or (ii) within an automatic mode upper gap between a predetermined reference speed and an automatic upper angular velocity, or (iii) within an automatic mode lower gap between the predetermined reference speed and an automatic lower angular velocity,
entering the powered assist mode in response to the angular velocity of the closure member being less than the automatic lower angular velocity, or greater than the automatic upper angular velocity,
transitioning to the anti-slam mode once the angular velocity of the closure member is a high speed upper threshold greater than the predetermined maximum speed threshold, and
transitioning back to the powered assist mode once the angular velocity of the closure member slows to a high speed lower threshold less than the predetermined maximum speed threshold.
